(19) United States
(12) Patent Application Publication
(10) Pub. No.: US 2026/0105420 A1
(43) Pub. Date: Apr. 16, 2026

(54) RECONFIGURABLE PERPETUAL CALENDAR DEVICE OPERABLE UNDER RUDERMAN METHOD OF MAKING A WEEKDAY DETERMINATION AND METHOD FOR PERIODIC UPDATING OF THE SAME

(71) Applicant: Dung B. Nguyen, Spencer, IA (US)

(72) Inventor: Dung B. Nguyen, Spencer, IA (US)

(21) Appl. No.: 19/175,792

(22) Filed: Apr. 10, 2025

Related U.S. Application Data
(63) Continuation-in-part of application No. 18/912,907, filed on Oct. 11, 2024.

(51) Int. Cl. G06Q 10/1093

(52) U.S. Cl. CPC G06Q 10/1093

(57) ABSTRACT

A reconfigurable perpetual calendar device operable under the Ruderman method of making weekday determinations is disclosed. The device includes a single slate with numbers 1 to 31 arranged in columns, a row of day dots, a row of month dots, and a row of movable weekday tiles. A slider mechanism allows for adjustments to accommodate leap years. The device eliminates the need for annual calendar replacements by incorporating movable elements that can be easily updated. A process for generating new calendars by sliding weekday tiles and adjusting month labels is also provided. The device and process can be adapted for various calendar formats, including academic and fiscal calendars of arbitrary starting dates. This improvement upon the space-saving Ruderman Calendar design offers increased versatility and longevity.

### CROSS REFERENCE TO RELATED APPLICATIONS

This application is a continuation-in-part application of U.S. Utility application Ser. No. 18/912,907, filed on Oct. 11, 2024. The entire disclosure of the above application is incorporated herein by reference.

### FIELD

The present technology relates to calendars and calendar devices and, more particularly, to perpetual calendar devices operable under the Ruderman method of making weekday determinations.

### INTRODUCTION

This section provides background information related to the present disclosure which is not necessarily prior art.

Calendars have been an essential tool for organizing time and planning activities throughout human history. Traditional calendars typically consist of 12 monthly slates, each displaying a grid of dates corresponding to the days of the week. However, this conventional format requires a new calendar to be produced each year due to the shifting relationship between dates and weekdays.

In the 1950s, Harry D. Ruderman invented a revolutionary calendar design that significantly compressed the information presented in traditional calendars. The Ruderman Calendar, as shown in FIG. 1 (Prior Art), condensed the 12 monthly slates into a single slate of numbers from 1 to 31, achieving a remarkable space-saving factor of 12.

The ingenious design of the Ruderman Calendar features a grid of numbers from 1 to 31 arranged in seven columns, each headed by an unlabeled “day” dot. Above this grid is a row of seven “month” dots, with each dot labeled with one or more month names. Between these two rows of dots is a row of weekday names (Sunday, Monday, etc.). To determine the weekday for a specific date, one locates the appropriate “month” dot and the “day” dot corresponding to the desired date. The line connecting these two dots intersects the row of weekday names, revealing the correct weekday.

While the Ruderman Calendar offers a more compact and efficient way to display calendar information, it still faces a significant limitation. The labeling of the “month” dots changes from year to year, necessitating the creation of a new Ruderman Calendar annually. This requirement for yearly updates diminishes the long-term utility and convenience of the calendar system.

Furthermore, the Ruderman Calendar does not easily accommodate leap years, which occur every four years (with rare exceptions). The insertion of an additional day in February during leap years disrupts the structure of the calendar, requiring a separate calendar design for leap years. This limitation further complicates the use and production of Ruderman Calendars over extended periods.

Another drawback of the conventional Ruderman Calendar is its fixed nature, which does not allow for easy adaptation to different calendar systems, such as academic or fiscal calendars that may begin and end on dates other than January 1st and December 31st, respectively. This inflexibility limits the applicability of the calendar in various professional and institutional settings.

There is a continuing need for an improved calendar device and method that builds upon the space-saving advantages of the Ruderman Calendar while addressing its limitations. Desirably, such a device and method would eliminate the need for annual replacements, easily accommodate leap years, and offer flexibility for different calendar formats, all while maintaining the intuitive weekday determination method pioneered by Ruderman.

### SUMMARY

In concordance with the instant disclosure, an improved calendar device and method that builds upon the space-saving advantages of the Ruderman Calendar while addressing its limitations by eliminating the need for annual replacements, easily accommodating leap years, and offering flexibility for different calendar formats, all while maintaining the intuitive weekday determination method pioneered by Ruderman, has surprisingly been discovered.

The present technology includes articles of manufacture, systems, and processes that relate to reconfigurable perpetual calendar devices operable under the Ruderman method of making weekday determinations and methods for periodically updating such devices.

In one embodiment, a first perpetual calendar device operable under a Ruderman method of making a weekday determination may include a calendar body permitting a user to make the weekday determination by selecting a day number and a month name. The calendar body may have a common year mode rendering the calendar body usable for the weekday determination during a common year, and a leap year mode rendering the calendar body usable for the weekday determination during a leap year.

The calendar body may have a surface with a top side, a bottom side, a left side, and a right side, further having a base calendar layout with immovable elements and movable elements. The immovable elements may include an array of day number elements having day number element columns and day number element rows, a series of spaced apart day markers, a first row of month name elements, a series of spaced apart month markers, a leap year element, and a second row of month name elements.

The movable elements may include a third row of month name elements having a first month element and a second month element, and a fourth row of weekday name elements. The first month element, optionally, may be configured to move toward the left side of the surface to a first month element leap year position when the calendar body is reconfigured to the leap year mode, and to move toward the right side of the surface to a first month element common year position when the calendar body is reconfigured to the common year mode. The second month element, optionally, may be configured to move toward the left side of the surface to a second month element leap year position when the calendar body is reconfigured to the leap year mode, and to move toward the right side of the surface to a second month element common year position when the calendar body is reconfigured to the common year mode, the second month element disposed over and covering the leap year element while in the second month element common year position. The fourth row of weekday name elements may be configured to move toward the left side of the surface during the annual update, and a leftmost one of the weekday name elements configured to move from a leftmost side of the fourth row to a rightmost side of the fourth row during the annual update.

The calendar body may be operable by the user under the Ruderman method to make the weekday determination by selecting the day number, selecting the month name, and visualizing or actually effecting a line extending from one of the series of spaced apart month markers aligned with the one of the month name elements associated with the month name that is selected to one of the series of spaced apart day markers aligned with one of the day number element columns associated with the day number that is selected. The line intersects one of the weekday name elements in the fourth row to thereby reveal a weekday associated with the day number and the month name selected by the user.

In another embodiment, a first method of updating the first perpetual calendar device from a former calendar year to a new calendar year may be provided. This first method may involve providing the first perpetual calendar device and reconfiguring the calendar body to provide the annual update to the first perpetual calendar device in accordance with one of three different scenarios.

In the first scenario, where the former calendar year is the common year and the new calendar year is the common year, the first method includes a step of moving the fourth row of weekday name elements one position to the left toward the left side of the surface at the end of the former calendar year so that the first perpetual calendar device remains in the new year's common year mode.

In the second scenario, where the former calendar year is the common year and the new calendar year is a leap year, the first method includes a step of moving the fourth row of weekday name elements two positions to the left toward the left side of the surface at the end of the former calendar year. The first method also includes a step of moving each of the first month element and the second month element one position to the left toward the left side of the surface at the end of the former calendar year, so that the first perpetual calendar device is placed in the leap year mode. The leap year element is thereby exposed to signify to the user that the calendar body is in the leap year mode.

In the third scenario, where the former calendar year is the leap year and the new calendar year is the common year, the first method includes a step of moving the fourth row of weekday name elements one position to the left toward the left side of the surface at the end of the former calendar year. The first method also includes a step of moving each of the first month element and the second month element one position to the right toward the right side of the surface at the end of the former calendar year, so that the first perpetual calendar device is placed in the common year mode. The leap year element is thereby covered to signify to the user that the calendar body is in the common year mode, thereby rendering the perpetual calendar device operable for the new calendar year.

In yet another embodiment, a second perpetual calendar device operable under a Ruderman method of making a weekday determination and also permitting for a monthly update to provide a rolling calendar year effective for the next twelve (12) months may be provided. The second perpetual calendar device may have a calendar body permitting a user to make the weekday determination by selecting a day number and a month name, the calendar body permitting for the monthly update by the user performing a reconfiguration of the calendar body notwithstanding the rolling calendar year beginning in either a common year or in a leap year.

The calendar body may have a surface with a top side, a bottom side, a left side, and a right side, the surface further having a base calendar layout with movable elements and immovable elements. The movable elements may include a first row of month name elements, a second row of month name elements, and a third row of month name elements.

Each of the first row, the second row, and the third row of month name elements may be disposed on the surface between the bottom side and the top side of the surface. Each of the month name elements in these rows may be configured to individually move toward the right side of the surface during the monthly update at the end of a month associated with each of the month name elements. A rightmost one of any row of month name elements may be configured to move from a rightmost side of its row to a leftmost side of any row during the monthly update at the end of the month associated with the rightmost one of any row of month name elements.

In particular, the month name elements may include a January month element, a February month element, a March month element, an April month element, a May month element, a June month element, a July month element, an August month element, a September month element, an October month element, a November month element, and a December month element.

The immovable elements may include an array of day number elements having day number element columns, a fourth row of weekday name elements, a series of spaced apart day markers, and a series of spaced apart month markers. The fourth row of weekday name elements may be in fixed position and not configured to move during the monthly update.

The calendar body may be operable by the user under the Ruderman method to manually make the weekday determination by selecting the day number, selecting the month name, and visualizing or actually effecting a line extending from one of the series of spaced apart month markers aligned with the one of the month name elements associated with the month name that is selected to one of the series of spaced apart day markers aligned with one of the day number element columns associated with the day number that is selected. The line intersects one of the weekday name elements in the fourth row to thereby reveal the weekday associated with the day number and the month name selected by the user.

In a further embodiment, a second method of updating the second perpetual calendar device may be provided. The second method may have steps of providing the second perpetual calendar device and reconfiguring the calendar body to provide the monthly update to the perpetual calendar device by one of three different scenarios.

In the first scenario, where the rolling calendar year begins in the common year preceding another common year, the second method includes a step of moving the month name elements only one position as the month name elements individually move toward the right side of the surface at the end of the month associated with each of the month name elements.

In the second scenario, where the rolling calendar year begins in the common year preceding the leap year, the second method includes a step of moving each of the January month element and the February month element only one position as the month name elements individually move toward the right side of the surface. The second method also includes a step of moving each of the March month element, the April month element, the May month element, the June month element, the July month element, the August month element, the September month element, the October month element, the November month element, and the December month element two positions as the month name elements individually move toward the right side of the surface, at the end of the month associated with each of the month name elements.

In the third scenario, where the rolling calendar year begins in the leap year preceding the common year, the second method includes a step of moving each of the January month element and the February month element two positions as the month name elements individually move toward the right side of the surface. The second method also includes a step of moving each of the March month element, the April month element, the May month element, the June month element, the July month element, the August month element, the September month element, the October month element, the November month element, and the December month element only one position as the month name elements individually move toward the right side of the surface, at the end of the month associated with each of the month name elements, thereby rendering the perpetual calendar device operable for the rolling calendar year effective for the next twelve (12) months.

In certain embodiments, a third perpetual calendar device operable under a Ruderman method of making a weekday determination may include a calendar body permitting a user to make the weekday determination by selecting a day number and a month name. The calendar body may have a common year mode rendering the calendar body usable for the weekday determination during a common year, and a leap year mode rendering the calendar body usable for the weekday determination during a leap year. The calendar body may have at least one surface with a top side, a bottom side, a left side, and a right side. The at least one surface may have a base calendar layout with immovable elements and movable elements.

The immovable elements may include an array of day number elements, a series of spaced apart day markers, a series of spaced apart month markers, and a fourth row of weekday name elements. The movable elements may include a first row of month name elements, a second row of month name elements, a third row of month name elements, and a leap year element.

The calendar body may be operable by the user under the Ruderman method to make the weekday determination by selecting the day number, selecting the month name, and visualizing a line extending from one of the series of spaced apart month markers aligned with the one of the month name elements associated with the month name that may be selected to one of the series of spaced apart day markers aligned with one of the day number element columns associated with the day number that may be selected, with the line intersecting one of the weekday name elements in the fourth row to thereby reveal a weekday associated with the day number and the month name selected by the user.

In certain embodiments, a third method of updating the third perpetual calendar device from the former calendar year to the new calendar year may have several steps. The first step may involve providing the third perpetual calendar device. The next step may involve reconfiguring the calendar body to provide the annual update to the third perpetual calendar device. The method may then proceed with one of three possible scenarios for reconfiguring the calendar body, depending on the transition between the former and new calendar years. One of ordinary skill in the art should appreciate that the steps of the third method may also be performed in a reverse update in order to generate a past calendar operable under the Ruderman method of making the weekday determination.

In the first scenario, where the former calendar year is the common year and the new calendar year is also the common year, the third method may involve moving the first row of month name elements, the second row of month name elements, and the third row of month name elements one position to a right toward the right side of the surface at the end of the former calendar year.

In the second scenario, where the former calendar year is the common year and the new calendar year is the leap year, the third method may involve moving the second row of month name elements and the third row of month name elements two positions to the right toward the right side of the surface at the end of the former calendar year, and moving each of the first month element of the first row of month name elements and the second month element of the first row of month name elements one position to the right toward the right side of the surface at the end of the former calendar year.

The third scenario may occur when the former calendar year is a leap year and the new calendar year is a common year. In this case, the method may involve moving the second row of month name elements and the third row of month name elements one position to the right toward the right side of the surface at the end of the former calendar year, and moving each of the first month element of the first row of month name elements and the second month element of the first row of month name elements two positions to the right toward the right side of the surface at the end of the former calendar year. The third perpetual calendar device is thereby rendered operable for the new calendar year. This step may be the culmination of the reconfiguration process, ensuring that the device is ready for use in the upcoming year.

In certain embodiments, a fourth perpetual calendar device operable under a Ruderman method of making a weekday determination may include a calendar body permitting a user to make the weekday determination by selecting a day number and a month name. The calendar body may have a common year mode rendering the calendar body usable for the weekday determination during a common year, and a leap year mode rendering the calendar body usable for the weekday determination during a leap year. The calendar body may have at least one surface with a top side, a bottom side, a left side, and a right side. The at least one surface may have a base calendar layout with immovable elements and movable elements.

The immovable elements may include a second row of month name elements, a third row of month name elements, a series of spaced apart day markers, a series of spaced apart month markers, and a fourth row of weekday name elements. The movable elements may include an array of day number elements, a first row of month name elements, and a leap year element.

The calendar body may be operable by the user under the Ruderman method to make the weekday determination by selecting the day number, selecting the month name, and visualizing a line extending from one of the series of spaced apart month markers aligned with the one of the month name elements associated with the month name that may be selected to one of the series of spaced apart day markers aligned with one of the day number element columns associated with the day number that may be selected, with the line intersecting one of the weekday name elements in the fourth row to thereby reveal a weekday associated with the day number and the month name selected by the user.

In certain embodiments, a fourth method of updating the fourth perpetual calendar device from the former calendar year to the new calendar year may have several steps. The first step may involve providing the fourth perpetual calendar device. The next step may involve reconfiguring the calendar body to provide the annual update to the fourth perpetual calendar device. The method may then proceed with one of three possible scenarios for reconfiguring the calendar body, depending on the transition between the former and new calendar years. One of ordinary skill in the art should appreciate that the steps of the fourth method may also be performed in a reverse update in order to generate a past calendar operable under the Ruderman method of making the weekday determination.

In the first scenario, where the former calendar year is the common year and the new calendar year is also the common year, the fourth method may involve moving the day number element columns one position to a right toward the right side of the surface at the end of the former calendar year.

In the second scenario, where the former calendar year is the common year and the new calendar year is the leap year, the fourth method may involve moving the day number element columns two positions to the right toward the right side of the surface at the end of the former calendar year, and moving each of the first month element of the first row of month name elements and the second month element of the first row of month name elements one position to the left toward the left side of the surface at the end of the former calendar year.

The third scenario may occur when the former calendar year is a leap year and the new calendar year is a common year. In this case, the method may involve moving the day number element columns one position to the right toward the right side of the surface at the end of the former calendar year, and moving each of the first month element of the first row of month name elements and the second month element of the first row of month name elements one position to the right toward the right side of the surface at the end of the former calendar year. The fourth perpetual calendar device is thereby rendered operable for the new calendar year. This step may be the culmination of the reconfiguration process, ensuring that the device is ready for use in the upcoming year.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a top plan view of a prior art calendar device for use with the Ruderman method of making a weekday determination.

FIG. 2 is a top plan view of a first reconfigurable perpetual calendar device for use with the Ruderman method of making a weekday determination, and illustrating a reconfiguration of the first reconfigurable perpetual calendar device from calendar year 2021 to calendar year 2022.

FIG. 3 is a top plan view of the first reconfigurable perpetual calendar device shown in FIG. 2, and illustrating a reconfiguration of the first reconfigurable perpetual calendar device from calendar year 2022 to calendar year 2023.

FIG. 4 is a top plan view of the first reconfigurable perpetual calendar device shown in FIG. 2, and illustrating a reconfiguration of the first reconfigurable perpetual calendar device from calendar year 2023 to calendar year 2024.

FIG. 5 is a top plan view of the first reconfigurable perpetual calendar device shown in FIG. 2, and illustrating a reconfiguration of the first reconfigurable perpetual calendar device from calendar year 2024 to calendar year 2025.

FIG. 6 is a top plan view of the first reconfigurable perpetual calendar device shown in FIG. 5, shown in calendar year 2025, and illustrating that a predetermined set of the movable weekday name elements may be connected or otherwise formed as a single one-piece unit that is movable on a surface of the first reconfigurable perpetual calendar device.

FIG. 7 is a flowchart illustrating a method for an annual updating of the first reconfigurable perpetual calendar device shown in FIGS. 2-6, according to some embodiments of the present disclosure.

FIG. 8 is a top plan view of a second reconfigurable perpetual calendar device for use with the method of making a weekday determination, and illustrating a reconfiguration of the second reconfigurable perpetual calendar device from a rolling calendar year beginning in January 2021 to a rolling calendar year beginning in February 2021, with all months being within a common year.

FIG. 9 is a top plan view of the second reconfigurable perpetual calendar device shown in FIG. 8, and illustrating a reconfiguration of the second reconfigurable perpetual calendar device from a rolling calendar year beginning in February 2021 to a rolling calendar year beginning in March 2021, with all months being within a common year.

FIG. 10 is a top plan view of the second reconfigurable perpetual calendar device shown in FIG. 8, and illustrating a reconfiguration of the second reconfigurable perpetual calendar device from a rolling calendar year beginning in March 2021 to a rolling calendar year beginning in April 2021, with all months being within a common year.

FIG. 11 is a top plan view of the second reconfigurable perpetual calendar device shown in FIG. 8, and illustrating a reconfiguration of the second reconfigurable perpetual calendar device from a rolling calendar year beginning in April 2021 to a rolling calendar year beginning in May 2021, with all months being within a common year.

FIG. 12 is a top plan view of the second reconfigurable perpetual calendar device shown in FIG. 8, and illustrating a reconfiguration of the second reconfigurable perpetual calendar device from a rolling calendar year beginning in May 2021 to a rolling calendar year beginning in June 2021, with all months being within a common year.

FIG. 13 is a top plan view of the second reconfigurable perpetual calendar device shown in FIG. 8, and illustrating a reconfiguration of the second reconfigurable perpetual calendar device from a rolling calendar year beginning in June 2021 to a rolling calendar year beginning in July 2021, with all months being within a common year.

FIG. 14 is a top plan view of the second reconfigurable perpetual calendar device shown in FIG. 8, and illustrating a reconfiguration of the second reconfigurable perpetual calendar device from a rolling calendar year beginning in July 2021 to a rolling calendar year beginning in August 2021, with all months being within a common year.

FIG. 15 is a top plan view of the second reconfigurable perpetual calendar device shown in FIG. 8, and illustrating a reconfiguration of the second reconfigurable perpetual calendar device from a rolling calendar year beginning in August 2021 to a rolling calendar year beginning in September 2021, with all months being within a common year.

FIG. 16 is a top plan view of the second reconfigurable perpetual calendar device shown in FIG. 8, and illustrating a reconfiguration of the second reconfigurable perpetual calendar device from a rolling calendar year beginning in September 2021 to a rolling calendar year beginning in October 2021, with all months being within a common year.

FIG. 17 is a top plan view of the second reconfigurable perpetual calendar device shown in FIG. 8, and illustrating a reconfiguration of the second reconfigurable perpetual calendar device from a rolling calendar year beginning in October 2021 to a rolling calendar year beginning in November 2021, with all months being within a common year.

FIG. 18 is a top plan view of the second reconfigurable perpetual calendar device shown in FIG. 8, and illustrating a reconfiguration of the second reconfigurable perpetual calendar device from a rolling calendar year beginning in November 2021 to a rolling calendar year beginning in December 2021, with all months being within a common year.

FIG. 19 is a top plan view of the second reconfigurable perpetual calendar device shown in FIG. 8, and illustrating a reconfiguration of the second reconfigurable perpetual calendar device from a rolling calendar year beginning in December 2021 to a rolling calendar year beginning in January 2022, with all months being within a common year.

FIG. 20 is a top plan view of the second reconfigurable perpetual calendar device shown in FIG. 8 that has been reconfigured to the rolling calendar year beginning in January 2022, with all months being within a common year.

FIG. 21 is a top plan view of the second reconfigurable perpetual calendar device shown in FIG. 8, and illustrating a reconfiguration of the second reconfigurable perpetual calendar device from a rolling calendar year beginning in January 2023 to a rolling calendar year beginning in February 2023, with the at least one of the prior months being within a common year and at least one of the latter months being within a leap year.

FIG. 22 is a top plan view of the second reconfigurable perpetual calendar device shown in FIG. 8, and illustrating a reconfiguration of the second reconfigurable perpetual calendar device from a rolling calendar year beginning in February 2023 to a rolling calendar year beginning in March 2023, with the at least one of the prior months being within a common year and at least one of the latter months being within a leap year.

FIG. 23 is a top plan view of the second reconfigurable perpetual calendar device shown in FIG. 8, and illustrating a reconfiguration of the second reconfigurable perpetual calendar device from a rolling calendar year beginning in March 2023 to a rolling calendar year beginning in April 2023, with the at least one of the prior months being within a common year and at least one of the latter months being within a leap year.

FIG. 24 is a top plan view of the second reconfigurable perpetual calendar device shown in FIG. 8, and illustrating a reconfiguration of the second reconfigurable perpetual calendar device from a rolling calendar year beginning in April 2023 to a rolling calendar year beginning in May 2023, with the at least one of the prior months being within a common year and at least one of the latter months being within a leap year.

FIG. 25 is a top plan view of the second reconfigurable perpetual calendar device shown in FIG. 8, and illustrating a reconfiguration of the second reconfigurable perpetual calendar device from a rolling calendar year beginning in May 2023 to a rolling calendar year beginning in June 2023, with the at least one of the prior months being within a common year and at least one of the latter months being within a leap year.

FIG. 26 is a top plan view of the second reconfigurable perpetual calendar device shown in FIG. 8, and illustrating a reconfiguration of the second reconfigurable perpetual calendar device from a rolling calendar year beginning in June 2023 to a rolling calendar year beginning in July 2023, with the at least one of the prior months being within a common year and at least one of the latter months being within a leap year.

FIG. 27 is a top plan view of the second reconfigurable perpetual calendar device shown in FIG. 8, and illustrating a reconfiguration of the second reconfigurable perpetual calendar device from a rolling calendar year beginning in July 2023 to a rolling calendar year beginning in August 2023, with the at least one of the prior months being within a common year and at least one of the latter months being within a leap year.

FIG. 28 is a top plan view of the second reconfigurable perpetual calendar device shown in FIG. 8, and illustrating a reconfiguration of the second reconfigurable perpetual calendar device from a rolling calendar year beginning in August 2023 to a rolling calendar year beginning in September 2023, with the at least one of the prior months being within a common year and at least one of the latter months being within a leap year.

FIG. 29 is a top plan view of the second reconfigurable perpetual calendar device shown in FIG. 8, and illustrating a reconfiguration of the second reconfigurable perpetual calendar device from a rolling calendar year beginning in September 2023 to a rolling calendar year beginning in October 2023, with the at least one of the prior months being within a common year and at least one of the latter months being within a leap year.

FIG. 30 is a top plan view of the second reconfigurable perpetual calendar device shown in FIG. 8, and illustrating a reconfiguration of the second reconfigurable perpetual calendar device from a rolling calendar year beginning in October 2023 to a rolling calendar year beginning in November 2023, with the at least one of the prior months being within a common year and at least one of the latter months being within a leap year.

FIG. 31 is a top plan view of the second reconfigurable perpetual calendar device shown in FIG. 8, and illustrating a reconfiguration of the second reconfigurable perpetual calendar device from a rolling calendar year beginning in November 2023 to a rolling calendar year beginning in December 2023, with the at least one of the prior months being within a common year and at least one of the latter months being within a leap year.

FIG. 32 is a top plan view of the second reconfigurable perpetual calendar device shown in FIG. 8, and illustrating a reconfiguration of the second reconfigurable perpetual calendar device from a rolling calendar year beginning in December 2023 to a rolling calendar year beginning in January 2024, with the at least one of the prior months being within a common year and at least one of the latter months being within a leap year.

FIG. 33 is a top plan view of the second reconfigurable perpetual calendar device shown in FIG. 8, shown beginning in January 2024, and with all of the latter months being within a leap year.

FIG. 34 is a top plan view of the second reconfigurable perpetual calendar device shown in FIG. 8, and illustrating a reconfiguration of the second reconfigurable perpetual calendar device from a rolling calendar year beginning in January 2024 to a rolling calendar year beginning in February 2024, with the at least one of the prior months being within a leap year and at least one of the latter months being within a common year.

FIG. 35 is a top plan view of the second reconfigurable perpetual calendar device shown in FIG. 8, and illustrating a reconfiguration of the second reconfigurable perpetual calendar device from a rolling calendar year beginning in February 2024 to a rolling calendar year beginning in March 2024, with the at least one of the prior months being within a leap year and at least one of the latter months being within a common year.

FIG. 36 is a top plan view of the second reconfigurable perpetual calendar device shown in FIG. 8, and illustrating a reconfiguration of the second reconfigurable perpetual calendar device from a rolling calendar year beginning in March 2024 to a rolling calendar year beginning in April 2024, with the at least one of the prior months being within a leap year and at least one of the latter months being within a common year.

FIG. 37 is a top plan view of the second reconfigurable perpetual calendar device shown in FIG. 8, and illustrating a reconfiguration of the second reconfigurable perpetual calendar device from a rolling calendar year beginning in April 2024 to a rolling calendar year beginning in May 2024, with the at least one of the prior months being within a leap year and at least one of the latter months being within a common year.

FIG. 38 is a top plan view of the second reconfigurable perpetual calendar device shown in FIG. 8, and illustrating a reconfiguration of the second reconfigurable perpetual calendar device from a rolling calendar year beginning in May 2024 to a rolling calendar year beginning in June 2024, with the at least one of the prior months being within a leap year and at least one of the latter months being within a common year.

FIG. 39 is a top plan view of the second reconfigurable perpetual calendar device shown in FIG. 8, and illustrating a reconfiguration of the second reconfigurable perpetual calendar device from a rolling calendar year beginning in June 2024 to a rolling calendar year beginning in July 2024, with the at least one of the prior months being within a leap year and at least one of the latter months being within a common year.

FIG. 40 is a top plan view of the second reconfigurable perpetual calendar device shown in FIG. 8, and illustrating a reconfiguration of the second reconfigurable perpetual calendar device from a rolling calendar year beginning in July 2024 to a rolling calendar year beginning in August 2024, with the at least one of the prior months being within a leap year and at least one of the latter months being within a common year.

FIG. 41 is a top plan view of the second reconfigurable perpetual calendar device shown in FIG. 8, and illustrating a reconfiguration of the second reconfigurable perpetual calendar device from a rolling calendar year beginning in August 2024 to a rolling calendar year beginning in September 2024, with the at least one of the prior months being within a leap year and at least one of the latter months being within a common year.

FIG. 42 is a top plan view of the second reconfigurable perpetual calendar device shown in FIG. 8, and illustrating a reconfiguration of the second reconfigurable perpetual calendar device from a rolling calendar year beginning in September 2024 to a rolling calendar year beginning in October 2024, with the at least one of the prior months being within a leap year and at least one of the latter months being within a common year.

FIG. 43 is a top plan view of the second reconfigurable perpetual calendar device shown in FIG. 8, and illustrating a reconfiguration of the second reconfigurable perpetual calendar device from a rolling calendar year beginning in October 2024 to a rolling calendar year beginning in November 2024, with the at least one of the prior months being within a leap year and at least one of the latter months being within a common year.

FIG. 44 is a top plan view of the second reconfigurable perpetual calendar device shown in FIG. 8, and illustrating a reconfiguration of the second reconfigurable perpetual calendar device from a rolling calendar year beginning in November 2024 to a rolling calendar year beginning in December 2024, with the at least one of the prior months being within a leap year and at least one of the latter months being within a common year.

FIG. 45 is a top plan view of the second reconfigurable perpetual calendar device shown in FIG. 8, and illustrating a reconfiguration of the second reconfigurable perpetual calendar device from a rolling calendar year beginning in December 2024 to a rolling calendar year beginning in January 2025, with the at least one of the prior months being within a leap year and at least one of the latter months being within a common year.

FIG. 46 is a top plan view of the second reconfigurable perpetual calendar device shown in FIG. 8, shown beginning in January 2025, and with all of the latter months being within a common year.

FIG. 47 is a flowchart illustrating a method for a rolling monthly updating of the second reconfigurable perpetual calendar device shown in FIGS. 8-46, according to some embodiments of the present disclosure.

FIG. 48 is an illustration depicting a configuration of the calendar device having a deformation of an area between day markers and month markers on a surface of the calendar device, according to a further embodiment of the disclosure.

FIG. 49a is an illustration depicting a configuration of the calendar device where the first day of the month can start on any of the day markers, and the numbers can be either inside or outside of the area between the day markers and the month markers, according to a further embodiment of the disclosure.

FIG. 49b is an illustration depicting a configuration of the calendar device where the first day of the month can start on any of the day markers, and the numbers can be either inside or outside of the area between the day markers and the month markers, according to a further embodiment of the disclosure.

FIG. 50 is an illustration depicting a configuration of the calendar device where there is a non-tabular association of at least one of the dates and the months to the day markers and the month markers.

FIG. 51 is an illustration depicting a configuration of the calendar device where there is an arbitrary orientation of the area between the day markers and the month markers, according to a further embodiment of the disclosure.

FIG. 52 is an illustration depicting a configuration of the calendar device where the day numbers and the months can be on either side of the area between the day markers and the month markers, according to a further embodiment of the disclosure.

FIG. 53 is an illustration depicting a configuration of the calendar device where the calendar body is three-dimensional and that is a hinged panel having the dates that can be closed with a fastener system such as a cooperating metal element and magnet, both hidden, which allow the panel to be folded up and held in place by the metal clicking to the magnet, according to a further embodiment of the disclosure.

FIG. 54 is an illustration depicting a configuration of the calendar device having another three-dimensional calendar body, and where the leap year slider is circular instead of linear, according to a further embodiment of the disclosure.

FIG. 55 is another view of the calendar device shown in FIG. 54.

FIG. 56 is an illustration depicting a configuration of the calendar device having an actual line element such as a rubber band for connecting the month marker and the day marker, and which can be removably held in place by fasteners, such as thumb tacks.

FIG. 57 is a top plan view of a third reconfigurable perpetual calendar device for use with the Ruderman method of making a weekday determination, and illustrating a reconfiguration of the third reconfigurable perpetual calendar device from calendar year 2024 to calendar year 2025.

FIG. 58 is a top plan view of a third reconfigurable perpetual calendar device for use with the Ruderman method of making a weekday determination, and illustrating a reconfiguration of the third reconfigurable perpetual calendar device from calendar year 2025 to calendar year 2026.

FIG. 59 is a top plan view of a third reconfigurable perpetual calendar device for use with the Ruderman method of making a weekday determination, and illustrating a reconfiguration of the third reconfigurable perpetual calendar device from calendar year 2026 to calendar year 2027.

FIG. 60 is a top plan view of a third reconfigurable perpetual calendar device for use with the Ruderman method of making a weekday determination, and illustrating a reconfiguration of the third reconfigurable perpetual calendar device from calendar year 2027 to calendar year 2028.

FIG. 61 is a top plan view of a third reconfigurable perpetual calendar device for use with the Ruderman method of making a weekday determination, and illustrating a reconfiguration of the third reconfigurable perpetual calendar device from calendar year 2028 to calendar year 2029.

FIG. 62 is a top plan view of a third reconfigurable perpetual calendar device for use with the Ruderman method of making a weekday determination, and illustrating a reconfiguration of the third reconfigurable perpetual calendar device for calendar year 2029.

FIG. 63 is a flowchart illustrating a method for an annual updating of the third reconfigurable perpetual calendar device shown in FIGS. 57-62, according to some embodiments of the present disclosure.

FIG. 64 is a top plan view of a fourth reconfigurable perpetual calendar device for use with the Ruderman method of making a weekday determination, and illustrating a reconfiguration of the fourth reconfigurable perpetual calendar device from calendar year 2024 to calendar year 2025.

FIG. 65 is a top plan view of a fourth reconfigurable perpetual calendar device for use with the Ruderman method of making a weekday determination, and illustrating a reconfiguration of the fourth reconfigurable perpetual calendar device from calendar year 2025 to calendar year 2026.

FIG. 66 is a top plan view of a fourth reconfigurable perpetual calendar device for use with the Ruderman method of making a weekday determination, and illustrating a reconfiguration of the fourth reconfigurable perpetual calendar device from calendar year 2026 to calendar year 2027.

FIG. 67 is a top plan view of a fourth reconfigurable perpetual calendar device for use with the Ruderman method of making a weekday determination, and illustrating a reconfiguration of the fourth reconfigurable perpetual calendar device from calendar year 2027 to calendar year 2028.

FIG. 68 is a top plan view of a fourth reconfigurable perpetual calendar device for use with the Ruderman method of making a weekday determination, and illustrating a reconfiguration of the fourth reconfigurable perpetual calendar device from calendar year 2028 to calendar year 2029.

FIG. 69 is a top plan view of a fourth reconfigurable perpetual calendar device for use with the Ruderman method of making a weekday determination, and illustrating a reconfiguration of the fourth reconfigurable perpetual calendar device for calendar year 2029.

FIG. 70 is a flowchart illustrating a method for an annual updating of the fourth reconfigurable perpetual calendar device shown in FIGS. 64-69, according to some embodiments of the present disclosure.

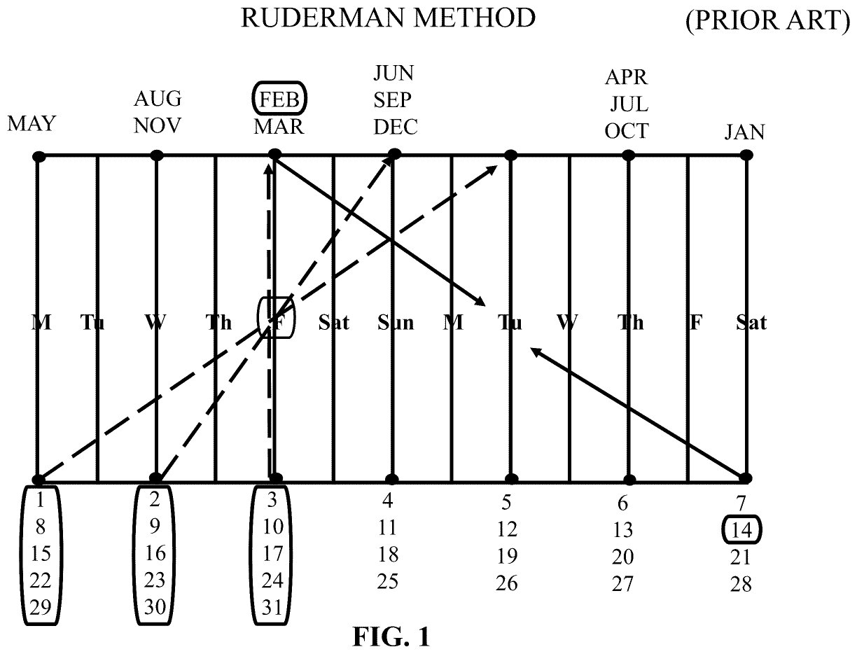

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a process reciting elements A, B and C specifically envisions embodiments consisting of, and consisting essentially of, A, B and C, excluding an element D that may be recited in the art, even though element D is not explicitly described as being excluded herein.

As referred to herein, all disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top,” “bottom,” “left,” “right,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly. The spatially relative terms such as “top,” “bottom,” “left,” “right,” may also be intended to encompass different configurations of the device, including three-dimensional configurations such as a sphere, for example, which are understood herein as having such “sides” irrespective of their surface(s) being substantially continuous, for purposes of illustrating the relationships of the element(s) or feature(s) as shown in the figures.

As used herein, the terms “array,” “row,” “column,” “series,” and the like describe an ordered sequence or arrangement of elements but do not necessarily limit the elements being described to sequences or arrangements that are linear or based on Cartesian coordinate systems like a matrix or a grid. It should be appreciated that the elements described in this manner can also be arranged in a non-linear fashion both in two-dimensional and in three-dimensional space, and that these elements may thereby be provided on three-dimensional bodies of various sizes, types, and configurations and still be operable as described herein.

The present technology improves upon conventional calendar systems, particularly the Ruderman Calendar, by providing a reconfigurable perpetual calendar device that eliminates the need for annual replacements. This innovative design incorporates movable elements, such as adjustable weekday tiles, day number columns, and month labels, allowing for easy updates to accommodate both regular years and leap years. The technology enhances the space-saving advantages of the Ruderman Calendar while addressing its limitations, offering a more versatile and long-lasting solution for calendar users. Additionally, the present technology introduces flexibility to adapt to various calendar formats, including academic and fiscal calendars, expanding its utility across different professional and institutional settings. By combining the intuitive weekday determination method of the Ruderman Calendar with these advancements, the present technology offers a more efficient, adaptable, and user-friendly approach to calendar systems.

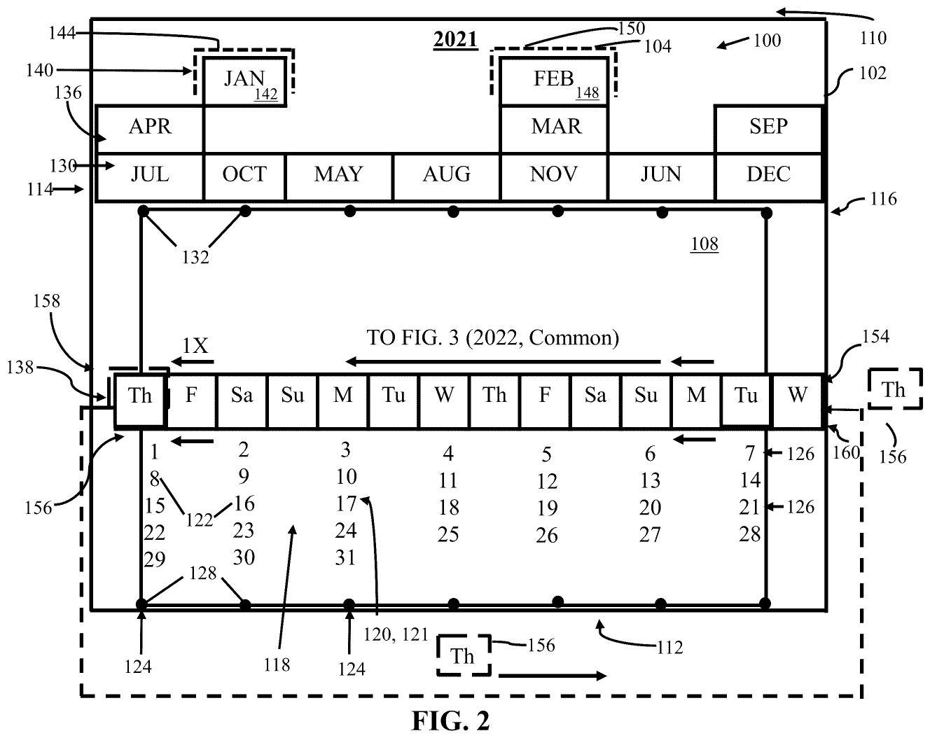

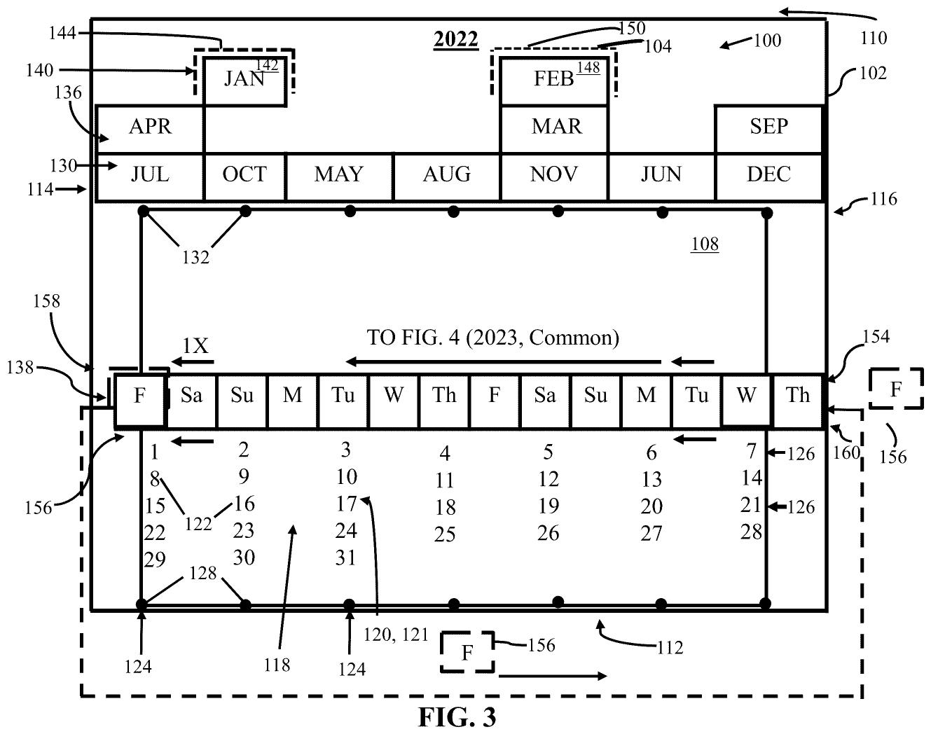

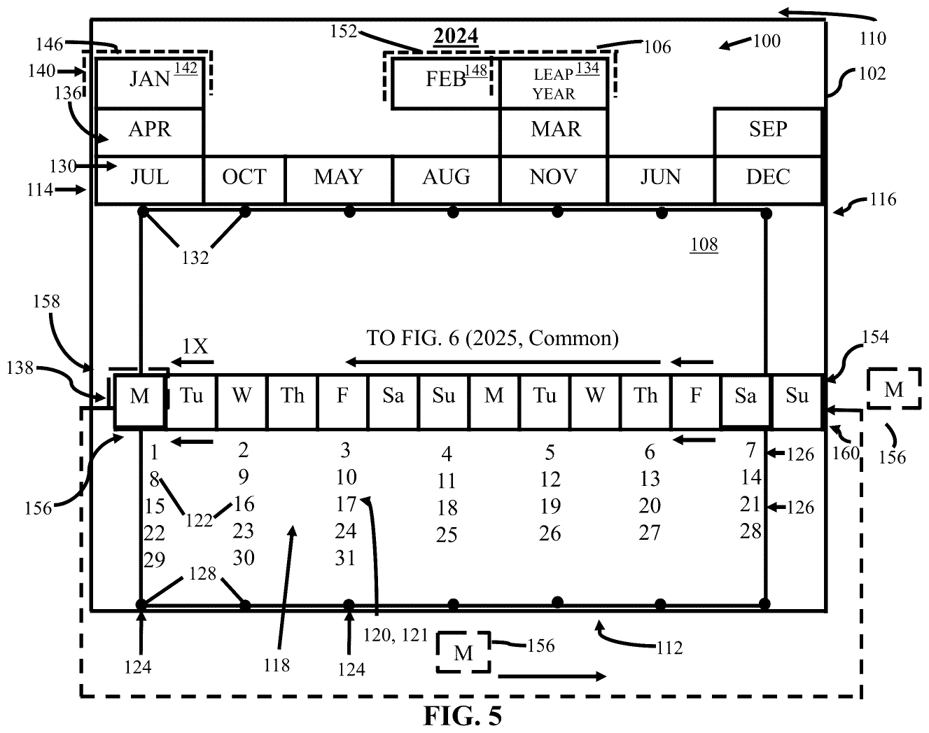

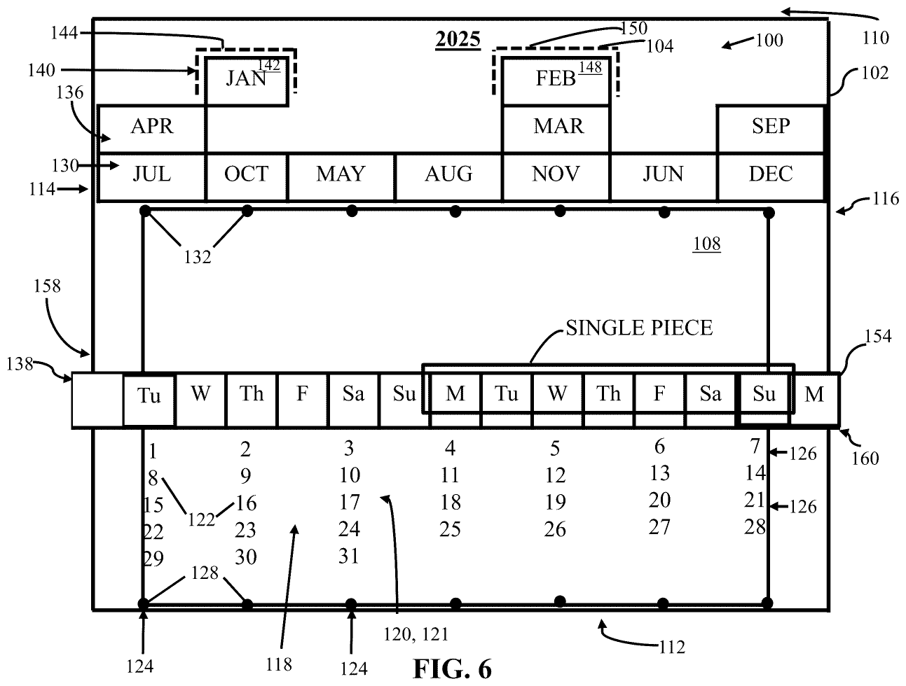

As shown in FIG. 2-6, the present disclosure includes a first perpetual calendar device 100. The first perpetual calendar device 100 may be operable under a Ruderman method of making a weekday determination and may also permit an annual update between a former calendar year and a new calendar year. The device may have a calendar body 102 that may permit a user to make the weekday determination by selecting a day number and a month name. The calendar body 102 may permit the annual update by the user performing a reconfiguration of the calendar body 102. The calendar body 102 may also have a common year mode 104 (shown in FIG. 2) rendering the calendar body 102 usable for the weekday determination during a common year, and a leap year mode 106 (shown in FIG. 5) rendering the calendar body 102 usable for the weekday determination during a leap year.

The calendar body 102 may have at least one surface 108 with a top side 110, a bottom side 112, a left side 114, and a right side 116. The at least one surface 108 may further have a base calendar layout 118 with immovable elements 120 and movable elements 138. The immovable elements 120 may include an array 121 of day number elements 122, a series of spaced apart day markers 128, a first row of month name elements 130, a series of spaced apart month markers 132, a leap year element 134 (shown in FIG. 5), and a second row of month name elements 136.

The array 121 of the day number elements 122 may have day number element columns 124 and day number element rows 126. The day number element columns 124 may be spaced apart evenly along a length of the calendar body 102 between the left side 114 and the right side 116 of the surface 108 and adjacent a bottom side 112 of the surface 108. The day number element rows 126 may be disposed evenly along a height of the calendar body 102 between the bottom side 112 and the right side 116 of the surface 108.

The series of spaced apart day markers 128 may be disposed adjacent to the array 121 and each day marker of the series of spaced apart day markers 128 may be aligned with one of the day number element columns 124. The first row of month name elements 130 may be disposed on the surface 108 between the array 121 and the top side 110 of the surface 108. The series of spaced apart month markers 132 may be disposed adjacent to the first row of month name elements 130 and each month marker of the series of spaced apart month markers 132 may be aligned with one of the month name elements.

The leap year element 134 may be disposed on the surface 108 between the first row of month name elements 130 and the top side 110 of the surface 108. The leap year element 134 may be exposed during the leap year to signify to the user that the calendar body 102 may be in the leap year mode 106. The second row of month name elements 136 may be disposed on the surface 108 between the first row of month name elements 130 and the leap year element 134.

The movable elements 138 may include a third row of month name elements 140, and a fourth row of weekday name elements 154. The third row of month name elements 140 may include a first month element 142 and a second month element 148. The first month element 142 may be configured to move toward the left side 114 of the surface 108 to a first month element leap year position 146 (shown in FIG. 5) when the calendar body 102 may be reconfigured to the leap year mode 106, and to move toward the right side 116 of the surface 108 to a first month element common year position 144 when the calendar body 102 may be reconfigured to the common year mode 104.

The second month element 148 may be configured to move toward the left side 114 of the surface 108 to a second month element leap year position 152 when the calendar body 102 may be reconfigured to the leap year mode 106, and to move toward the right side 116 of the surface 108 to a second month element common year position 150 when the calendar body 102 may be reconfigured to the common year mode 104. The second month element 148 may be disposed over and covering the leap year element 134 while in the second month element common year position 150.

The fourth row of weekday name elements 154 may be configured to move toward the left side 114 of the surface 108 during the annual update, and a leftmost one of the weekday name elements 156 may be configured to move from a leftmost side of the fourth row 158 to a rightmost side of the fourth row 160 during the annual update.

The calendar body 102 may be operable by the user under the Ruderman method to make the weekday determination by selecting the day number, selecting the month name, and visualizing a line extending from one of the series of spaced apart month markers 132 aligned with the one of the month name elements associated with the month name that may be selected to one of the series of spaced apart day markers 128 aligned with one of the day number element columns 124 associated with the day number that may be selected, with the line intersecting one of the weekday name elements in the fourth row 154 to thereby reveal a weekday associated with the day number and the month name selected by the user.

In some embodiments, the calendar body 102 may be configured for a full calendar year, with the first month element 142 being a January month element and the second month element 148 being a February month element. Alternatively, the calendar body 100 may be configured for one of a full calendar year, an academic year, or a fiscal year. The array 121 may have seven day number element columns 124 and five day number element rows 126.

With respect to the calendar body 100 being configured for non-standard calendar years, such as the academic year or the fiscal year, for example, it should be appreciated that the only difference between a standard and non-standard calendar is the months that have to move to take care of leap. The months always are from the start of the calendar (standard or not) through February. So, for example, in a standard calendar, only January and February have to move in accordance with the operation described herein. Similarly, in a fiscal year July 1 through June 30 calendars, July-August-Sept-Oct-Nov-Dec-Jan-Feb all have to move. The calendar July 2023-June2024 is for a leap fiscal year, and July 2024-June 2025 is for a common year. Note that when July-August-Sept-Oct-Nov-Dec-Jan-Feb moves, Oct is bumped off the right most and has to jump to the left most position.

In certain embodiments, each of the immovable elements 120 may be printed to the surface 108 of the calendar body 102. The movable elements 138 may be either magnetically or mechanically movably secured to the surface 108 of the calendar body 102. In some embodiments, the perpetual calendar device 100 may include a slider that is slidably attached to the calendar body 102, with the first month element 142 and the second month element 148 attached to the slider so that they may be movable together.

In additional embodiments, each of the movable elements 138 may be a tile. The surface 108 of the calendar body 102 may include at least one of a rail or a channel that slidably receives the movable elements 138. The fourth row of weekday name elements 154 may include both individually movable weekday units and a single piece having multiple movable weekday units.

It should be appreciated that the at least one surface 108 of the calendar body 102 may be substantially planar. Alternatively, the calendar body 102 may be three-dimensional and the surface 108 may be substantially non-planar. The surface 108 of the calendar body 102 may be substantially continuous, with each of the top side 110, the bottom side 112, the left side 114, and the right side 116 not being terminal.

In some embodiments, the calendar body 102 may be three-dimensional, the surface 108 may be substantially non-planar, and the fourth row of weekday name elements 154 may be presented as a continuous band that circumscribes the calendar body 102. The calendar body 102 may also be generated as a graphical user interface of a computerized display. One skilled in the art may select suitable formats for the calendar body 102 and the associated at least one surface 108, as desired.

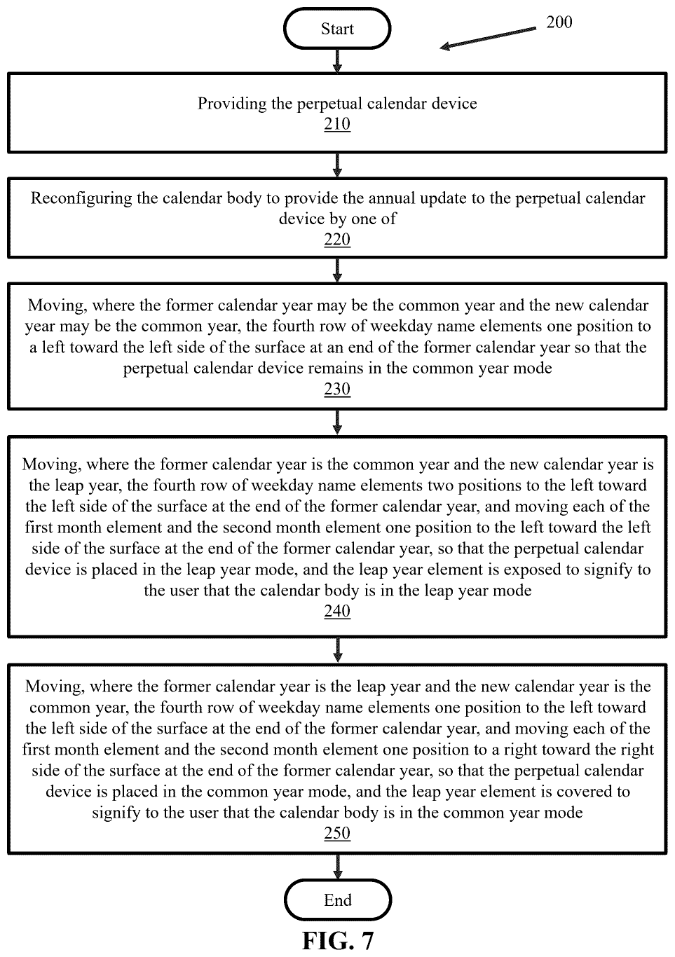

As shown in FIG. 7, a first method 200 of updating the first perpetual calendar device 100 from the former calendar year to the new calendar year may have several steps. The first step 210 may involve providing the first perpetual calendar device 100. The next step 220 may involve reconfiguring the calendar body 102 to provide the annual update to the first perpetual calendar device 100. The method may then proceed with one of three possible scenarios for reconfiguring the calendar body 102, depending on the transition between the former and new calendar years.

Although described herein with respect to a forward update, one of ordinary skill in the art should appreciate that the steps of the first method 200 may also be performed in a reverse update in order to generate a past calendar operable under the Ruderman method of making the weekday determination, within the scope of the present disclosure.

In the first scenario 230, where the former calendar year is the common year and the new calendar year is also the common year, the method may involve moving the fourth row of weekday name elements 154 one position to the left toward the left side 114 of the surface 108 at the end of the former calendar year. In the second scenario 240, where the former calendar year is the common year and the new calendar year is the leap year, the method may involve moving the fourth row of weekday name elements 154 two positions to the left toward the left side 114 of the surface 108 at the end of the former calendar year, and moving each of the first month element 142 and the second month element 148 one position to the left toward the left side 114 of the surface 108 at the end of the former calendar year.

The third scenario 250 may occur when the former calendar year is a leap year and the new calendar year is a common year. In this case, the method may involve moving the fourth row of weekday name elements 154 one position to the left toward the left side 114 of the surface 108 at the end of the former calendar year, and moving each of the first month element 142 and the second month element 148 one position to the right toward the right side 116 of the surface 108 at the end of the former calendar year. The first perpetual calendar device 100 is thereby rendered operable for the new calendar year. This step may be the culmination of the reconfiguration process, ensuring that the device is ready for use in the upcoming year.

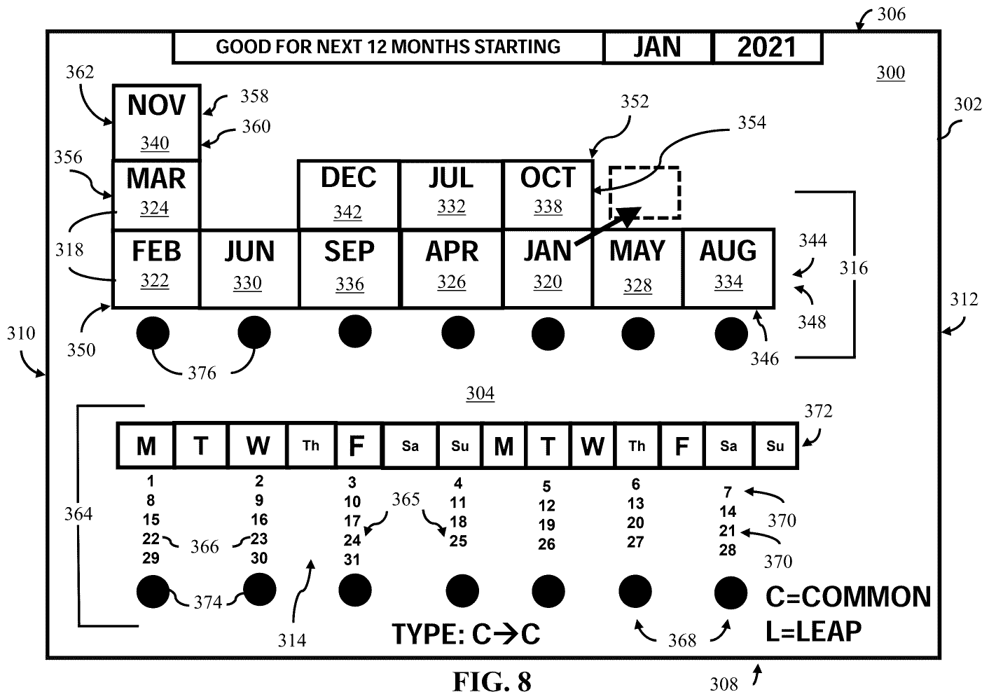

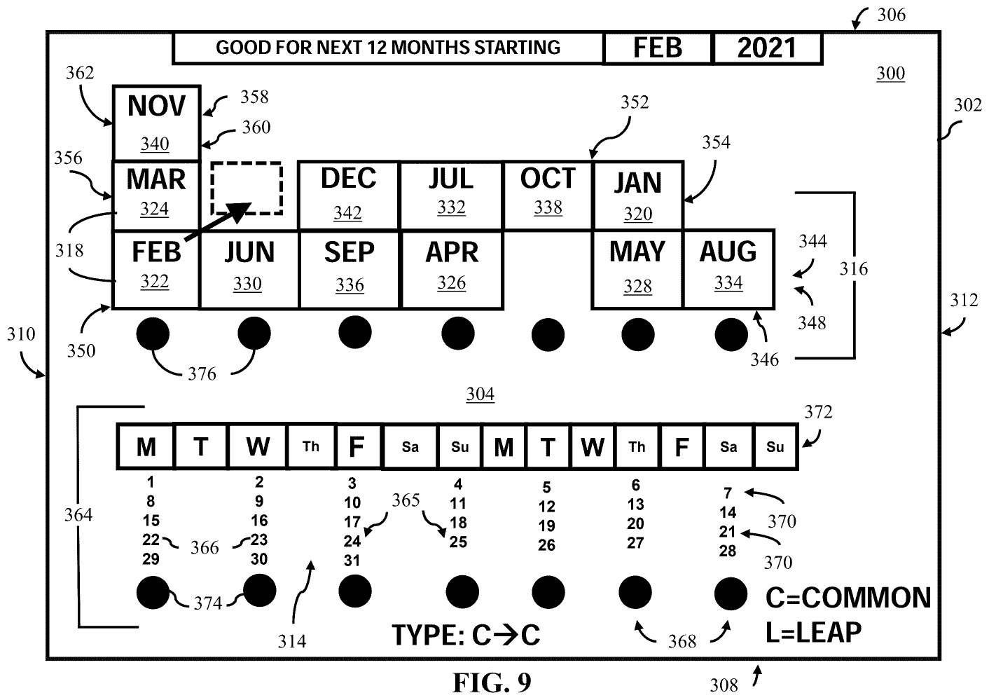

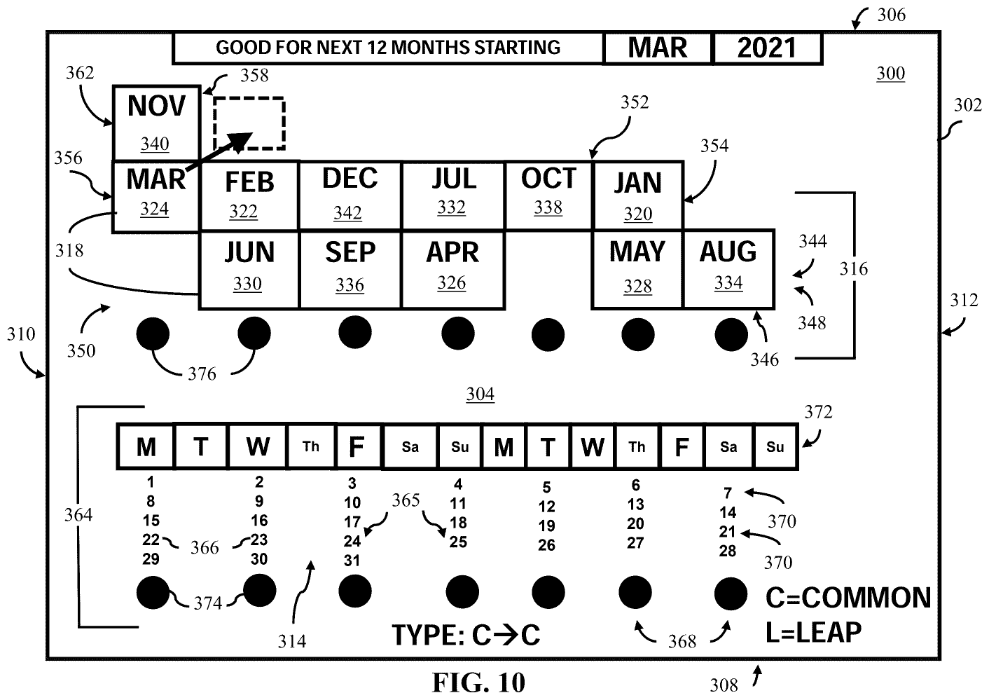

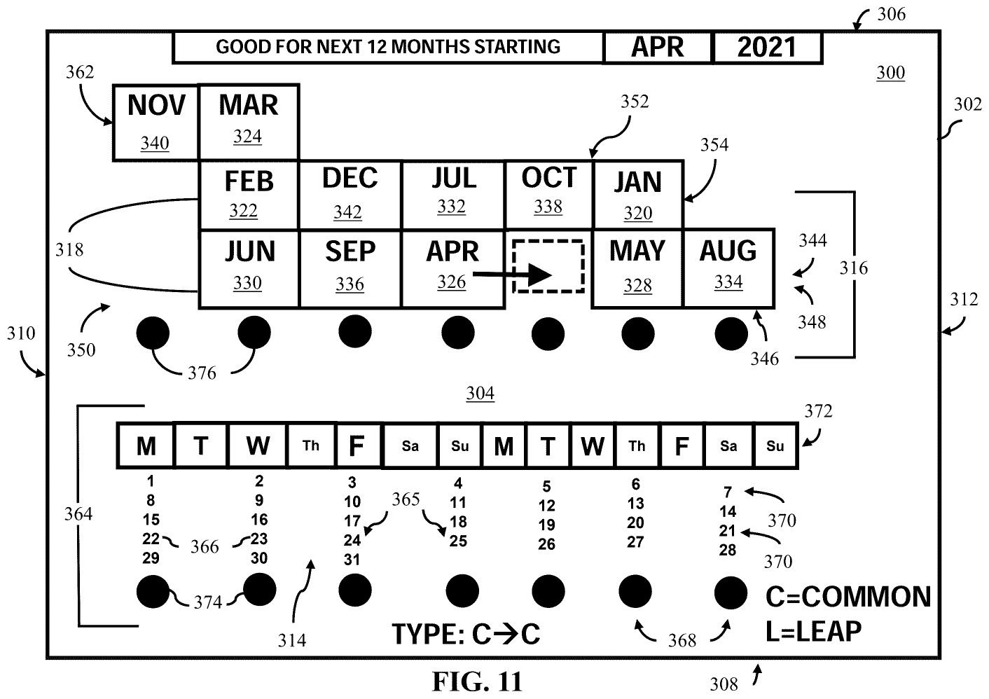

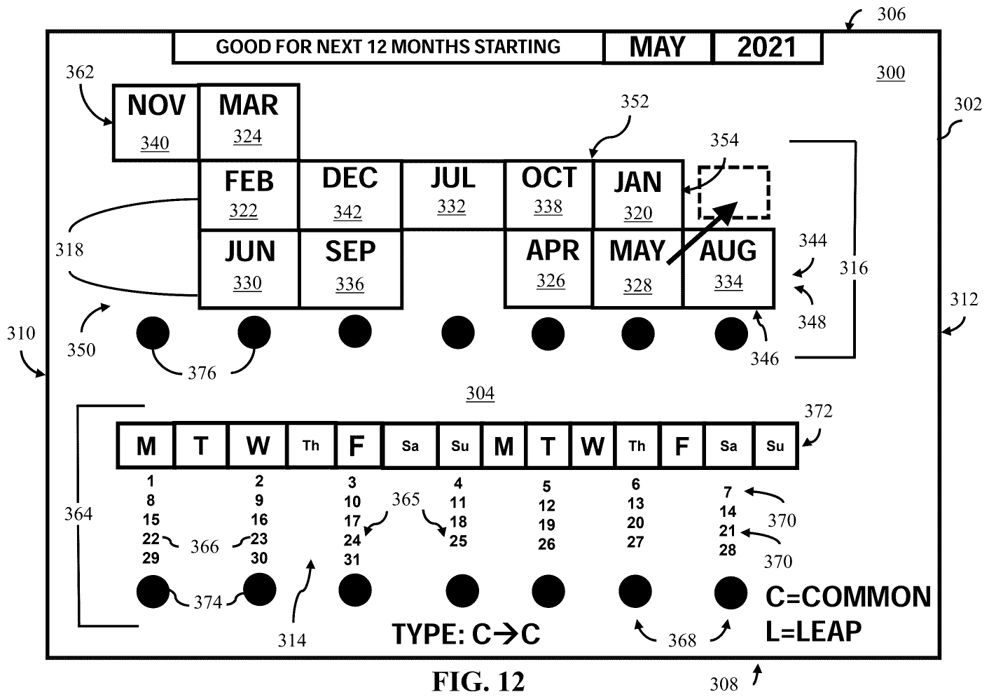

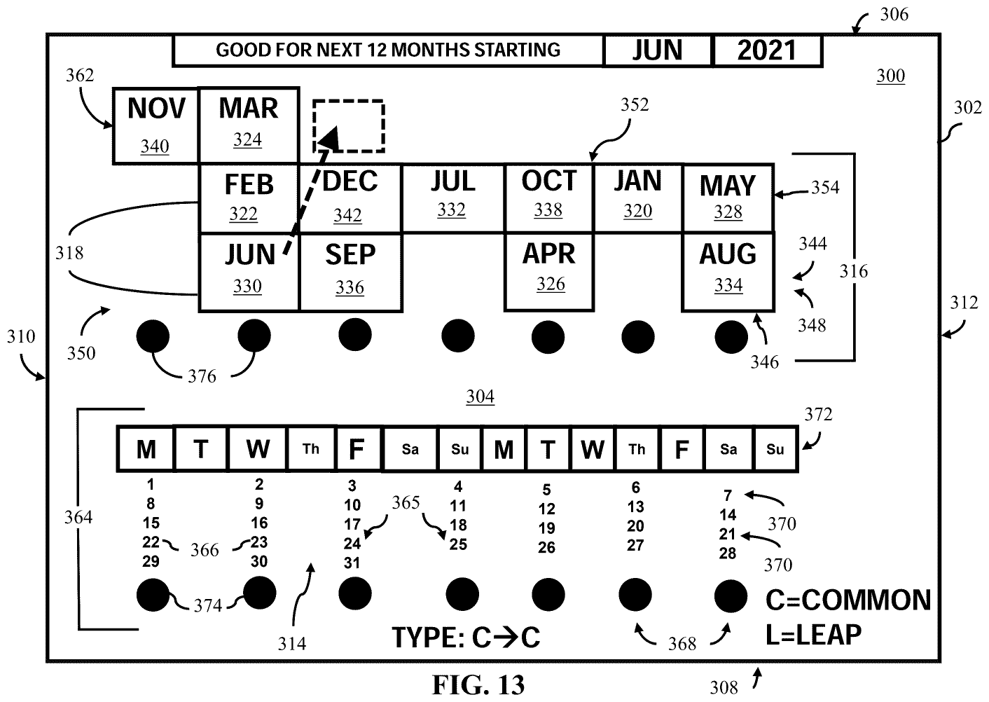

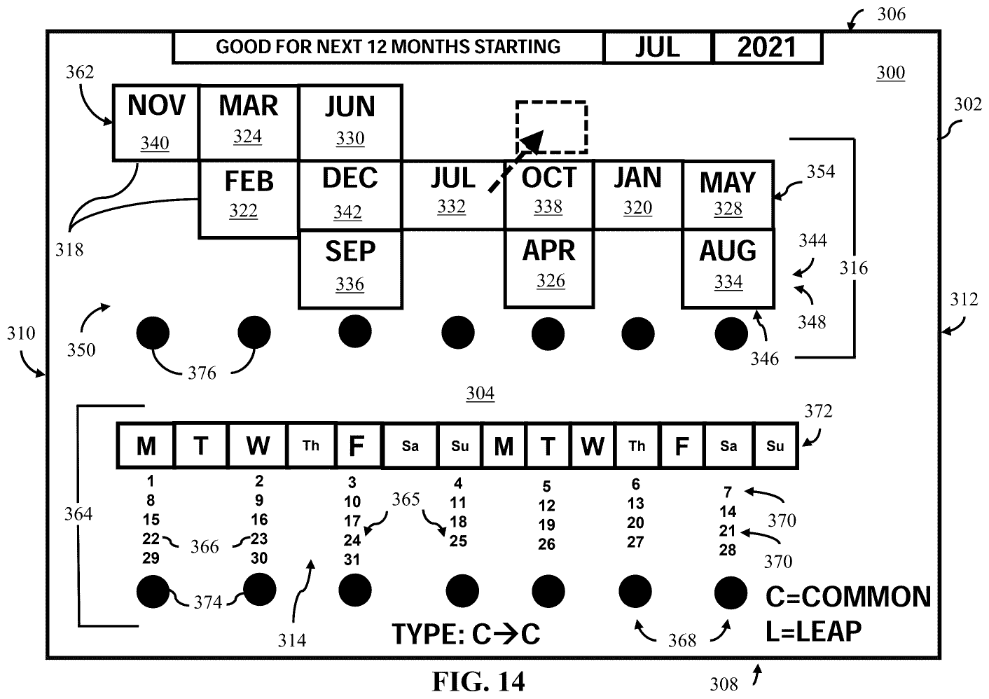

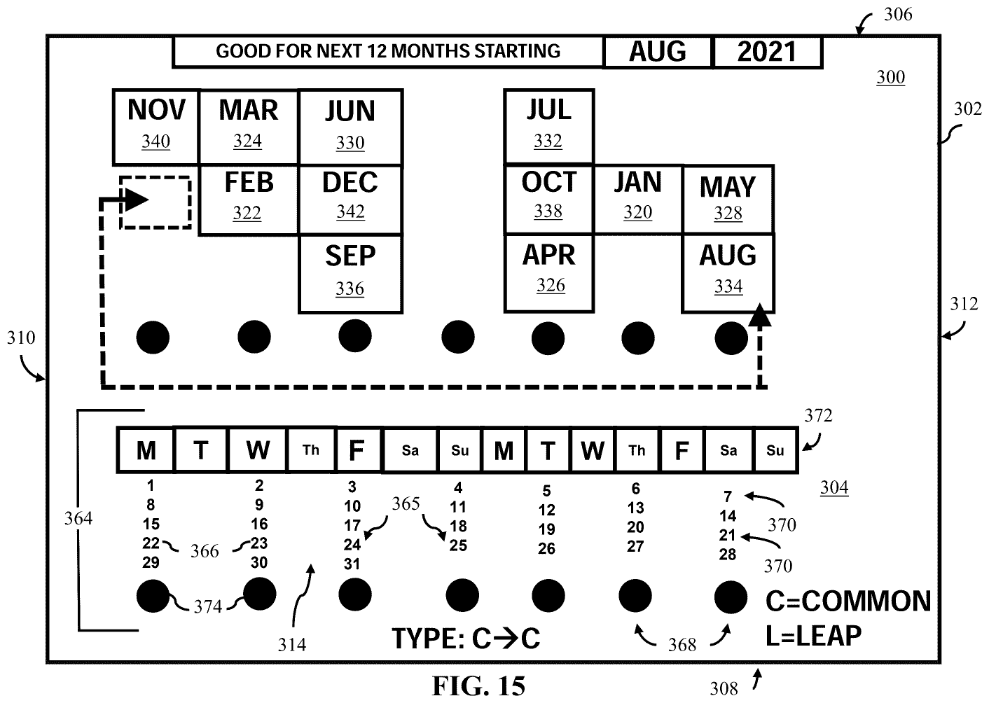

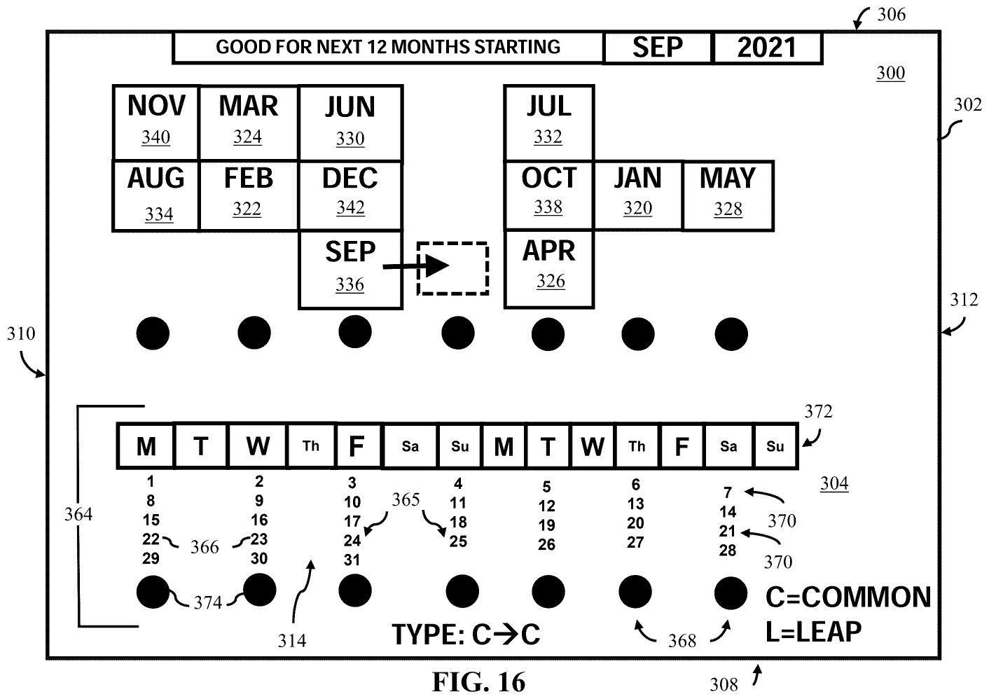

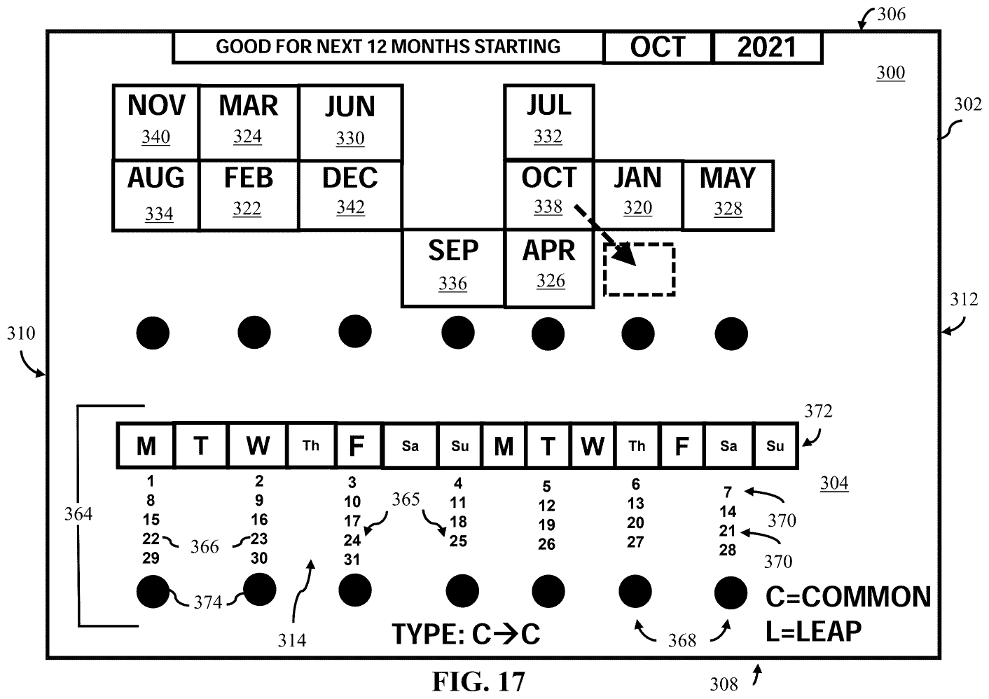

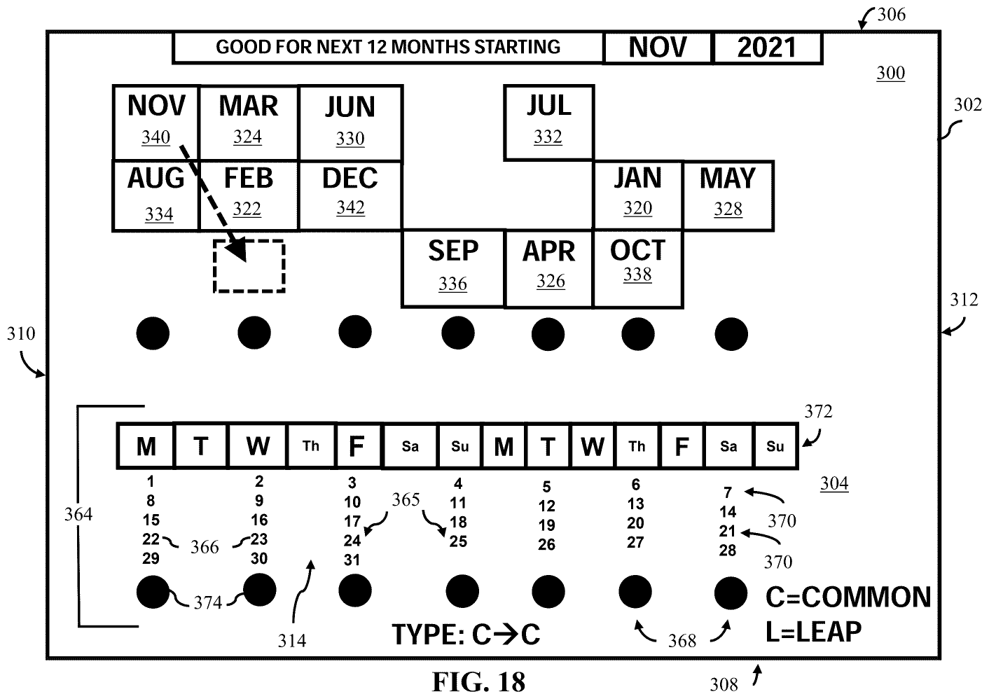

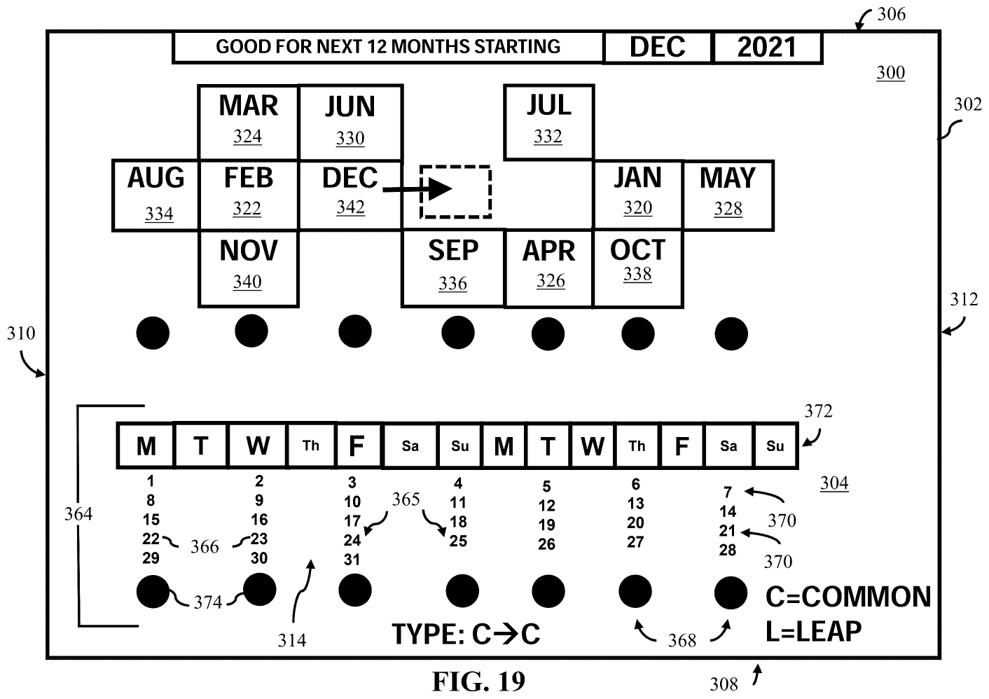

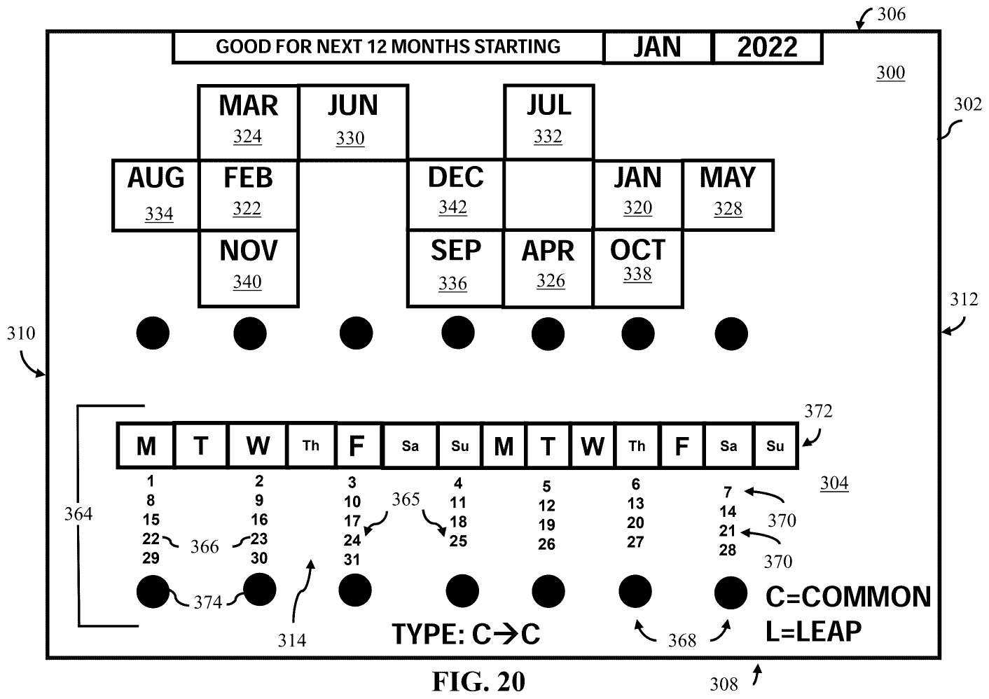

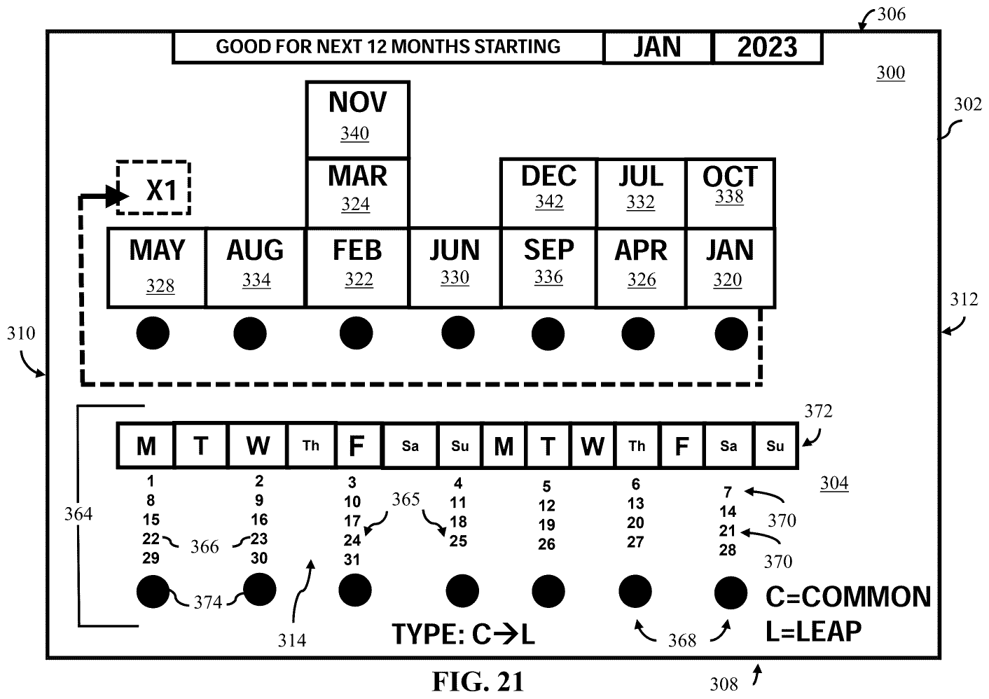

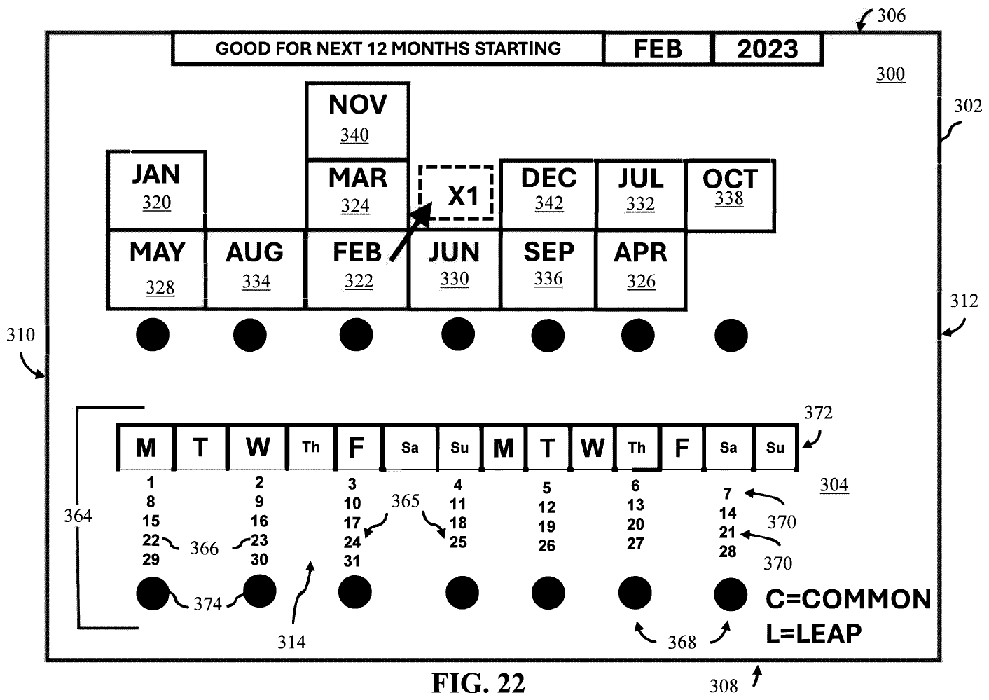

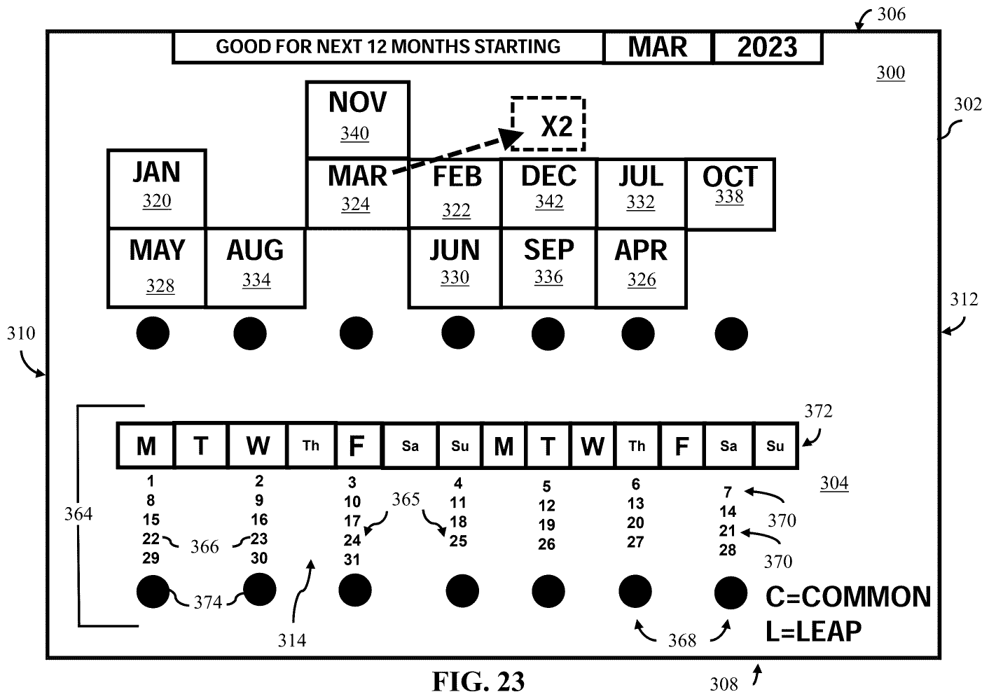

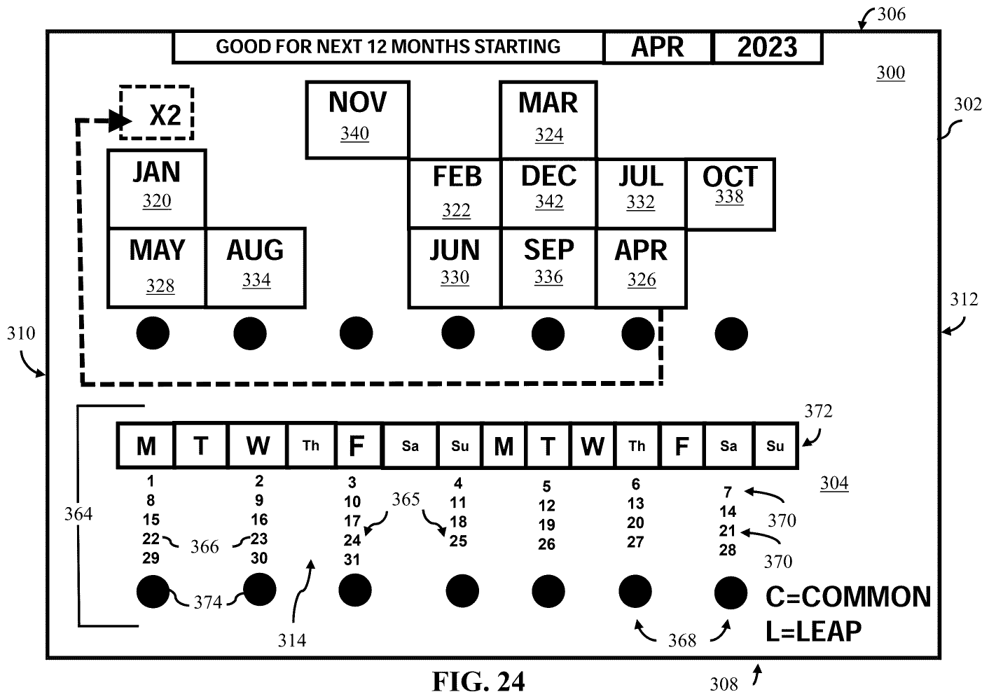

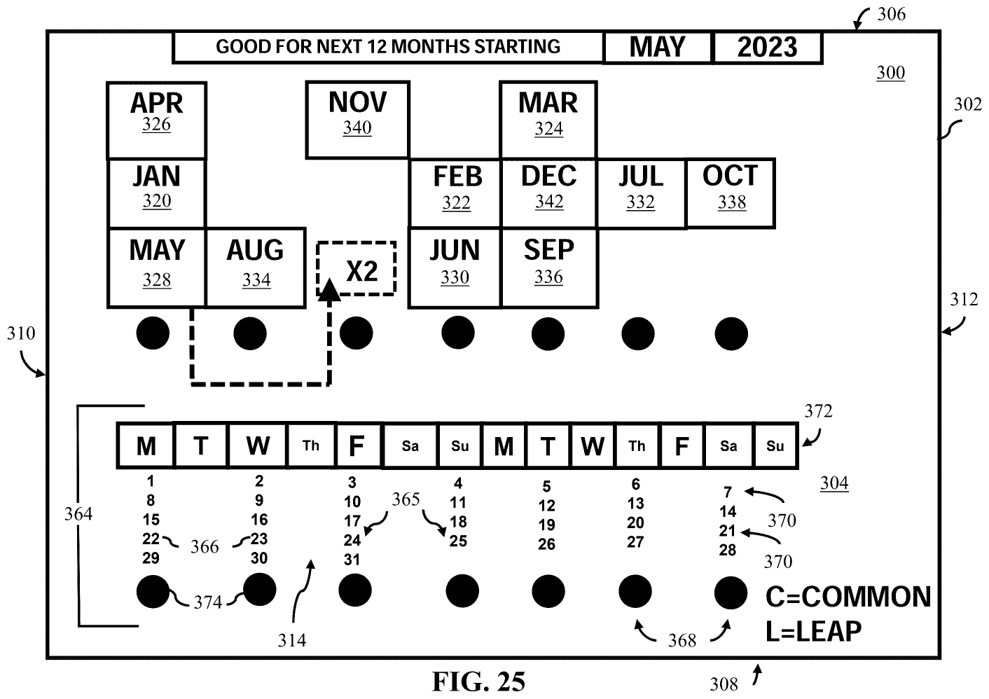

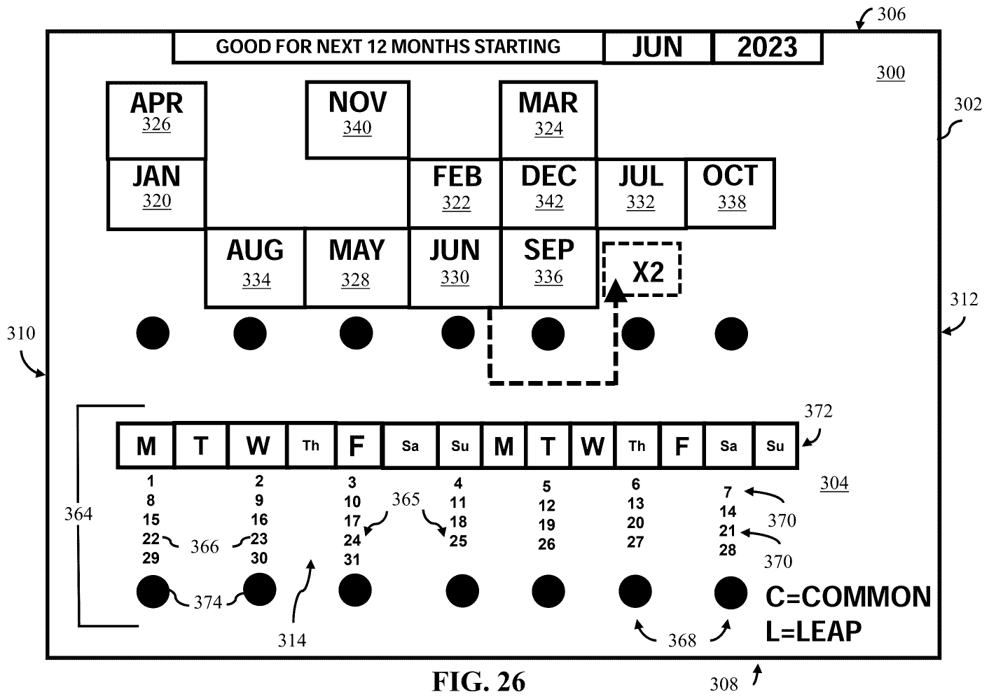

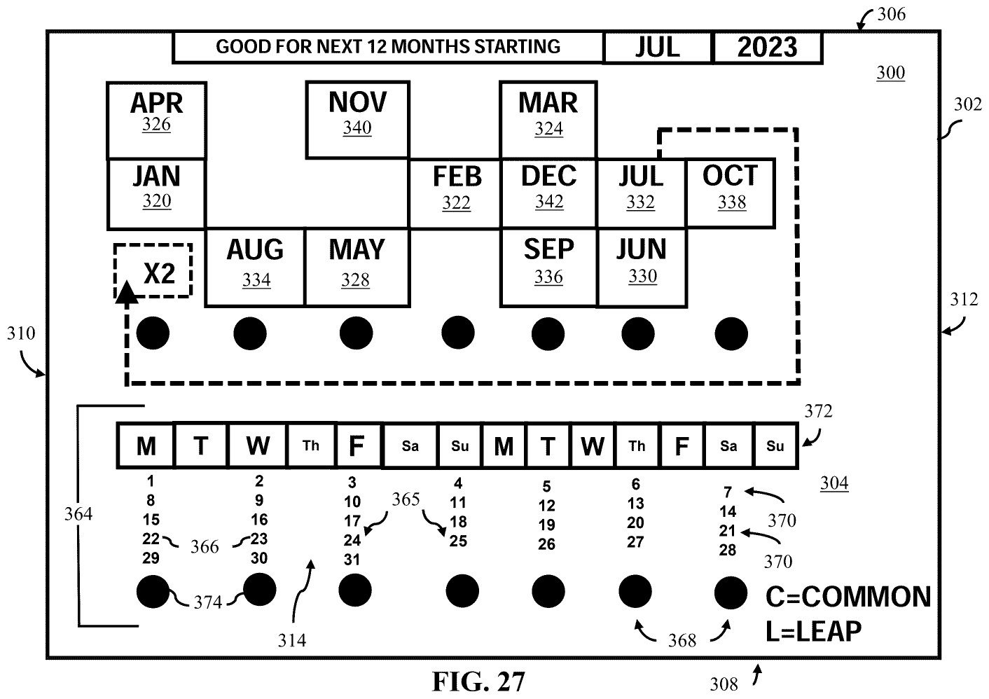

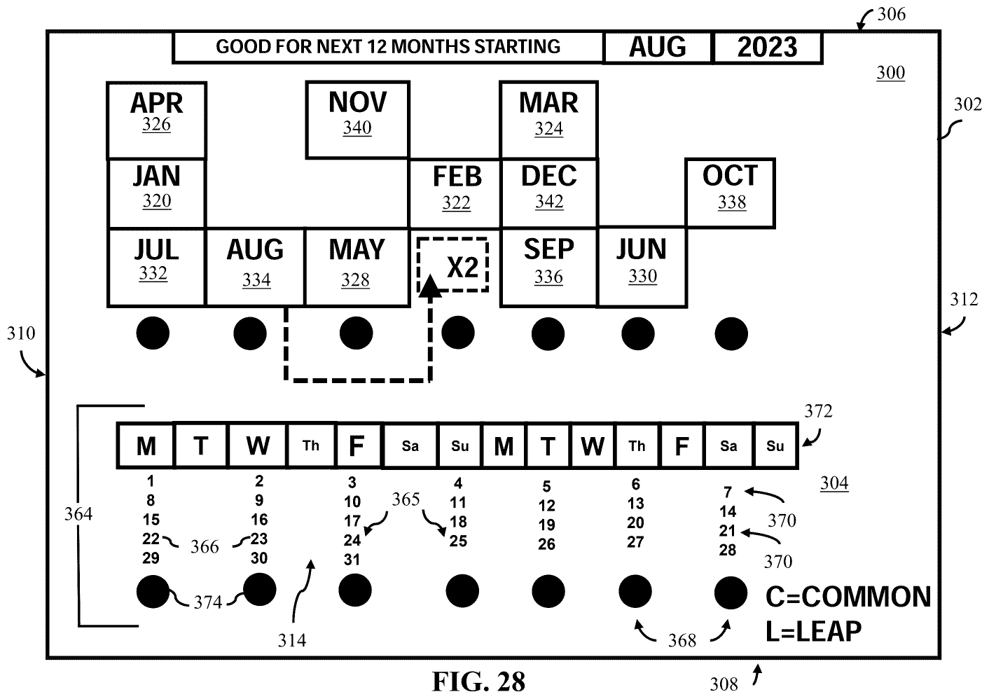

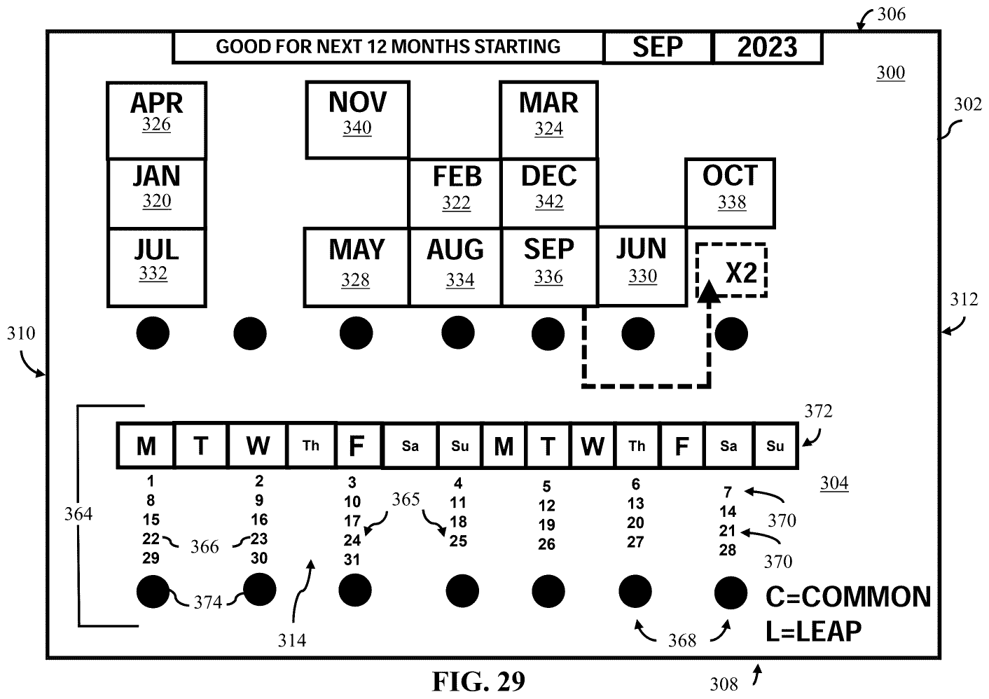

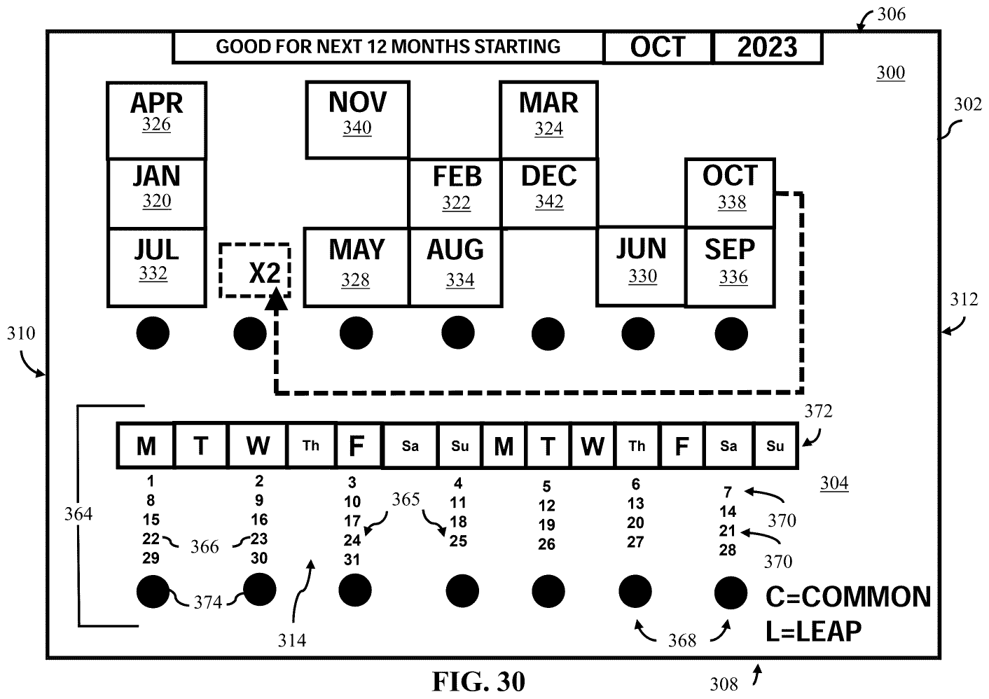

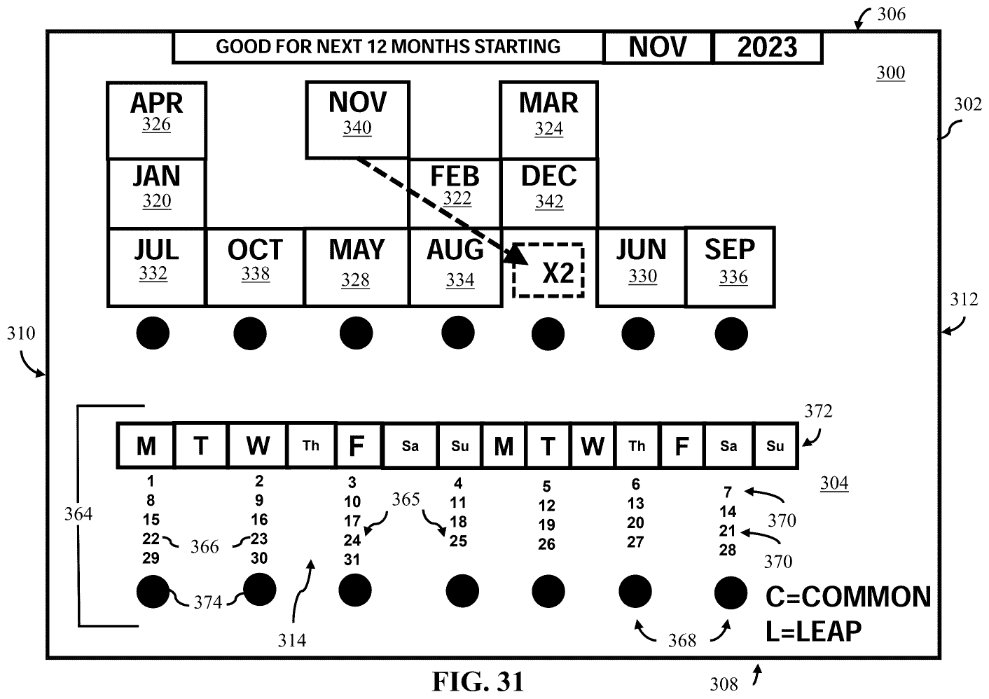

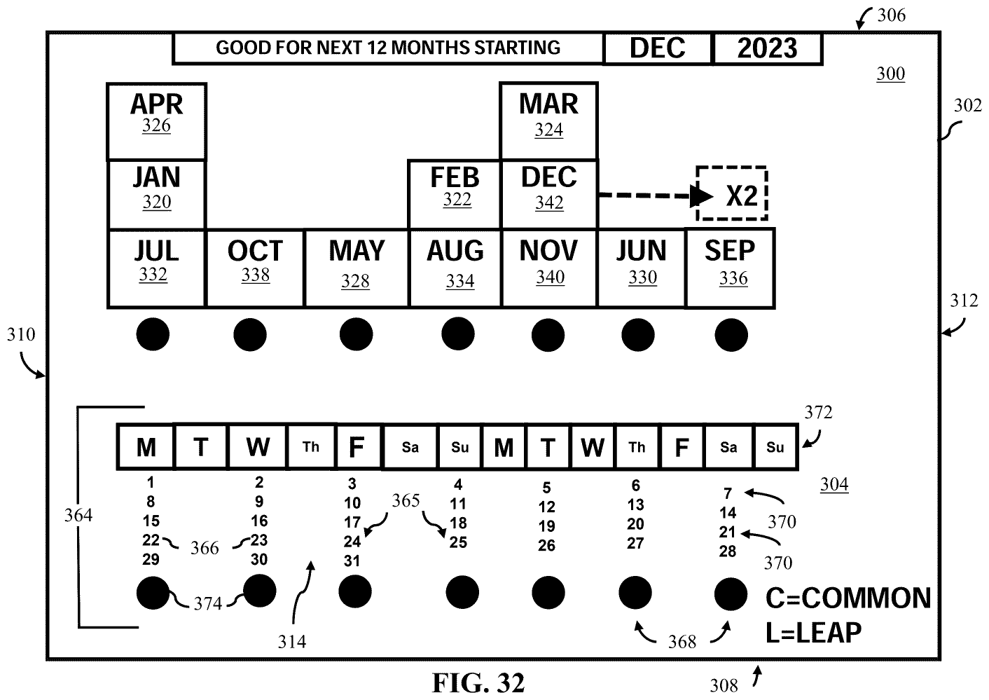

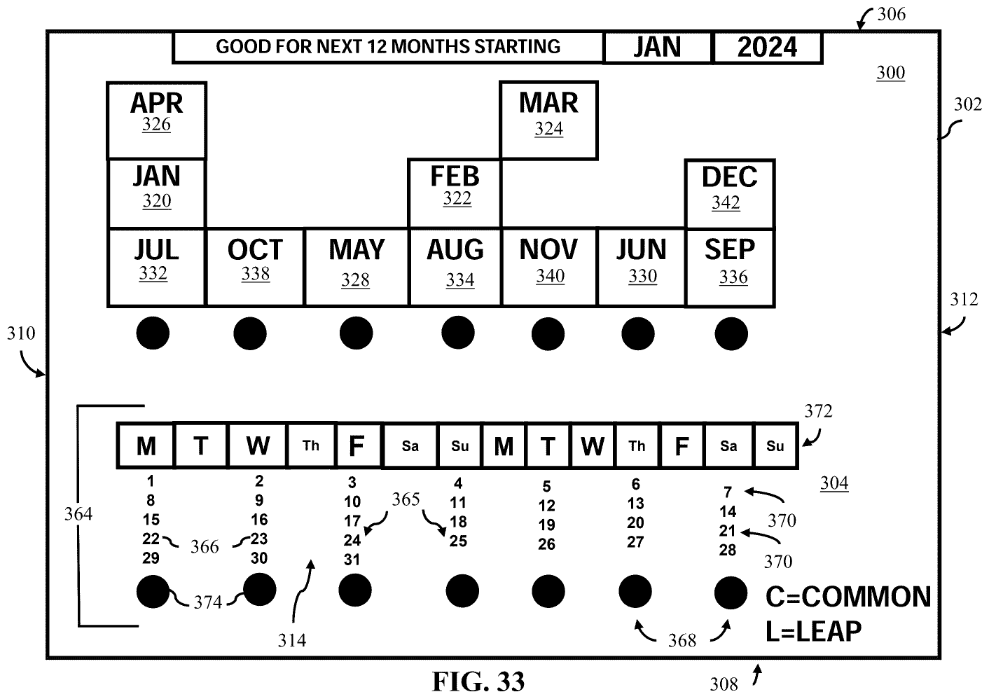

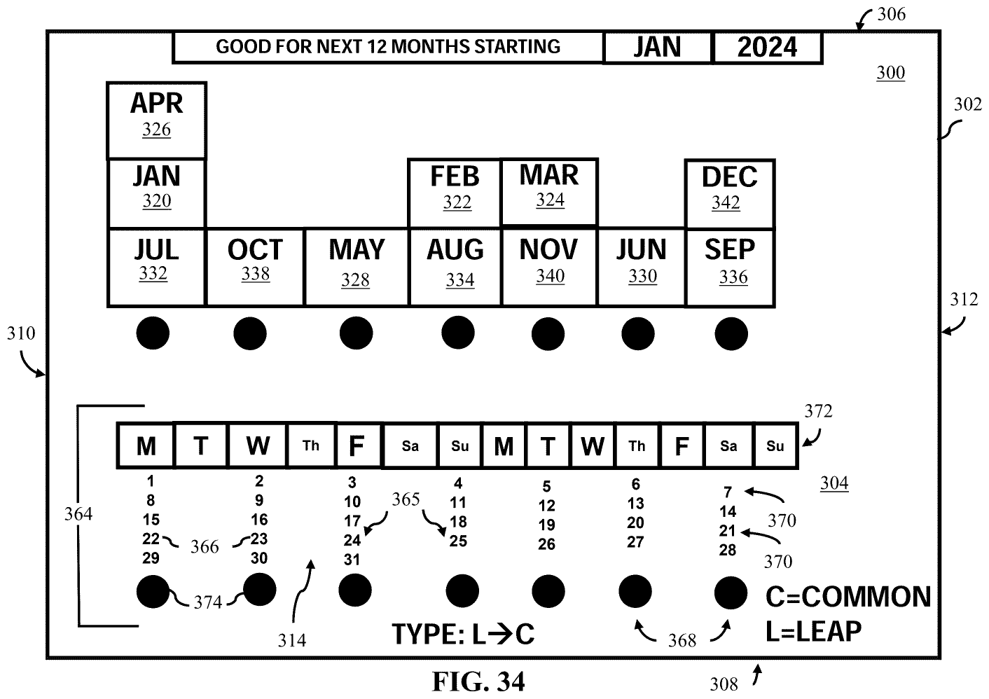

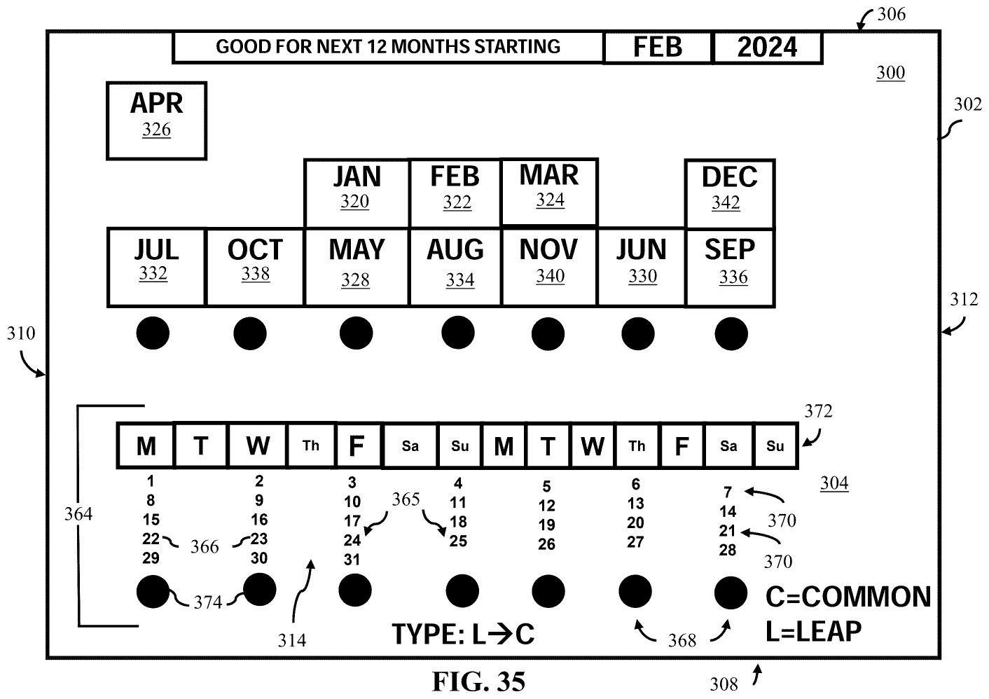

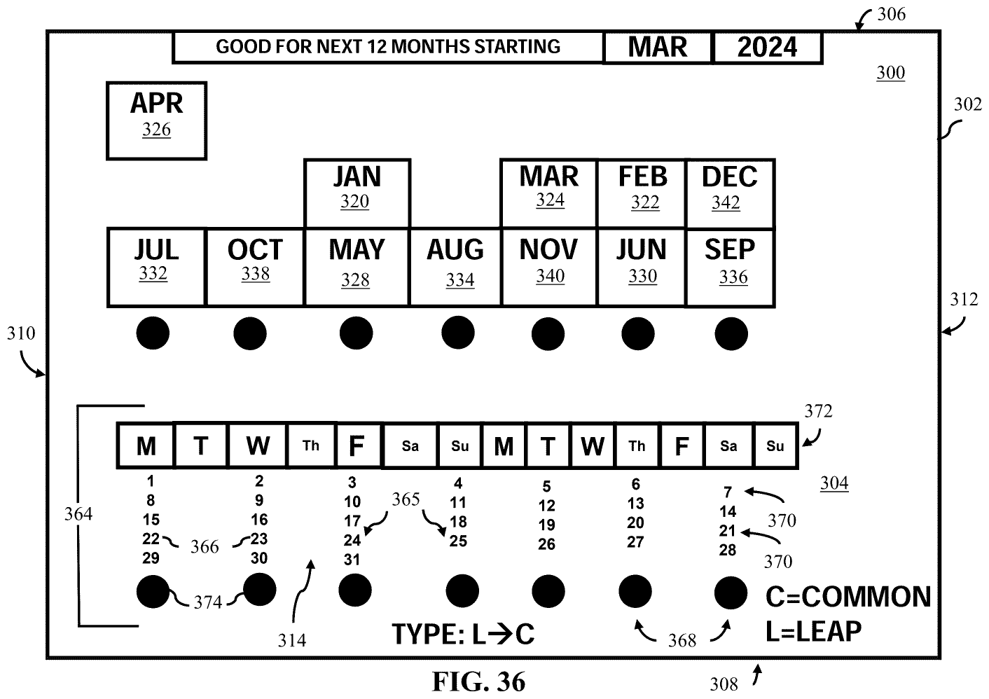

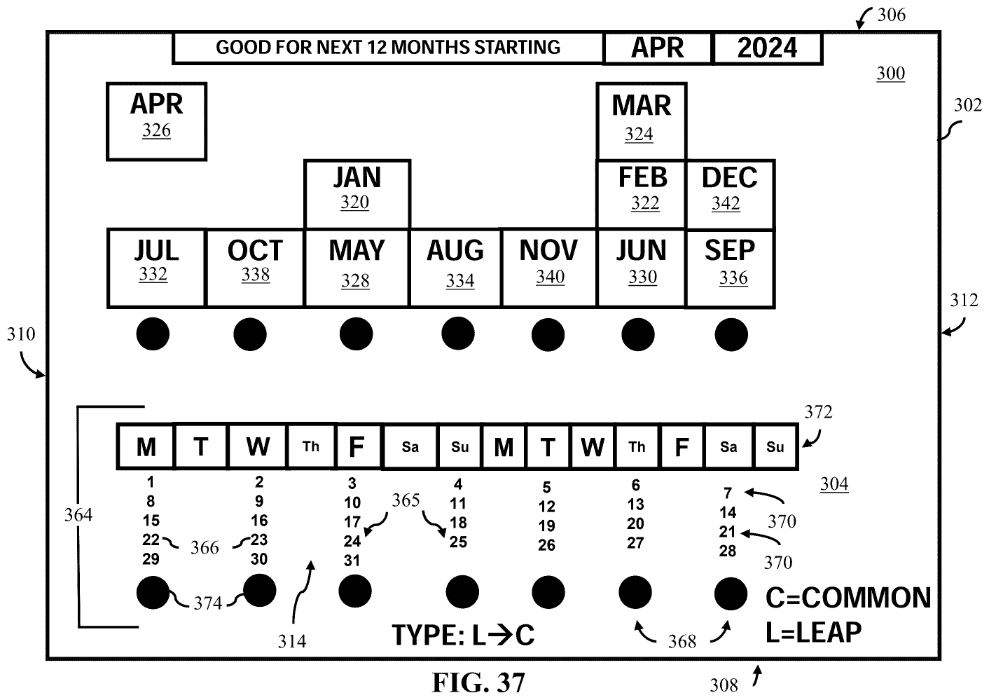

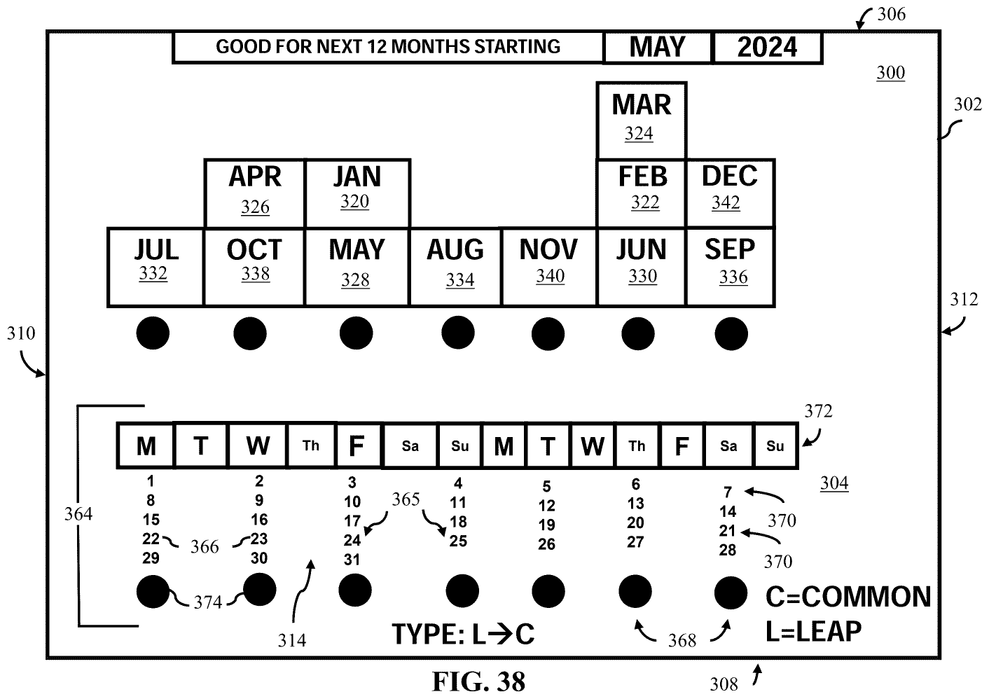

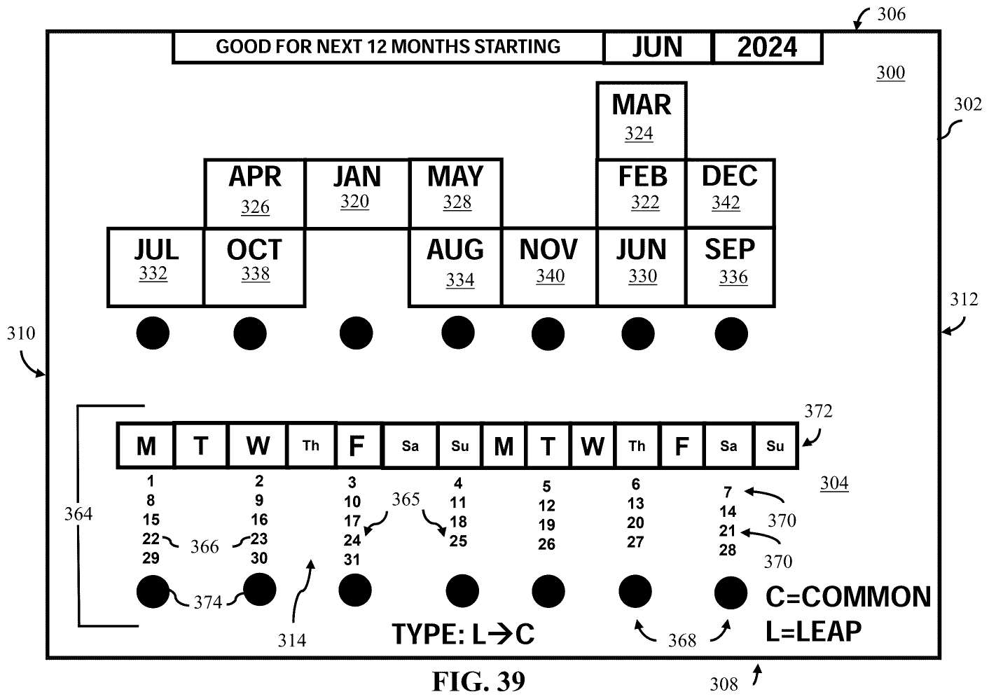

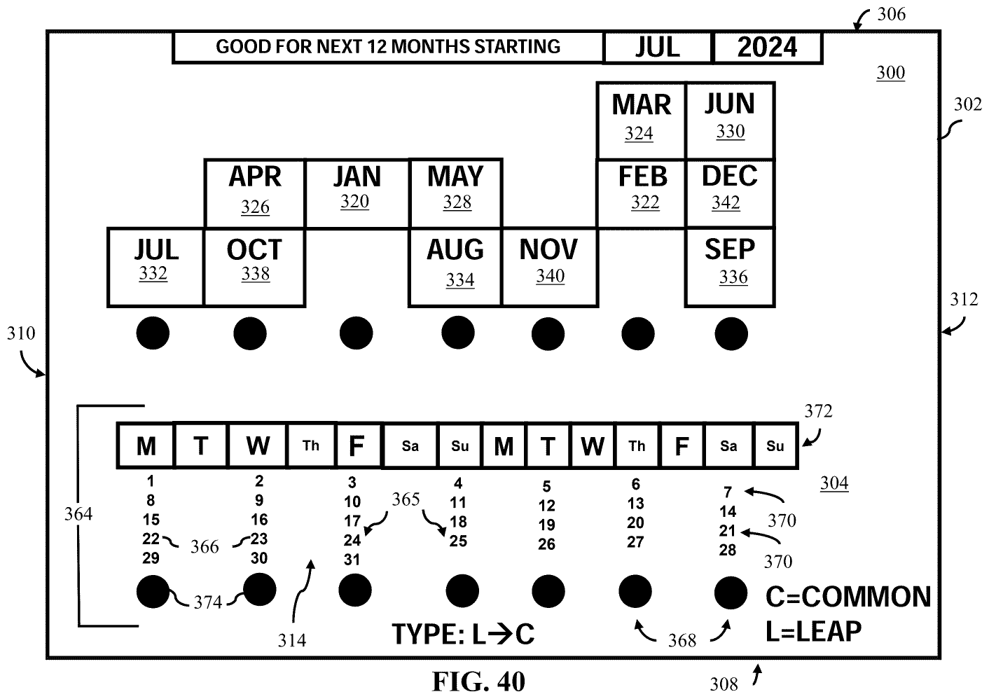

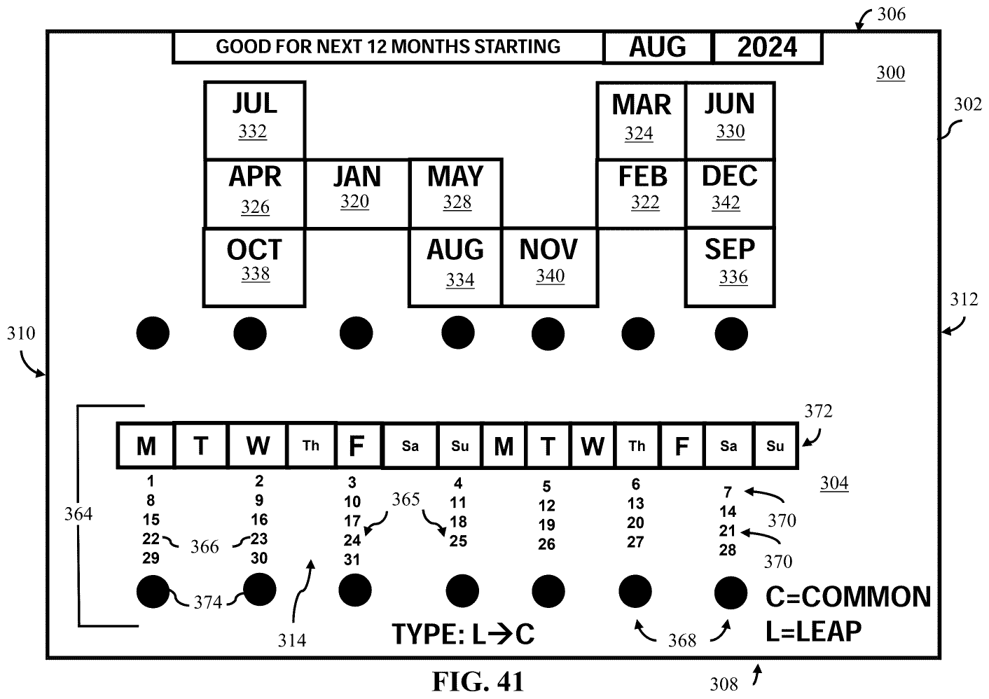

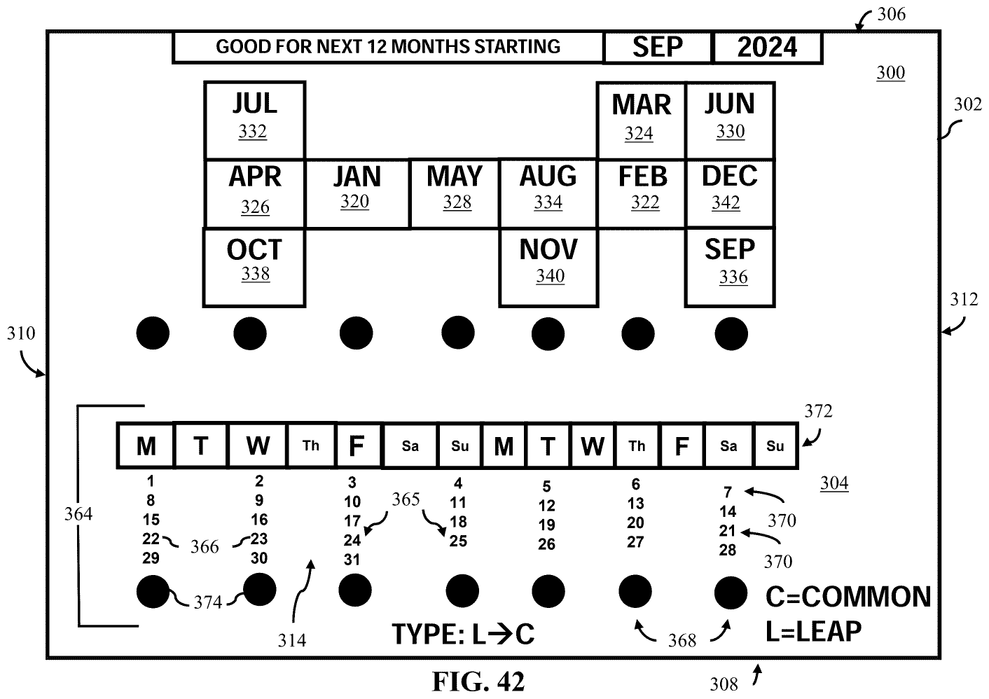

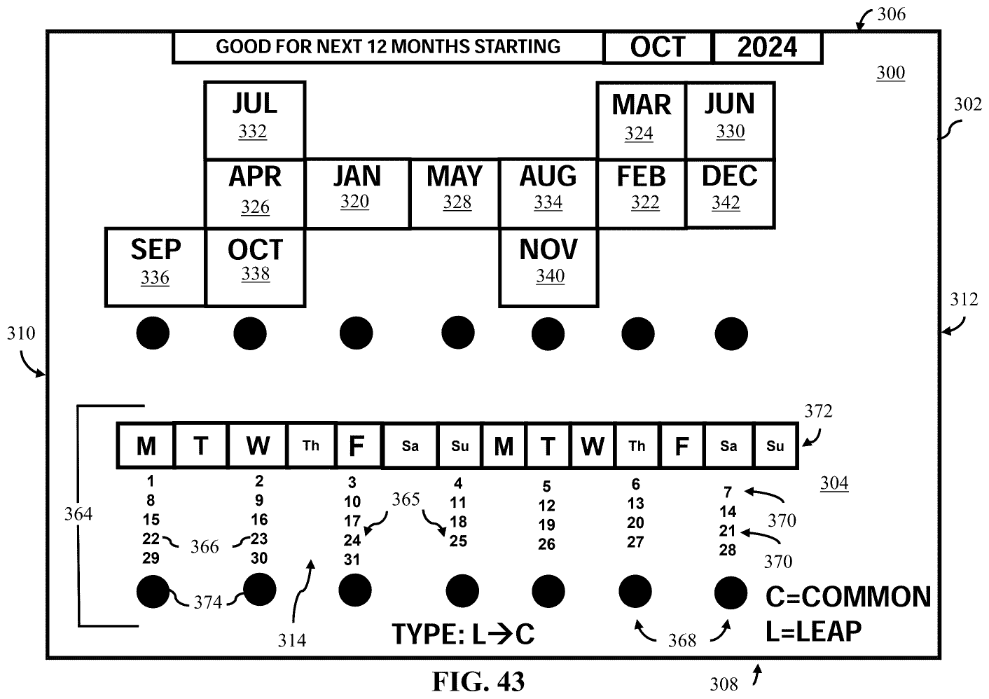

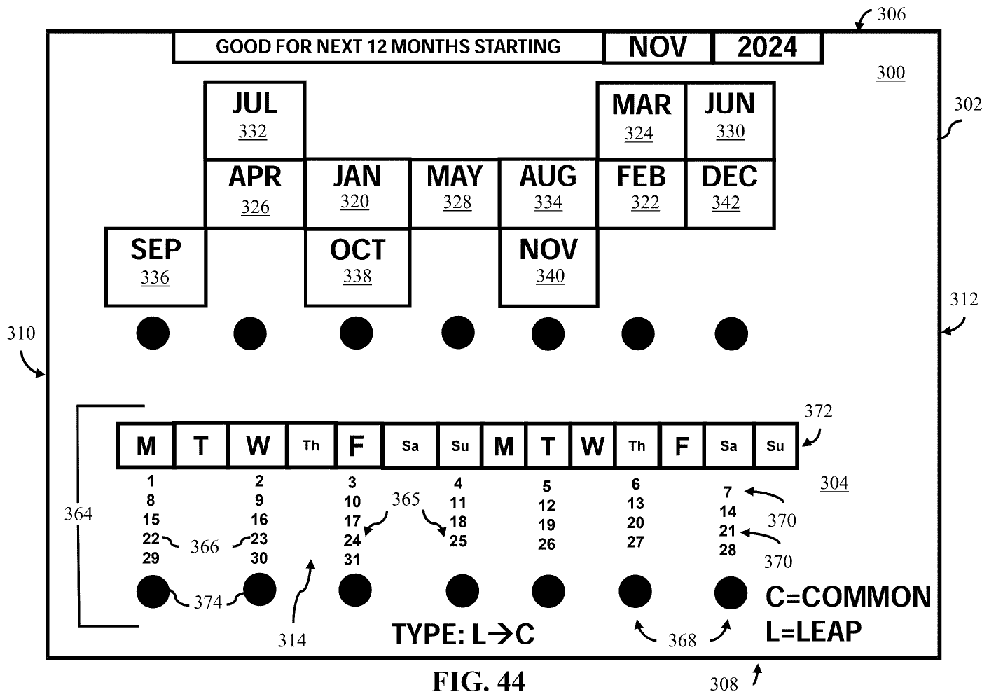

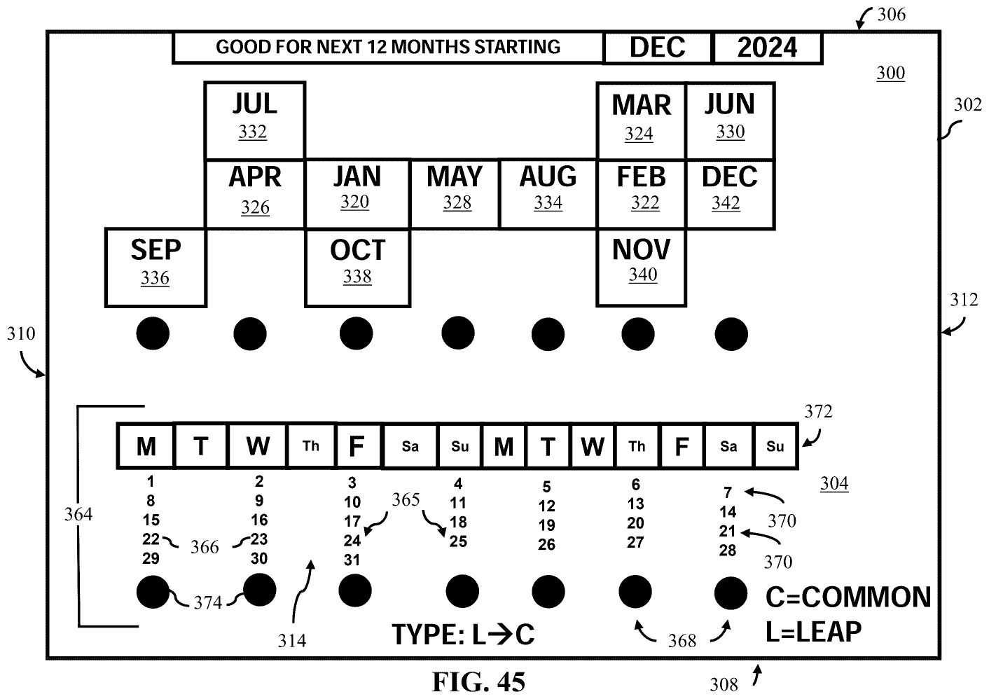

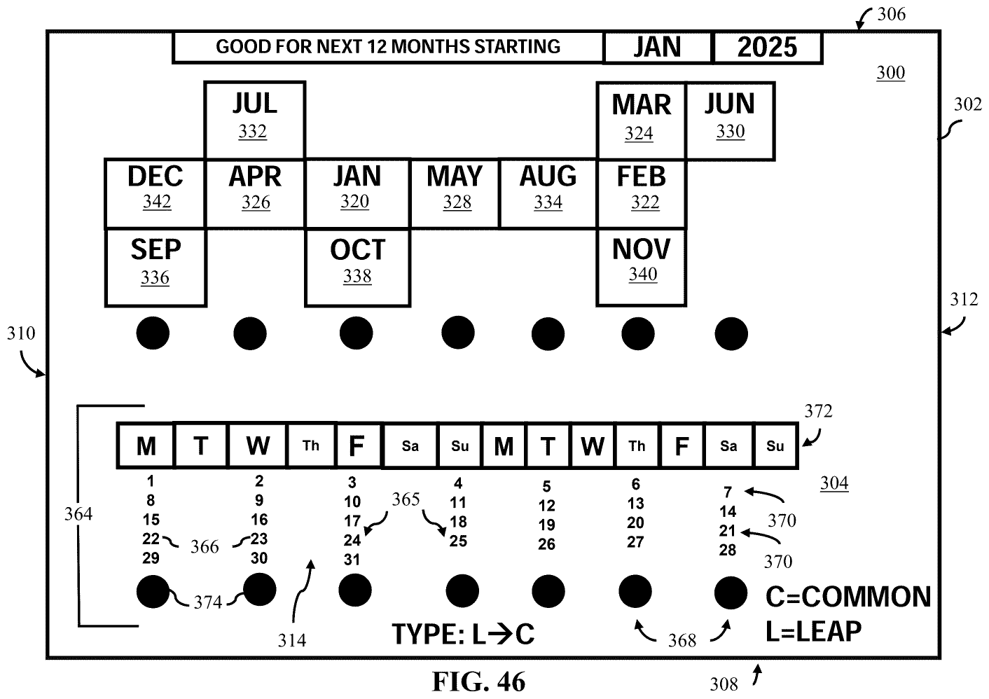

As shown in FIGS. 8-46, a second perpetual calendar device 300 may be operable under a Ruderman method of making a weekday determination and may also permit a monthly update to provide a rolling calendar year effective for the next twelve (12) months. It should be appreciated that the second perpetual calendar device 300 may also be provided with substantially the same or similar features or formats as described hereinabove with respect to the first perpetual calendar device 100. One of ordinary skill in the art can select these features and formats for the second perpetual calendar device 300 within the scope of the present disclosure.

In particular, the second perpetual calendar device 300 may have a calendar body 302 that may permit a user to make the weekday determination by selecting a day number and a month name. The calendar body 302 may permit the monthly update by the user performing a reconfiguration of the calendar body 302 notwithstanding the rolling calendar year beginning in either a common year or in a leap year.

The calendar body 302 may have at least one surface 304 with a top side 306, a bottom side 308, a left side 310, and a right side 312. The surface 304 may further have a base calendar layout 314 with movable elements 316 and immovable elements 364. The movable elements 316 may include a plurality of month name elements 318, including a first row of month name elements 344, a second row of month name elements 352, and a third row of month name elements 358.

The plurality of month name elements 318 may include a January month element 320, a February month element 322, a March month element 324, an April month element 326, a May month element 328, a June month element 330, a July month element 332, an August month element 334, a September month element 336, an October month element 338, a November month element 340, and a December month element 342.

The first row of month name elements 344 may be disposed on the surface 304 between the bottom side 308 and the top side 306 of the surface 304. Each of the month name elements in the first row 344 may be configured to individually move toward the right side 312 of the surface 304 during the monthly update at an end of a month associated with each of the month name elements. The rightmost one of the first row of month name elements 346 may be configured to move from the rightmost side of the first row 348 to the leftmost side of one of the first row 350, the second row 352, and the third row 358 during the monthly update at the end of the month associated with the rightmost one of the first row of month name elements 346.

The second row of month name elements 352 and the third row of month name elements 358 may operate similarly to the first row, with each of the elements of the rows configured to move individually and the rightmost elements configured to move to the leftmost side of one of the rows during the monthly update.

The immovable elements 364 may include an array 365 of day number elements 366, a fourth row of weekday name elements 372, a series of spaced apart day markers 374, and a series of spaced apart month markers 376. The array 365 of day number elements 366 may have day number element columns 368 and day number element rows 370, arranged similarly to the array 365 in the first perpetual calendar device 100.

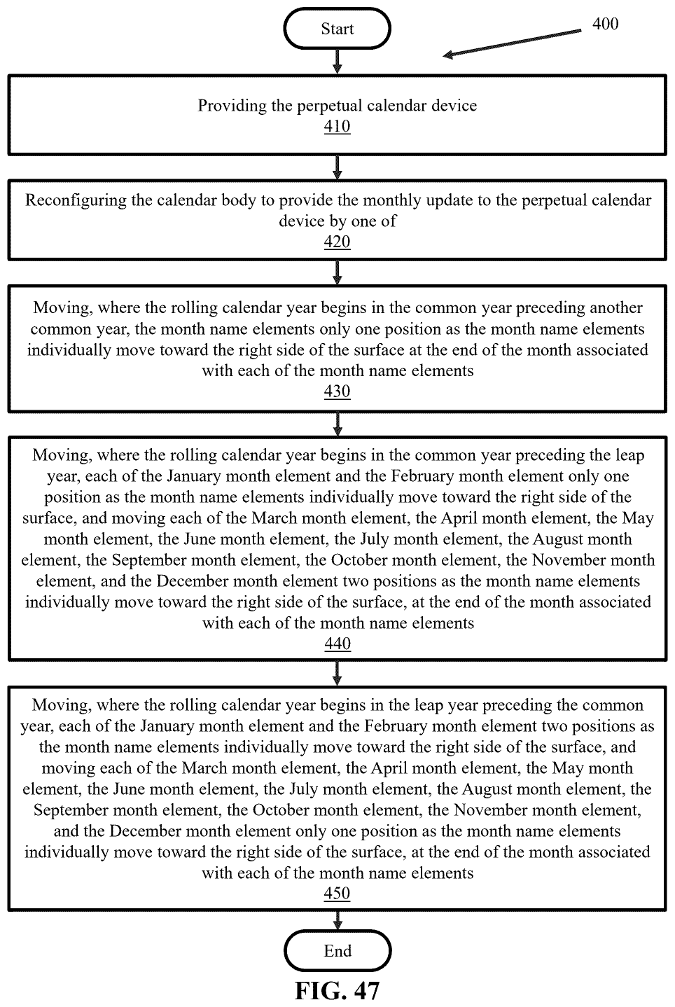

As shown in FIG. 47, a second method 400 of updating the second perpetual calendar device 300 for a rolling calendar year may have several steps. The first step 410 may involve providing the second perpetual calendar device 300. The next step 420 may involve reconfiguring the calendar body 302 to provide the monthly update to the second perpetual calendar device 300. The method may then proceed with one of three possible scenarios for reconfiguring the calendar body 302, depending on the transition between calendar years in the rolling calendar.

In the first scenario 430, where the rolling calendar year begins in the common year preceding another common year, the method may involve moving the month name elements only one position as they individually move toward the right side 312 of the surface 304 at the end of the month associated with each of the month name elements.

In the second scenario 440, where the rolling calendar year begins in the common year preceding the leap year, the method may involve moving each of the January month element 320 and the February month element 322 only one position, and moving each of the March month element 324 through the December month element 342 two positions as the month name elements individually move toward the right side 312 of the surface 304, at the end of the month associated with each of the month name elements.

The third scenario 450 may occur when the rolling calendar year begins in the leap year preceding the common year. In this case, the method may involve moving each of the January month element 320 and the February month element 322 two positions, and moving each of the March month element 324 through the December month element 342 only one position as the month name elements individually move toward the right side 312 of the surface 304, at the end of the month associated with each of the month name elements. The second perpetual calendar device 300 may thereby be rendered operable for the rolling calendar year effective for the next twelve (12) months. This step may be the culmination of the reconfiguration process, ensuring that the device is ready for use in the upcoming rolling calendar year.

Although described herein with respect to a forward update, one of ordinary skill in the art should appreciate that the steps of the second method 400 may also be performed in a reverse update in order to generate a past calendar operable under the Ruderman method of making the weekday determination, within the scope of the present disclosure.

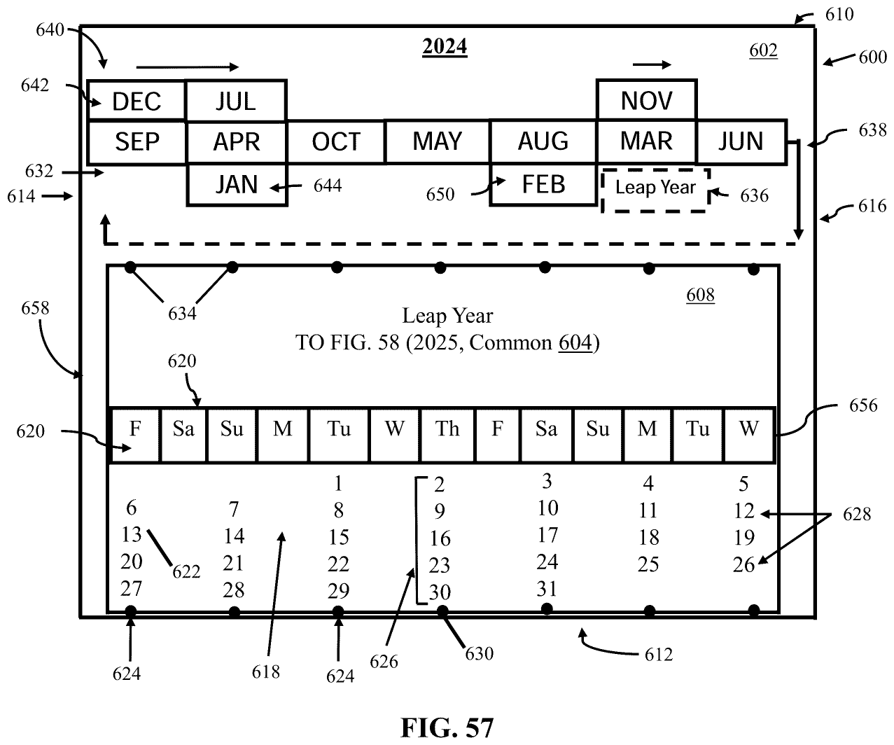

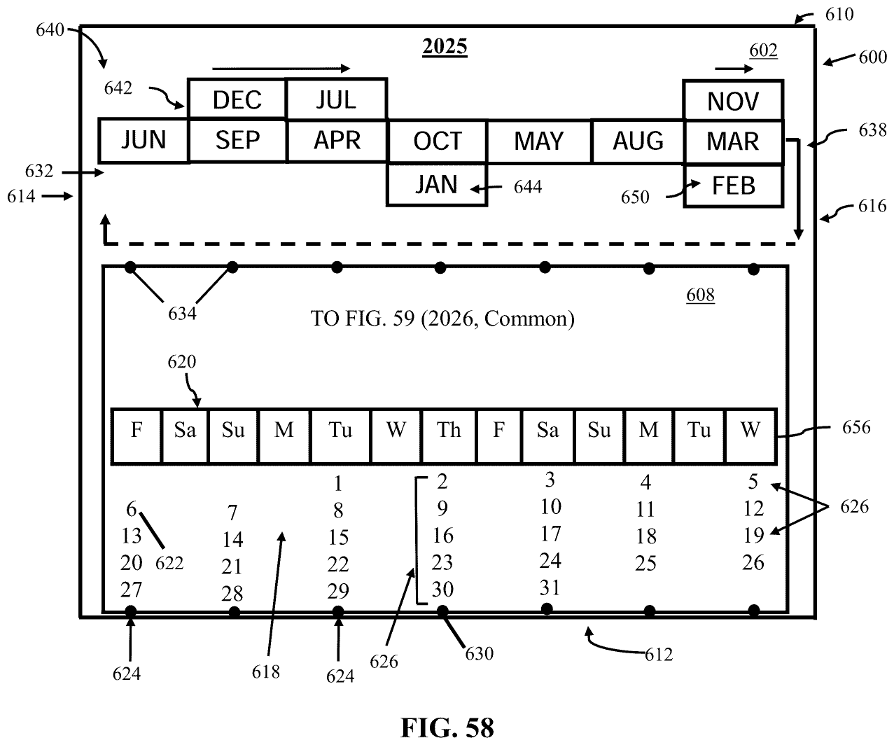

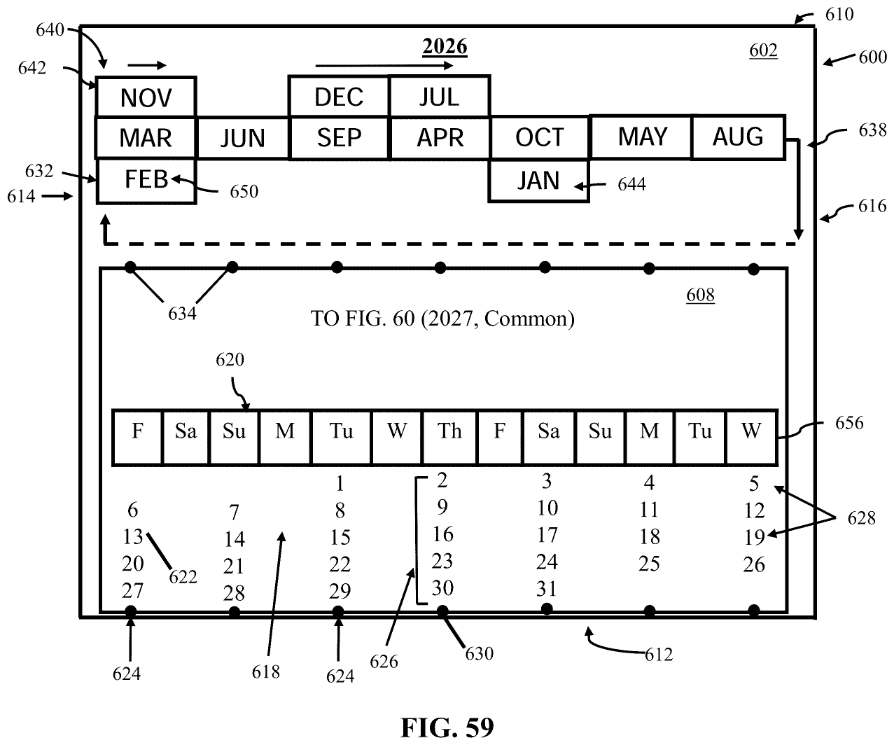

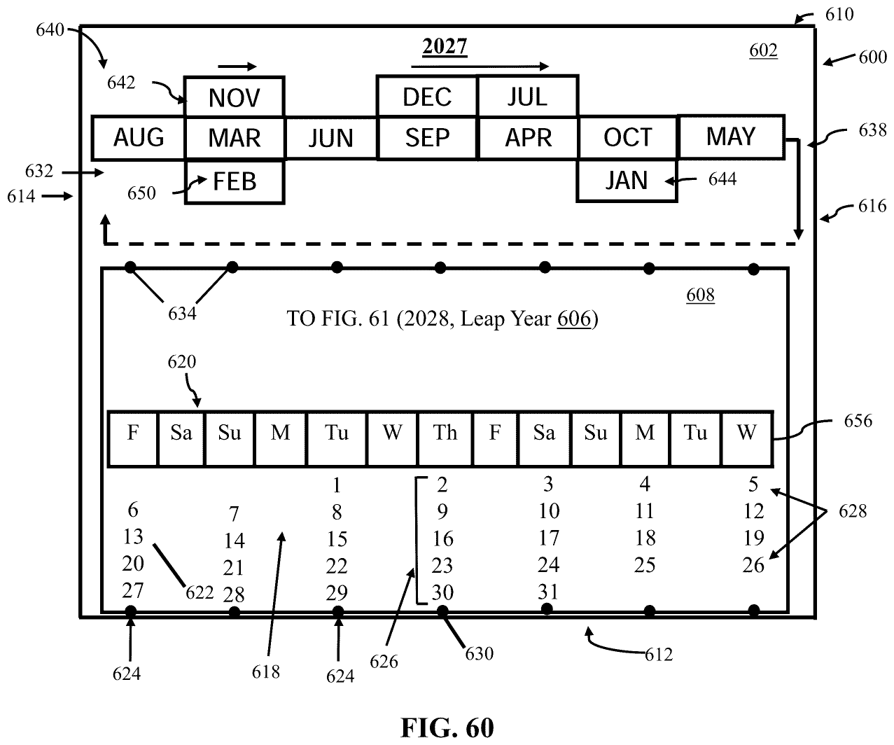

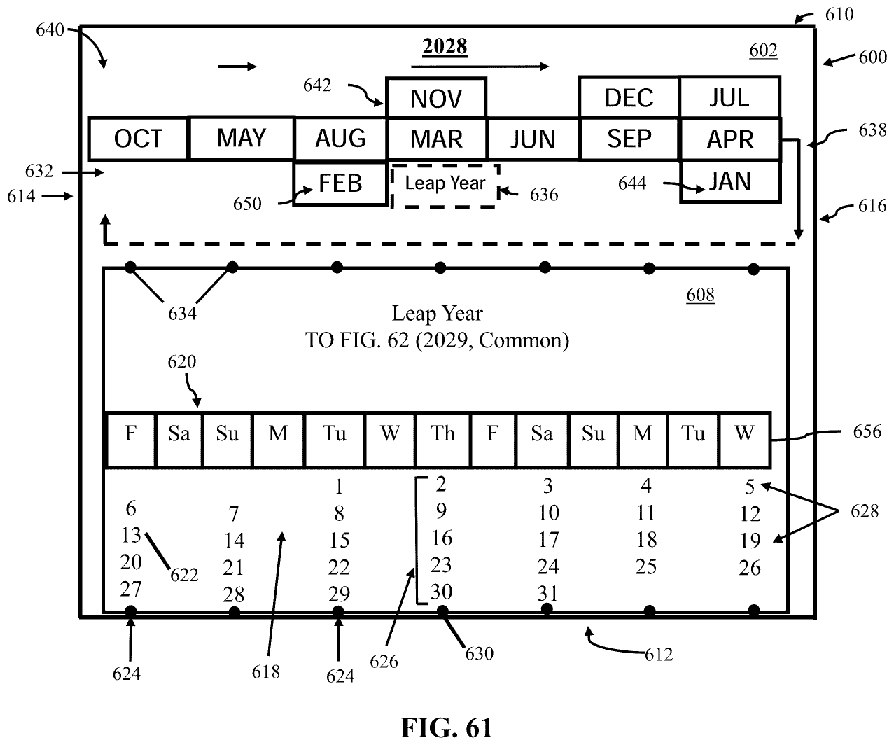

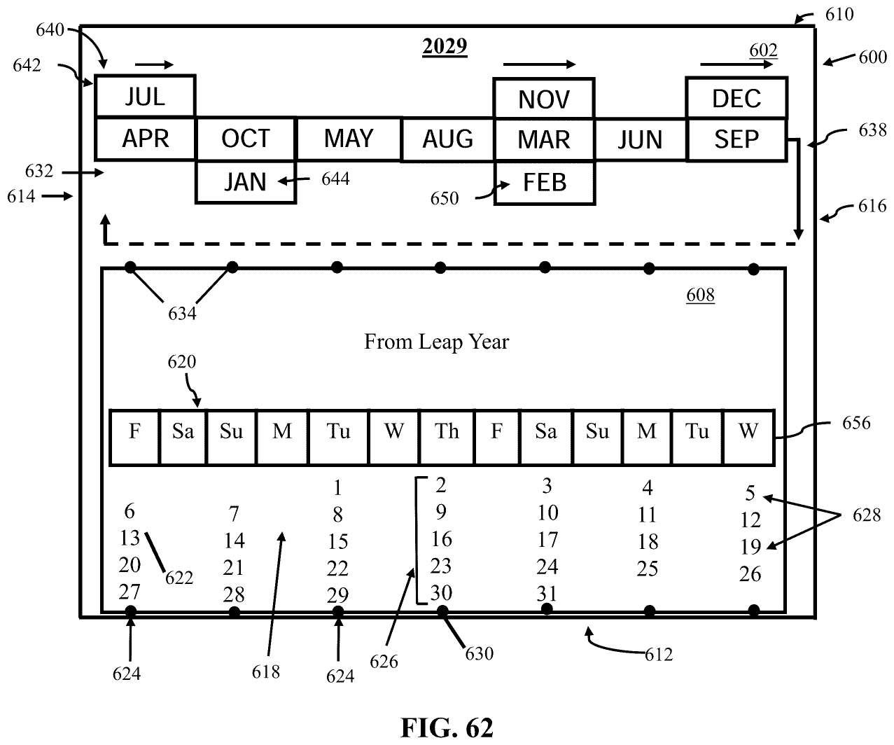

As shown in FIGS. 57-62, the present disclosure includes a third perpetual calendar device 600. The third perpetual calendar device 600 may be operable under a Ruderman method of making a weekday determination and may also permit an annual update between a former calendar year and a new calendar year. The device may have a calendar body 602 that may permit a user to make the weekday determination by selecting a day number and a month name. The calendar body 602 may permit the annual update by the user performing a reconfiguration of the calendar body 602. The calendar body 602 may also have a common year mode 604 (shown in FIG. 58) rendering the calendar body 602 usable for the weekday determination during a common year, and a leap year mode 606 (shown in FIG. 57) rendering the calendar body 602 usable for the weekday determination during a leap year. The calendar body 602 may also be configured for non-standard calendar years, such as the academic year or the fiscal year.

The calendar body 602 may have at least one surface 608 with a top side 610, a bottom side 612, a left side 614, and a right side 616. The at least one surface 608 may further have a base calendar layout 618 with immovable elements 620 and movable elements 640.

Each of the immovable elements 620 may be printed to the surface 608 of the calendar body 602. The immovable elements 620 may include an array 622 of day number elements 624, a series of spaced apart day markers 630, a series of spaced apart month markers 634, and a fourth row of weekday name elements 656. The array 622 of the day number elements 624 may have day number element columns 626 and day number element rows 628. For example, the array 622 may have seven day number element columns 626 and five day number element rows 628. The day number element columns 626 may be spaced apart evenly along a length of the calendar body 602 between the left side 614 and the right side 616 of the surface 608 and adjacent a bottom side 612 of the surface 608. The day number element rows 628 may be disposed evenly along a height of the calendar body 602 between the bottom side 612 and the right side 616 of the surface 608. The series of spaced apart day markers 630 may be disposed adjacent to the array 622 and each day marker of the C may be aligned with one of the day number element columns 626. The series of spaced apart month markers 634 may be disposed adjacent to the first row of month name elements 632 and each month marker of the series of spaced apart month markers 634 may be aligned with one of the month name elements. The fourth row of weekday name elements 656 may be disposed equidistant to the series of spaced apart month markers 634 and the series of spaced apart day markers 630.

The movable elements 640 may include a first row of month name elements 632, a second row of month name elements 638, a third row of month name elements 642, and a leap year element 636 (shown in FIG. 57). The first row of month name elements 632 may be disposed on the surface 608 between the array 622 and the top side 610 of the surface 608. The first row of month name elements 632 may include a first month element 644 and a second month element 650. The first month element 644 and second month element 650 may be configured to move toward the right side 616 of the surface 608 by one position when the calendar body 602 may be reconfigured from the common year mode 604 to common year mode 604 and reconfigured from the common year mode 604 to the leap year mode 606, and to move toward the right side 616 of the surface 608 by two positions when the calendar body 602 may be reconfigured from the leap year mode 606 to the common year mode 604.

The second row of month name elements 638 may be disposed on the surface 608 between the first row of month name elements 632 and the third row of month name elements 642. The third row of month name elements 642 may be disposed on the surface 608 between the second row of month name elements 632 and top side 610 of the third perpetual calendar device 600. The second row of month name elements 638 and third row of month name elements 642 may be configured to move toward the right side 616 of the surface 608 by one position when the calendar body 602 may be reconfigured from the common year mode 604 to common year mode 604 and reconfigured from the leap year mode 606 to the common year mode 604, and to move toward the right side 616 of the surface 608 by two positions when the calendar body 602 may be reconfigured from the common year mode 604 to the leap year mode 606.

The leap year element 636 may be disposed on the surface 608 between the first row of month name elements 632 and the top side 610 of the surface 608. The leap year element 636 may be exposed during the leap year to signify to the user that the calendar body 602 may be in the leap year mode 606.

The calendar body 602 may be operable by the user under the Ruderman method to make the weekday determination by selecting the day number, selecting the month name, and visualizing a line extending from one of the series of spaced apart month markers 634 aligned with the one of the month name elements associated with the month name that may be selected to one of the series of spaced apart day markers 630 aligned with one of the day number element columns 626 associated with the day number that may be selected, with the line intersecting one of the weekday name elements in the fourth row 656 to thereby reveal a weekday associated with the day number and the month name selected by the user. The calendar body 602 may be configured for a full calendar year, with the first month element 644 being a January month element and the second month element 650 being a February month element. Alternatively, the calendar body 602 may be configured for one of a full calendar year, an academic year, or a fiscal year.

The movable elements 640 may be either magnetically or mechanically movably secured to the surface 608 of the calendar body 602. The third perpetual calendar device 600 may include a slider that is slidably attached to the calendar body 602, with the first month element 644 and the second month element 650 attached to the slider so that they may be movable together. Each of the movable elements 640 may be a tile. The surface 608 of the calendar body 602 may include at least one of a rail or a channel that slidably receives the movable elements 640. It should be appreciated that the at least one surface 608 of the calendar body 602 may be substantially planar. Alternatively, the calendar body 602 may be three-dimensional and the surface 608 may be substantially non-planar. The surface 608 of the calendar body 602 may be substantially continuous, with each of the top side 610, the bottom side 612, the left side 614, and the right side 616 not being terminal. The calendar body 602 may also be three-dimensional, the surface 608 may be substantially non-planar, and the fourth row of weekday name elements 656 may be presented as a continuous band that circumscribes the calendar body 602.

The calendar body 602 may also be generated as a graphical user interface of a computerized display. For example, the calendar body 602 may be generated as a graphical user interface on a smartphone or desktop application, where a user may touch or click on a day number element 624 or a first row, second row, or third row month name elements 632, 638, 642, and the month and date may highlight on the graphical user interface. In another example, the smartphone or desktop application may, upon a user selecting a day number element 624 and a month name element 632, 638, 642, generate a line or highlight connecting the appropriate markers from the series of spaced apart day markers 630 and series of spaced apart month markers 634 that intersect the weekday name elements 656, highlighting the weekday name element 656 that the line intersects. In yet another example, the smartphone or desktop application may automatically update all elements upon each annual update.

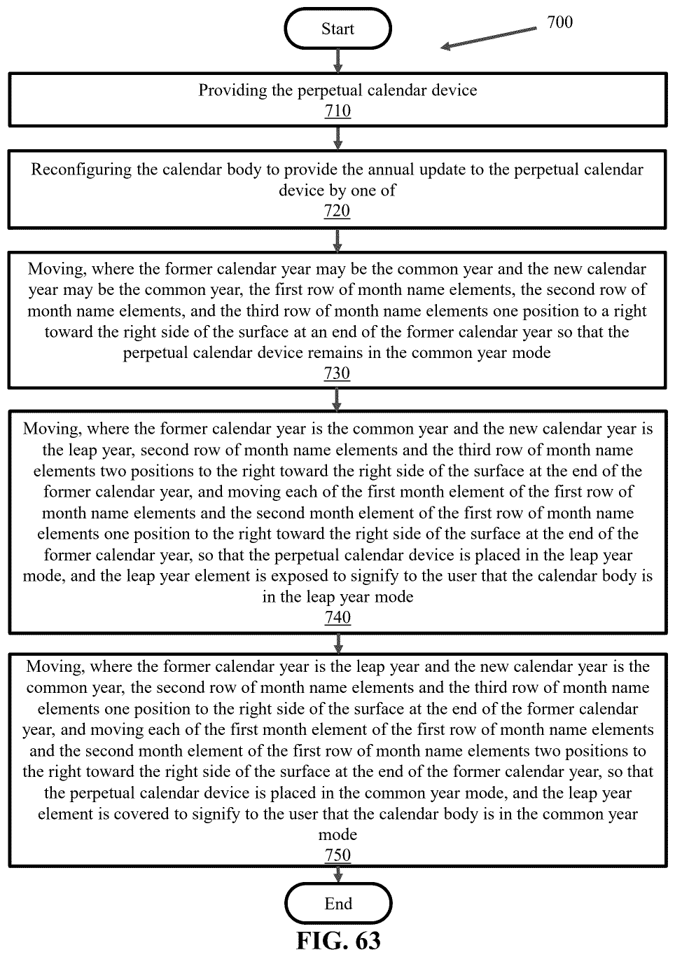

As shown in FIG. 63, a third method 700 of updating the third perpetual calendar device 600 from the former calendar year to the new calendar year may have several steps. The first step 710 may involve providing the third perpetual calendar device 600. The next step 720 may involve reconfiguring the calendar body 602 to provide the annual update to the third perpetual calendar device 600. The method may then proceed with one of three possible scenarios for reconfiguring the calendar body 602, depending on the transition between the former and new calendar years. One of ordinary skill in the art should appreciate that the steps of the third method 700 may also be performed in a reverse update in order to generate a past calendar operable under the Ruderman method of making the weekday determination.

In the first scenario 730, where the former calendar year is the common year and the new calendar year is also the common year, the third method 700 may involve moving the first row of month name elements 632, the second row of month name elements 638, and the third row of month name elements 642 one position to a right toward the right side 616 of the surface 608 at the end of the former calendar year.

In the second scenario 740, where the former calendar year is the common year and the new calendar year is the leap year, the third method 700 may involve moving the second row of month name elements 638 and the third row of month name elements 642 two positions to the right toward the right side 616 of the surface 608 at the end of the former calendar year, and moving each of the first month element 644 of the first row of month name elements 632 and the second month element 650 of the first row of month name elements 632 one position to the right toward the right side 616 of the surface 608 at the end of the former calendar year.

The third scenario 750 may occur when the former calendar year is a leap year and the new calendar year is a common year. In this case, the method may involve moving the second row of month name elements 638 and the third row of month name elements 642 one position to the right toward the right side 616 of the surface 608 at the end of the former calendar year, and moving each of the first month element 644 of the first row of month name elements 632 and the second month element 650 of the first row of month name elements 632 two positions to the right toward the right side 616 of the surface 608 at the end of the former calendar year. The third perpetual calendar device 600 is thereby rendered operable for the new calendar year. This step may be the culmination of the reconfiguration process, ensuring that the device is ready for use in the upcoming year.

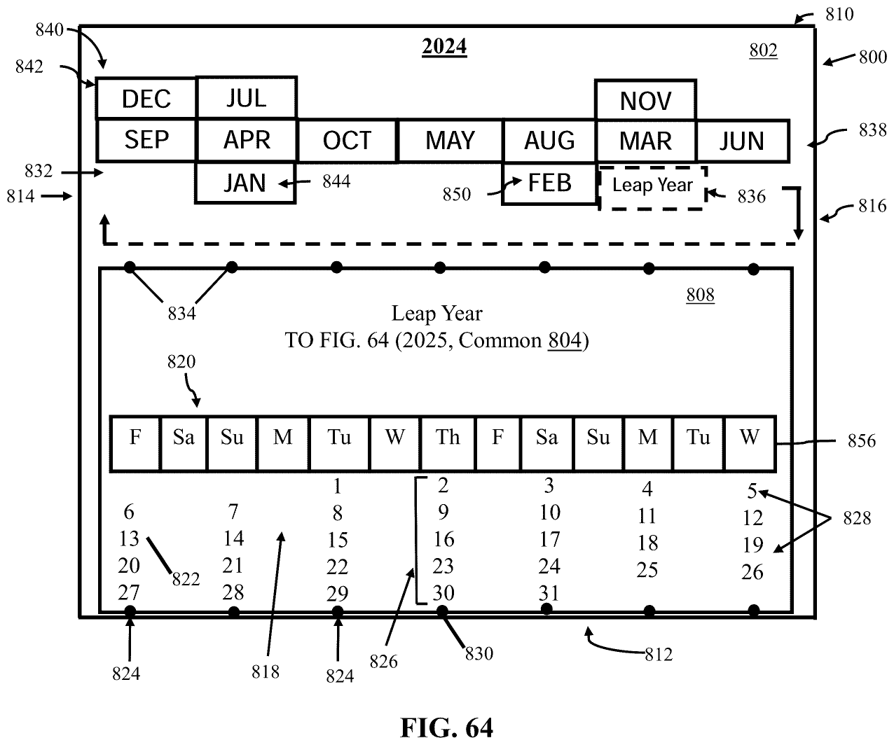

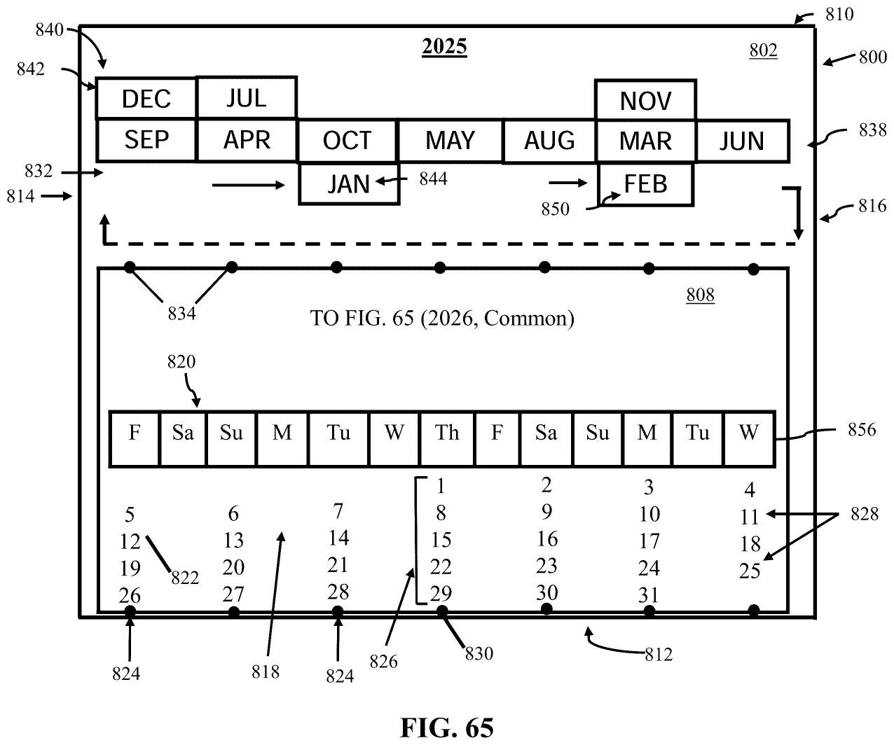

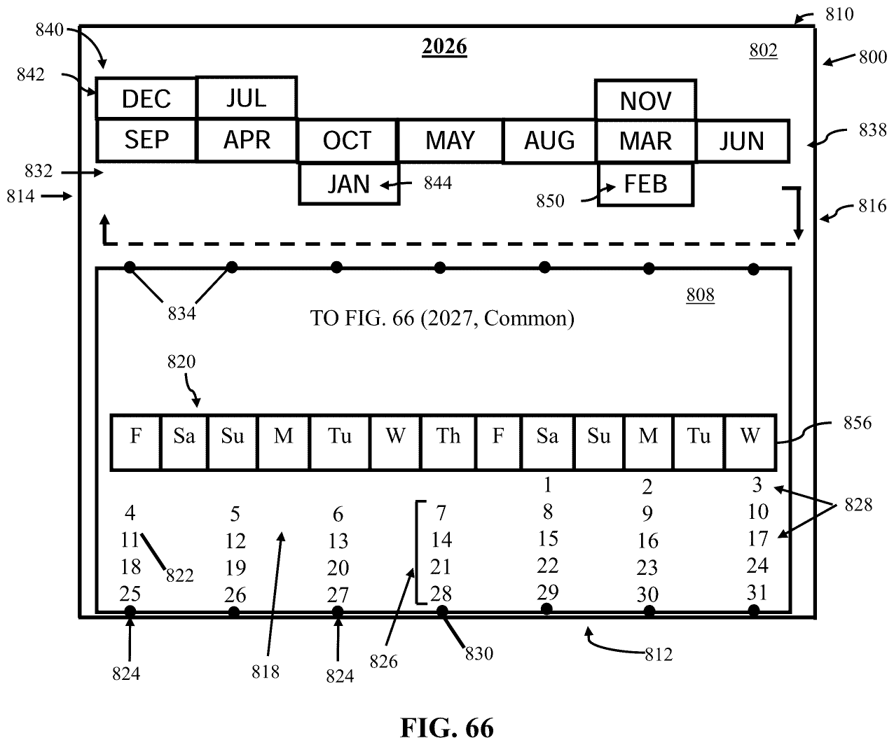

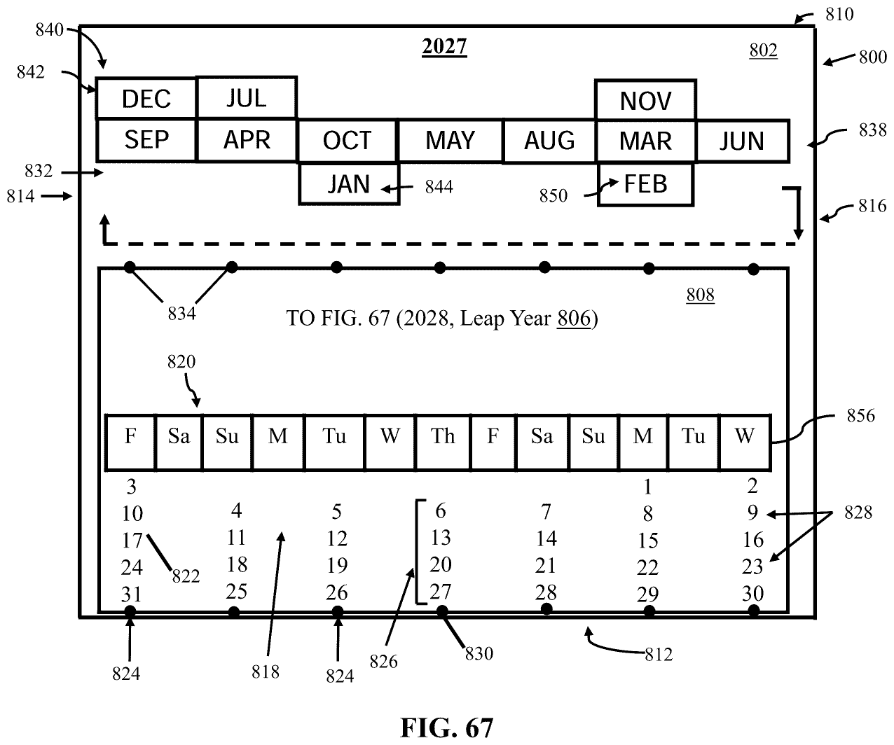

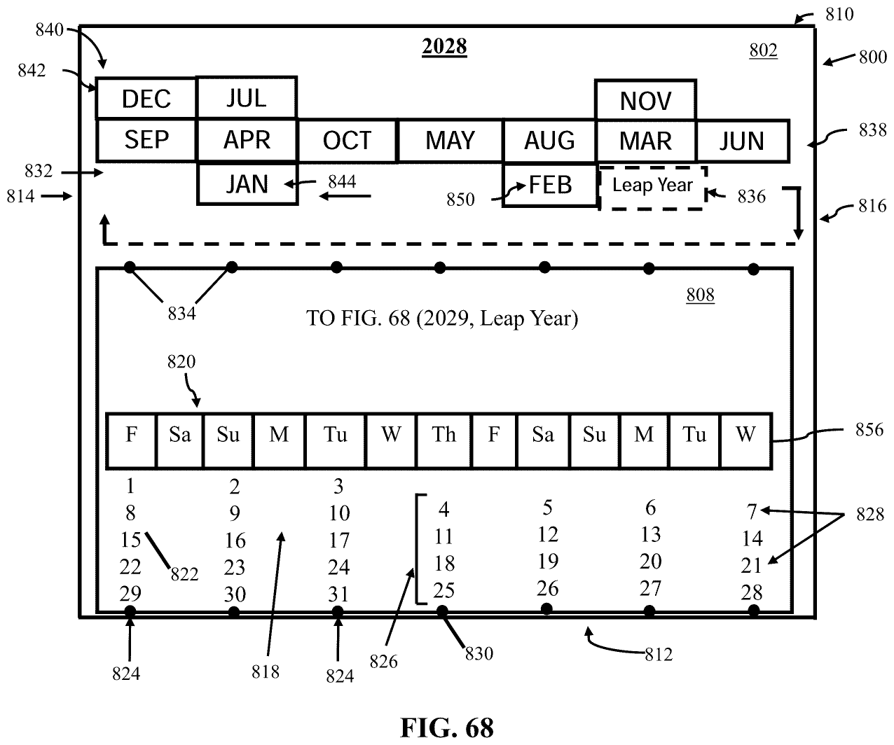

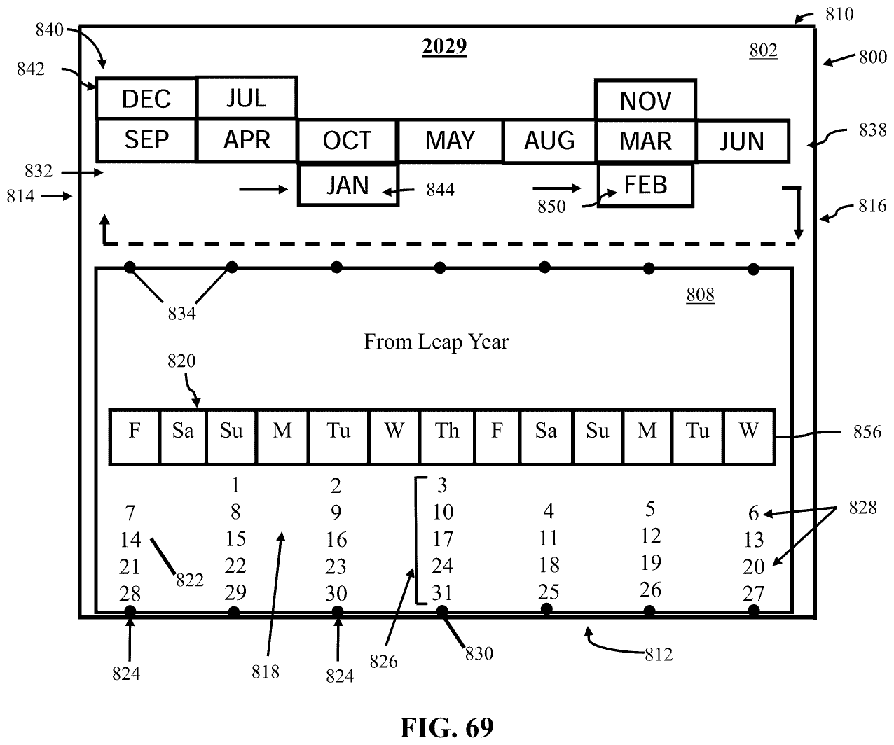

As shown in FIGS. 64-69, the present disclosure includes a fourth perpetual calendar device 800. The fourth perpetual calendar device 800 may be operable under a Ruderman method of making a weekday determination and may also permit an annual update between a former calendar year and a new calendar year. The device may have a calendar body 802 that may permit a user to make the weekday determination by selecting a day number and a month name. The calendar body 802 may permit the annual update by the user performing a reconfiguration of the calendar body 802. The calendar body 802 may also have a common year mode 804 (shown in FIG. 65) rendering the calendar body 802 usable for the weekday determination during a common year, and a leap year mode 806 (shown in FIG. 64) rendering the calendar body 802 usable for the weekday determination during a leap year. The calendar body 802 may also be configured for non-standard calendar years, such as the academic year or the fiscal year.

The calendar body 802 may have at least one surface 808 with a top side 810, a bottom side 812, a left side 814, and a right side 816. The at least one surface 808 may further have a base calendar layout 818 with immovable elements 820 and movable elements 840.

Each of the immovable elements 820 may be printed to the surface 808 of the calendar body 802. The immovable elements 820 may include a second row of month name elements 838, a third row of month name elements 842, a series of spaced apart day markers 830, a series of spaced apart month markers 834, and a fourth row of weekday name elements 856. The second row of month name elements 838 may be disposed on the surface 808 between the first row of month name elements 832 and the third row of month name elements 842. The third row of month name elements 842 may be disposed on the surface 808 between the second row of month name elements 832 and top side 810 of the fourth perpetual calendar device 800. The series of spaced apart day markers 830 may be disposed adjacent to the array 822 and each day marker of the C may be aligned with one of the day number element columns 826. The series of spaced apart month markers 834 may be disposed adjacent to the first row of month name elements 832 and each month marker of the series of spaced apart month markers 834 may be aligned with one of the month name elements. The fourth row of weekday name elements 856 may be disposed equidistant to the series of spaced apart month markers 834 and the series of spaced apart day markers 830.

The movable elements 840 may include an array 822 of day number elements 824, a first row of month name elements 832, and a leap year element 836 (shown in FIG. 64). The array 822 of the day number elements 824 may have day number element columns 826 and day number element rows 828. For example, the array 822 may have seven day number element columns 826 and five day number element rows 828. The day number element columns 826 may be spaced apart evenly along a length of the calendar body 802 between the left side 814 and the right side 816 of the surface 808 and adjacent a bottom side 812 of the surface 808. The day number element rows 828 may be disposed evenly along a height of the calendar body 802 between the bottom side 812 and the right side 816 of the surface 808. The day number element columns 826 may be configured to move toward the right side 816 of the surface 808 by one position when the calendar body 802 may be reconfigured from the common year mode 804 to common year mode 804 and reconfigured from the leap year mode 806 to the common year mode 804, and to move toward the right side 816 of the surface 808 by two positions when the calendar body 802 may be reconfigured from the common year mode 804 to the leap year mode 806.

The first row of month name elements 832 may be disposed on the surface 808 between the array 822 and the top side 810 of the surface 808. The first row of month name elements 832 may include a first month element 844 and a second month element 850. The first month element 844 and second month element 850 may be configured to move toward the right side 816 of the surface 808 by one position when the calendar body 802 may be reconfigured from the leap year mode 806 to the common year mode 804, and to move toward the left side 816 of the surface 808 by one position when the calendar body 802 may be reconfigured from the common year mode 804 to the leap year mode 806.

The leap year element 836 may be disposed on the surface 808 between the first row of month name elements 832 and the top side 810 of the surface 808. The leap year element 836 may be exposed during the leap year to signify to the user that the calendar body 802 may be in the leap year mode 806.

The calendar body 802 may be operable by the user under the Ruderman method to make the weekday determination by selecting the day number, selecting the month name, and visualizing a line extending from one of the series of spaced apart month markers 834 aligned with the one of the month name elements associated with the month name that may be selected to one of the series of spaced apart day markers 830 aligned with one of the day number element columns 826 associated with the day number that may be selected, with the line intersecting one of the weekday name elements in the fourth row 856 to thereby reveal a weekday associated with the day number and the month name selected by the user. The calendar body 802 may be configured for a full calendar year, with the first month element 844 being a January month element and the second month element 850 being a February month element. Alternatively, the calendar body 802 may be configured for one of a full calendar year, an academic year, or a fiscal year.

The movable elements 840 may be either magnetically or mechanically movably secured to the surface 808 of the calendar body 802. The fourth perpetual calendar device 800 may include a slider that is slidably attached to the calendar body 802, with the first month element 844 and the second month element 850 attached to the slider so that they may be movable together. Each of the movable elements 840 may be a tile. The surface 808 of the calendar body 802 may include at least one of a rail or a channel that slidably receives the movable elements 840. At least one surface 808 of the calendar body 802 may be substantially planar. Alternatively, the calendar body 802 may be three-dimensional and the surface 808 may be substantially non-planar. The surface 808 of the calendar body 802 may be substantially continuous, with each of the top side 810, the bottom side 812, the left side 814, and the right side 816 not being terminal. For example, the surface 808 of the calendar body 802 may be spherical with no surface 808 edges. The calendar body 802 may also be three-dimensional, the surface 808 may be substantially non-planar, and the fourth row of weekday name elements 856 may be presented as a continuous band that circumscribes the calendar body 802.

The calendar body 802 may also be generated as a graphical user interface of a computerized display. For example, the calendar body 802 may be generated as a graphical user interface on a smartphone or desktop application, where a user may touch or click on a day number element 824 or a first row, second row, or third row month name elements 832, 838, 842, and the month and date may highlight on the graphical user interface. In another example, the smartphone or desktop application may, upon a user selecting a day number element 824 and a month name element 832, 838, 842, generate a line or highlight connecting the appropriate markers from the series of spaced apart day markers 830 and series of spaced apart month markers 834 that intersect the weekday name elements 856, highlighting the weekday name element 856 that the line intersects. In yet another example, the smartphone or desktop application may automatically update all elements upon each annual update.

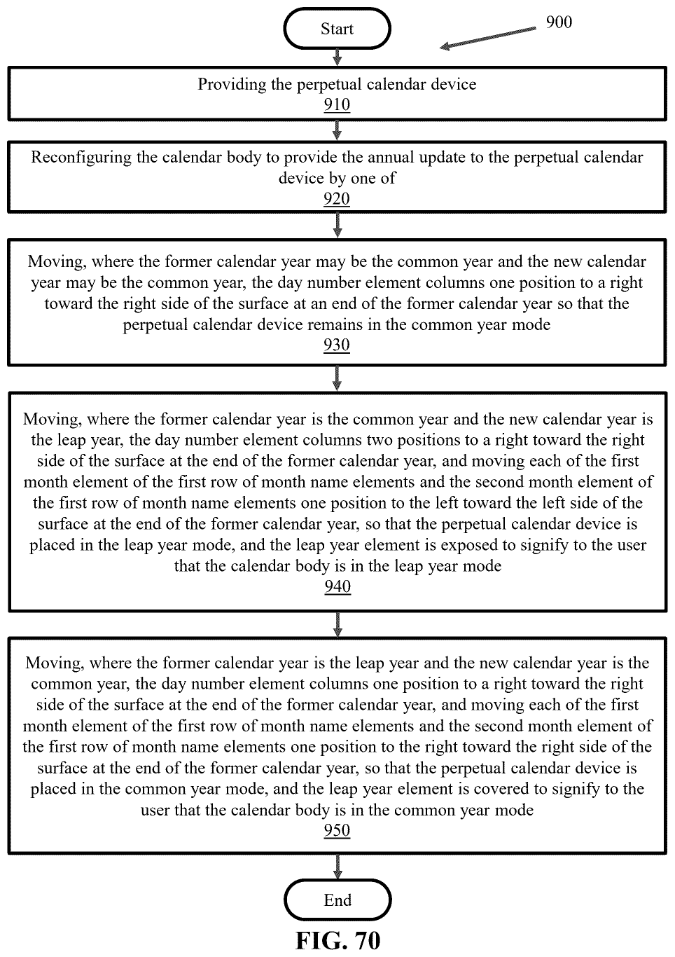

As shown in FIG. 70, a fourth method 900 of updating the fourth perpetual calendar device 800 from the former calendar year to the new calendar year may have several steps. The first step 910 may involve providing the fourth perpetual calendar device 800. The next step 920 may involve reconfiguring the calendar body 802 to provide the annual update to the fourth perpetual calendar device 800. The method may then proceed with one of three possible scenarios for reconfiguring the calendar body 802, depending on the transition between the former and new calendar years. One of ordinary skill in the art should appreciate that the steps of the fourth method 900 may also be performed in a reverse update in order to generate a past calendar operable under the Ruderman method of making the weekday determination.

In the first scenario 930, where the former calendar year is the common year and the new calendar year is also the common year, the fourth method 900 may involve moving the day number element columns 826 one position to a right toward the right side 816 of the surface 808 at the end of the former calendar year.

In the second scenario 940, where the former calendar year is the common year and the new calendar year is the leap year, the fourth method 900 may involve moving the day number element columns 826 two positions to the right toward the right side 816 of the surface 808 at the end of the former calendar year, and moving each of the first month element 844 of the first row of month name elements 832 and the second month element 850 of the first row of month name elements 832 one position to the left toward the left side 816 of the surface 808 at the end of the former calendar year.

The third scenario 950 may occur when the former calendar year is a leap year and the new calendar year is a common year. In this case, the method may involve moving the day number element columns 826 one position to the right toward the right side 816 of the surface 808 at the end of the former calendar year, and moving each of the first month element 844 of the first row of month name elements 832 and the second month element 850 of the first row of month name elements 832 one position to the right toward the right side 816 of the surface 808 at the end of the former calendar year. The fourth perpetual calendar device 800 is thereby rendered operable for the new calendar year. This step may be the culmination of the reconfiguration process, ensuring that the device is ready for use in the upcoming year.

Advantageously, the present disclosure provides an elegant solution to the limitations of conventional Ruderman Calendars by introducing a reconfigurable perpetual calendar device that eliminates the need for annual replacements while maintaining the space-saving benefits of the original design. These innovative Calendar devices 100, 300, 600, 900 of the present disclosure incorporates movable elements, such as adjustable weekday tiles and month labels, allowing for easy updates to accommodate both common years and leap years without requiring the production of entirely new calendars each year. The ability to transition between common year and leap year modes through simple reconfigurations addresses the challenge of leap year accommodation that plagued traditional Ruderman Calendars.

Furthermore, it should be appreciated that the flexibility of the present disclosure in adapting to various calendar formats, including academic and fiscal calendars, expands its utility across different professional and institutional settings, overcoming the inflexibility of conventional designs. By combining the intuitive weekday determination method of the Ruderman Calendar with these advancements, the present technology offers a more efficient, adaptable, and user-friendly approach to calendar systems, effectively addressing the continuing need for an improved calendar system that builds upon the space-saving advantages of the Ruderman Calendar while resolving its limitations.

### EXAMPLES

Example embodiments of the present technology are provided with reference to the several figures enclosed herewith.

### Example 1: Annual Update Calendar

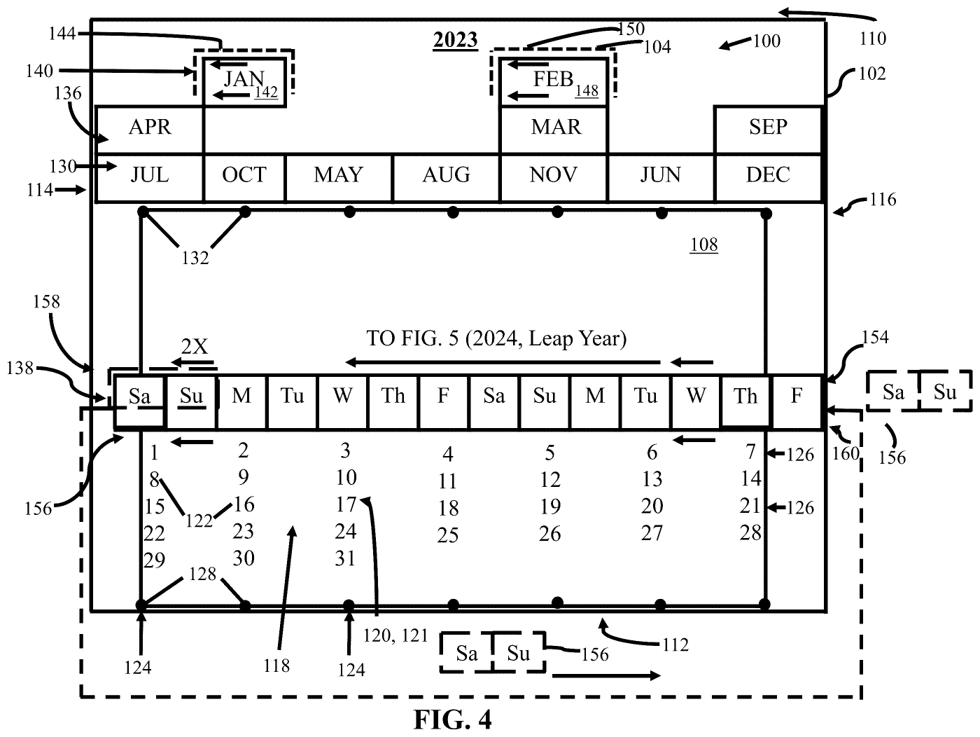

This example demonstrates the annual update process for a perpetual calendar device (shown in FIGS. 2-7) configured for a full calendar year. The calendar body is set up with the common year mode for the year 2023 (FIG. 4). It displays the array of day number elements from 1 to 31 arranged in 7 columns and 5 rows. The first row of month name elements shows the month markers aligned with their respective day markers. The fourth row of weekday name elements is positioned between the rows of markers at the bottom, with Saturday as the leftmost element.

At the end of 2023, the user performs the annual update to prepare the calendar for 2024, which is a leap year. Following the reconfiguration process, the user moves the fourth row of weekday name elements two positions to the left. Then, the user slides the first month element (January) and the second month element (February) one position to the left, exposing the leap year element. This action places the calendar body in the leap year mode for 2024 (FIG. 5).

After the reconfiguration, the calendar is ready for use in 2024. The user can now make weekday determinations for any date in 2024 using the Ruderman method, visualizing a line from the appropriate month marker to the day marker corresponding to the chosen date.

### Example 2: Non-traditional Calendar Layouts

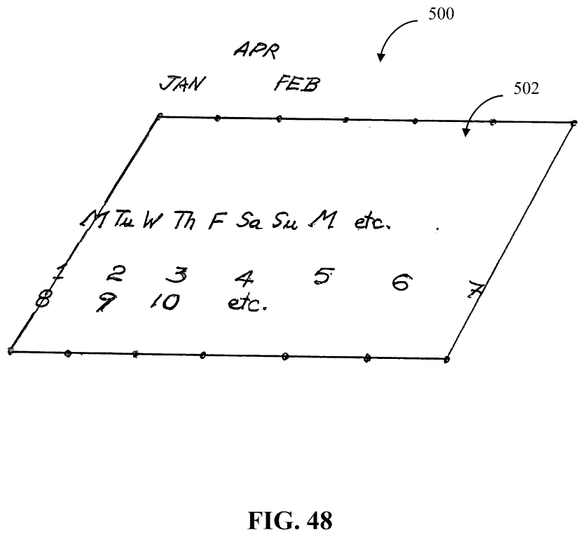

This example demonstrates various non-traditional layouts 500 and configurations for the perpetual calendar device, showcasing its flexibility and adaptability to different design preferences and use cases. In one variation, shown in FIG. 48, the calendar body can have a surface that is not merely planar or provided as a matrix or table. Instead, the calendar body can be designed with a “deformation” 502 of the otherwise planar matrix or table that would be associated with an entirely flat version. This allows for more creative and potentially ergonomic designs that still maintain the functionality of the Ruderman method.

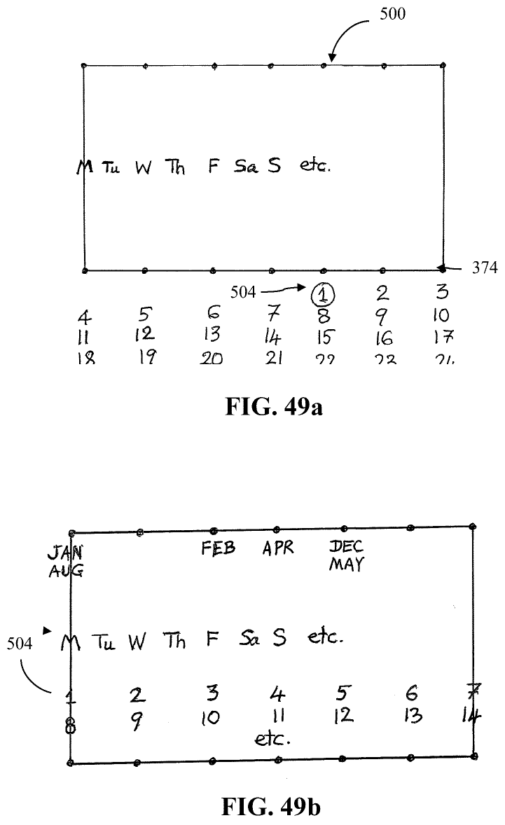

Another variation, shown in FIG. 49a, allows for flexibility in the starting point of the array of day number elements. The array can include a starting point of number “1” 504. The number “1” can start on any of the seven day markers, providing users with the ability to customize the calendar layout according to their preferences.

As also shown in FIG. 49b, the positioning of various elements can also be adjusted for different visual layouts. The day number elements can be provided inside or outside of the area bordered by the series of spaced apart day markers and the series of spaced apart month markers. Similarly, the rows of month name elements can be placed inside or outside of this bordered area. This flexibility allows for diverse design options that may better suit specific user needs or aesthetic preferences.

### Example 3: Alternative Arrangements and Orientations

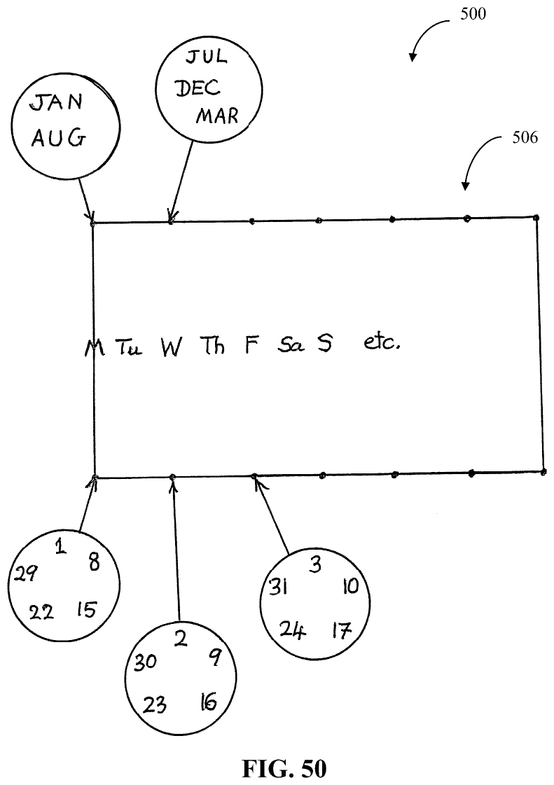

This example explores alternative arrangements and orientations for the calendar elements, further demonstrating the versatility of the perpetual calendar device. As shown in FIG. 50, the arrays in this version of the calendar do not have to be provided as a matrix or grid. Instead, they can be any predetermined ordered series or arrangement that is configured to operate in accordance with the principles of the Ruderman Method. This allows for a non-tabular association 506 of dates and/or months to the markers provided, opening up possibilities for more creative or intuitive layouts.

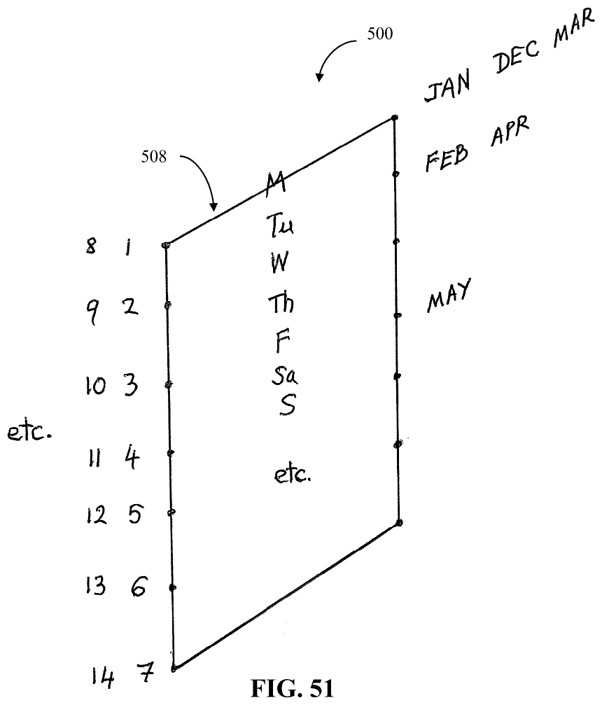

As shown in FIG. 51, the orientation 508 of the area bordered by the series of spaced apart day markers and the series of spaced apart month markers can be arbitrary or user-selected. This area can also be deformed, allowing for curved or non-rectangular calendar layouts that may better fit certain design aesthetics or functional requirements.

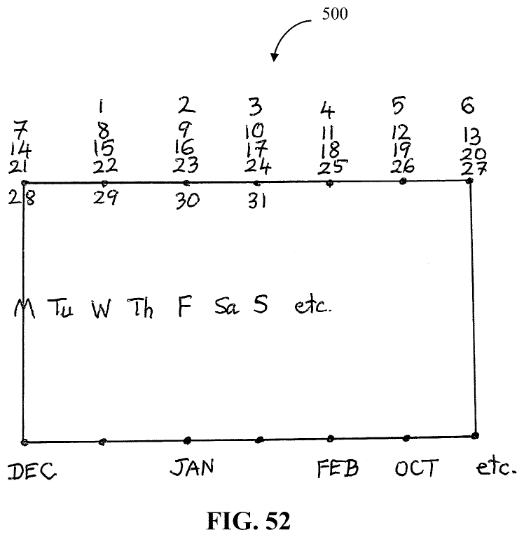

The positioning of the day number elements and the month name elements can be on either side of the area bordered by the series of spaced apart day markers and the series of spaced apart month markers, for example, as shown in FIG. 52. This means that the day number elements do not necessarily have to be on the bottom of the calendar as shown in the previous examples, allowing for alternative layouts that may be more intuitive or visually appealing to certain users.

### Example 4: Portable and Foldable Designs

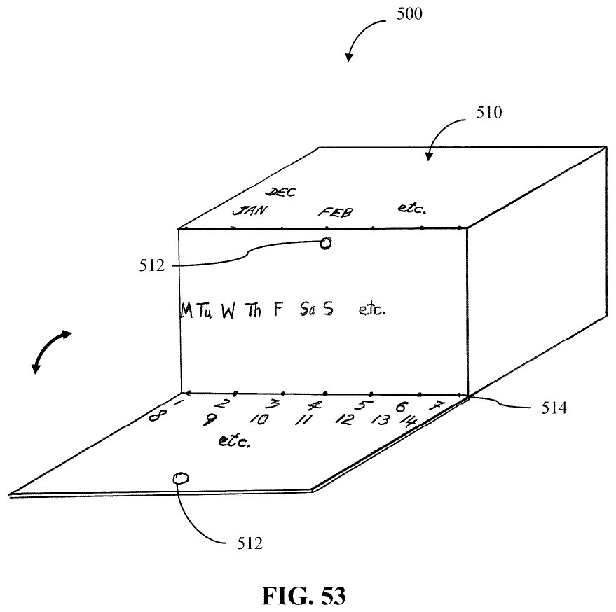

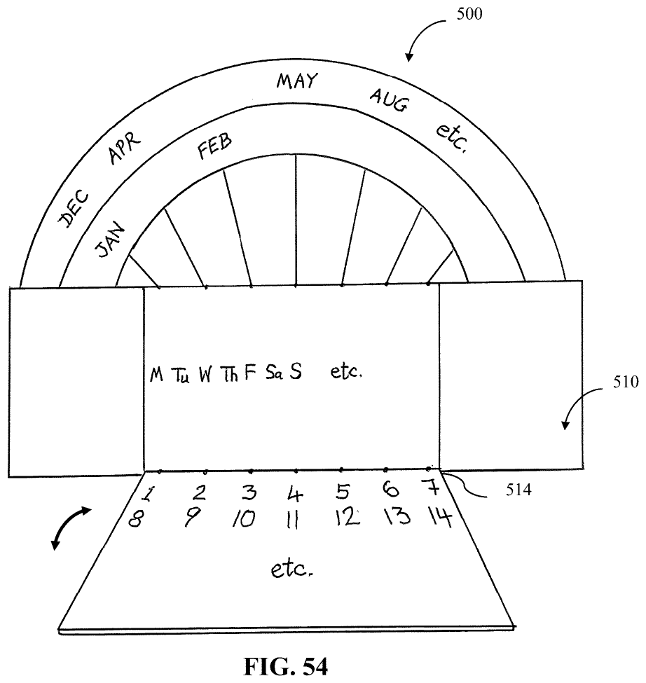

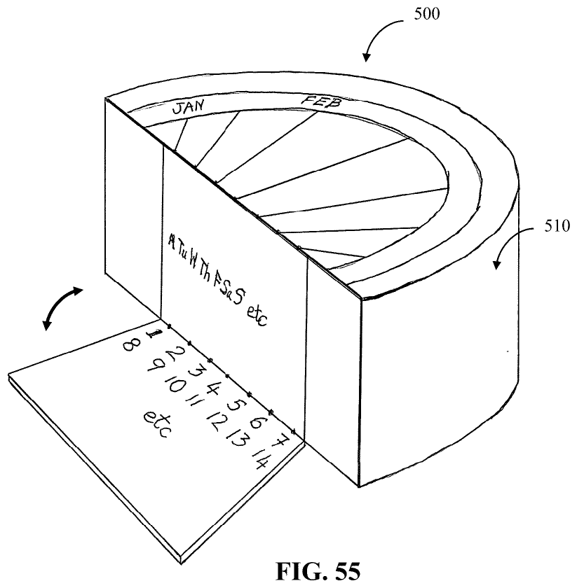

This example introduces design features that enhance the portability and compactness of the perpetual calendar device. One variation, shown in FIGS. 53-55, can include three-dimensional portions 510, and can include a panel 516 having the day number elements that can be hinged 514 to a main body that has the weekday name elements. This panel can be folded up and selectively held in place with a fastener 512, allowing the calendar to be easily transported or stored in a compact form when not in use.

The fastener used to hold the folded panel in place may be mechanical or magnetic. In the case of a magnetic fastener, it may be normally hidden and then click to the magnet when the panel is folded up. This design provides a sleek appearance when the calendar is open and ensures secure closure when folded.

These portable and foldable designs make the perpetual calendar device more versatile for users who need to carry it with them or who have limited space for displaying a full-sized calendar. The ability to fold and unfold the calendar also adds an interactive element to the device, potentially making it more engaging for users.

### Example 5: Improved Weekday Determination

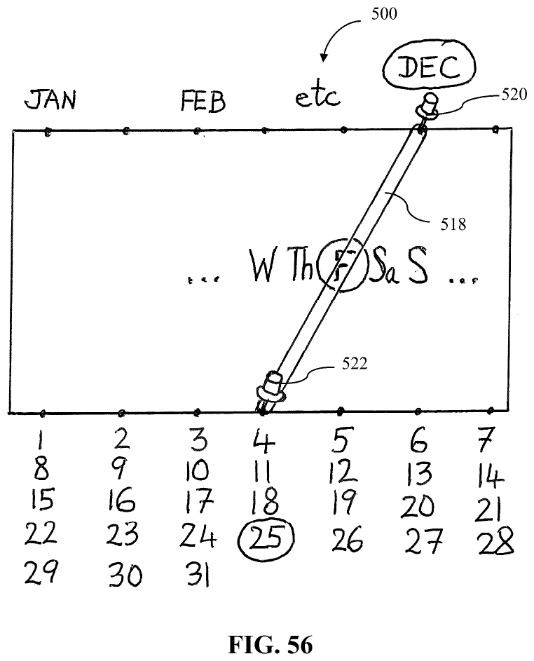

This example demonstrates an enhancement to the weekday determination process of the perpetual calendar device, as shown in FIG. 56, by incorporating physical elements to aid in visualizing the line between month and day markers. The calendar body is set up with the standard configuration, including the array of day number elements, rows of month name elements, and the fourth row of weekday name elements. In addition to these elements, the calendar includes two removable and re-insertable elements, such as thumb tacks, labeled M (for month) 520 and D (for day) 522.

To make a weekday determination, the user first selects the desired month and day. They then insert the M thumb tack at the appropriate month marker and the D thumb tack at the corresponding day marker in the array of day number elements. A third element, such as a rubber band 518, is then stretched between the two thumb tacks.

The rubber band creates a visible line connecting the month and day markers, making it easier for the user to read off the weekday where the line intersects the fourth row of weekday name elements. For example, using this method, a user can quickly determine that December 25th falls on a Friday.

This physical enhancement to the weekday determination process provides a tactile and visual aid that can improve the user experience, especially for those who may find it challenging to visualize the imaginary line in the standard Ruderman method. The removable nature of the thumb tacks and rubber band allows for easy resetting of the calendar for subsequent date determinations while maintaining the overall flexibility and updateability of the perpetual calendar device.

### Example 6: Three-Dimensional Calendar Body

This example demonstrates a variation of the perpetual calendar device, as also shown in FIGS. 53-55, where the calendar body is designed as a three-dimensional object rather than a flat board or panel. In this configuration, the array of day number elements is placed on a first surface of the calendar body, arranged on a first plane. This surface may correspond to the front face of the three-dimensional body, providing a familiar layout for the user to reference when selecting a day number.

The fourth row of weekday name elements is positioned on a second surface of the three-dimensional body, oriented on a second plane that is transverse to the first surface. This arrangement could be implemented, for example, by placing the weekday names along the top edge or a side edge of the calendar body, creating a visually distinct separation between the day numbers and the weekday names.

The rows of month name elements are then placed on a third surface of the three-dimensional body, oriented on a third plane that is transverse to the second surface. This could be achieved by positioning the month names on another edge or face of the calendar body, further enhancing the visual organization of the calendar information.

It may be important to note that in this three-dimensional configuration, the array of day number elements may not necessarily be arranged in a traditional grid or matrix format.

Instead, it could be presented as a non-grid or non-matrix array that still maintains the logical relationship between the numbers and their corresponding weekdays.

Similarly, the row of weekday name elements and the row of month name elements may be provided as an ordered series or arrangement that is not necessarily linear or disposed on the same plane. This flexibility in design allows for creative and potentially more intuitive layouts that take advantage of the three-dimensional nature of the calendar body.

This three-dimensional approach to the perpetual calendar device offers several potential advantages. It may provide improved visibility and accessibility of calendar information from different angles, make the device more visually interesting or aesthetically pleasing, and potentially offer new ways of interacting with the calendar that are not possible with a flat design. The three-dimensional structure could also incorporate additional features or storage options that enhance the overall functionality of the device.

### Example 7: Flexible Leap Year Insertion

This example demonstrates the versatility of the perpetual calendar device in accommodating different leap year insertion patterns, specifically a system that inserts 8 leap years in every 31-year cycle. The calendar body is initially set up for the first year of the 31-year cycle. The array of day number elements, the rows of month name elements, and the fourth row of weekday name elements are positioned according to the standard configuration. However, the leap year element is designed to be exposed more frequently than in the traditional Gregorian calendar system.

At the end of each year, the user performs the annual update process. For most years, this involves moving the fourth row of weekday name elements one position to the left. However, for the 8 designated leap years within the 31-year cycle, the user moves the fourth row of weekday name elements two positions to the left and slides the first month element (January) and the second month element (February) one position to the left, exposing the leap year element.

This flexible leap year insertion pattern allows the calendar to maintain a high degree of accuracy, with an error of only about 1 second per year. As a result, the calendar can track the position of the Earth in its orbit around the sun with an accuracy of approximately ±30 km, which is remarkably precise for a low-tech device. This example showcases the adaptability of the perpetual calendar device to various calendar systems and leap year patterns, making it suitable for specialized applications.

### Example 8: Alternate Uses

It should also be appreciated that the devices and methods of the present disclosure can have alternate uses. For example, in the original Ruderman's, one will specify a month and a day, e.g. December 25, and the calendar tells the user what day of the week it is. As an alternate use, one can consider a set of months, a set of day numbers, and a set of days of the week, such that one can specify any two sets and the calendar gives the remaining set. This reduces to the usual Ruderman operation when the set of month consists of only one month (e.g. December) and the set of days consists of only one number (e.g. 25), in which case the Ruderman calendar gives the remaining set, consisting of only one particular day of the week.

By understanding these set operations, one can answer many more questions. For example, the set of days be {13}, and the set of days of the week be {Friday}, the calendar will tell one how many “Friday the 13^{th}” there are, and the set of months in which it occurs. For another example, people who are paid weekly on Fridays might want to know in what months, if any, they are paid 5 times. There are only 3 day markers with 5 days each, namely {1,8,15,22,29}-marker, {2,9.16,23,30}-marker, and {3,10,17,24,31}-marker. These, along with the set {Friday} for weekday name will yield the set {Feb, Mar, Jun, Sep, Dec} as the 5 months that have 5 Fridays (for the particular year).

Other alternate uses of the devices and methods described hereinabove are also contemplated and considered within the scope of the present disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, and methods can be made within the scope of the present technology, with substantially similar results.

What is claimed is:

1. A perpetual calendar device operable under a Ruderman method of making a weekday determination and also permitting for an annual update between a former calendar year and a new calendar year, the perpetual calendar device comprising:
a calendar body permitting a user to make the weekday determination by selecting a day number and a month name, the calendar body permitting for the annual update by the user performing a reconfiguration of the calendar body, and the calendar body also having a common year mode rendering the calendar body usable for the weekday determination during a common year, and a leap year mode rendering the calendar body usable for the weekday determination during a leap year,
the calendar body having at least one surface with a top side, a bottom side, a left side, and a right side, the at least one surface further having a base calendar layout with immovable elements and movable elements,
the immovable elements including an array of day number elements, a series of spaced apart day markers, a series of spaced apart month markers, and a fourth row of weekday name elements,
the array having day number element columns and day number element rows, the day number element columns spaced apart evenly along a length of the calendar body between the left side and the right side of the at least one surface and adjacent a bottom side of the at least one surface, the day number element rows disposed evenly along a height of the calendar body between the bottom side and the right side of the at least one surface, the series of spaced apart day markers disposed adjacent the array and each day marker of the series of spaced apart day markers aligned with one of the day number element columns, and
the fourth row of weekday name elements disposed on the at least one surface between the array and the top side of the at least one surface, and the series of spaced apart month markers disposed adjacent the first row of month name elements and each month marker of the series of spaced apart month markers aligned with one of the month name elements,
the movable elements including a first row of month name elements, a second row of month name elements, a third row of month name elements, and a leap year element,
the first row of month name elements disposed on the at least one surface between the array and the top side of the at least one surface, the first row of month name elements including a first month element and a second month element, the first month element and second month element of the first row of month name elements configured to:
individually move toward the right side of the at least one surface by one position, and a rightmost one of the first row of month name elements configured to move from a rightmost side of the first row to a leftmost side of one of the first row when the calendar body is reconfigured to the common year mode and during a yearly update when the calendar body is reconfigured from the common year mode to the common year mode, and reconfigured from the common year mode to the leap year mode, and
individually move toward the right side of the at least one surface by two positions, and the rightmost one of the first row of month name elements configured to move from the rightmost side of the first row to the leftmost side of one of the first row when the calendar body is reconfigured from the leap year mode to the common year mode,
the second row of month name elements disposed on the at least one surface between the array and the top side of the at least one surface, and the series of spaced apart month markers disposed adjacent the first row of month name elements and each month marker of the series of spaced apart month markers aligned with one of the month name elements, the second row of month name elements configured to:
individually move toward the right side of the at least one surface by one position, and a rightmost one of the second row of month name elements configured to move from a rightmost side of the second row to a leftmost side of one of the second row when the calendar body is reconfigured to the common year mode and during a yearly update when the calendar body is reconfigured from the common year mode to the common year mode, and reconfigured from the leap year mode to the common year mode, and
individually move toward the right side of the at least one surface by two positions, and the rightmost one of the second row of month name elements configured to move from the rightmost side of the second row to the leftmost side of one of the second row when the calendar body is reconfigured from the common year mode to the leap year mode,
the third row of month name elements disposed on the at least one surface between the array and the top side of the at least one surface, third row of month name elements including a first month element, a second month element, and a third month element, the first month element, the second month element, and third month element of the third row configured to:
individually move toward the right side of the at least one surface by one position, and a rightmost one of the third row of month name elements configured to move from a rightmost side of the third row to a leftmost side of one of the third row when the calendar body is reconfigured to the common year mode and during a yearly update when the calendar body is reconfigured from the common year mode to the common year mode, and reconfigured from the leap year mode to the common year mode,
individually move toward the right side of the at least one surface by two positions, and the rightmost one of the second row of month name elements configured to move from the rightmost side of the third row to the leftmost side of one of the third row when the calendar body is reconfigured from the common year mode to the leap year mode, and
the leap year element disposed on the at least one surface between the third row of month name elements and the top side of the at least one surface, the leap year element exposed during the leap year to signify to the user that the calendar body is in the leap year mode, the leap year element configured to display, optionally, on the right side of the second month element of the first row,
whereby the calendar body is operable by the user under the Ruderman method to make the month determination by selecting the day number, selecting the month name, and visualizing or actually effecting a line extending from one of the series of spaced apart month markers aligned with the one of the month name elements associated with the month name that is selected to one of the series of spaced apart day markers aligned with one of the day number element columns associated with the day number that is selected, with the line intersecting one of the weekday name elements in the fourth row to thereby reveal a weekday associated with the day number and the month name selected by the user.

2. The perpetual calendar device of claim 1, wherein the first month element of the first row of month name elements is a January month element, the second month element of the first row of month name elements is a February month element, the array includes seven of the day number element columns and five of the day number element rows, and the calendar body is configured for a calendar year, the calendar year including a member selected from the group consisting of a full calendar year, an academic year, and a fiscal year with an arbitrary start date and end date 365 days later.

3. The perpetual calendar device of claim 1, wherein each of the immovable elements are printed to the at least one surface of the calendar body.

4. The perpetual calendar device of claim 1, wherein the movable elements are movably secured to the at least one surface of the calendar body, and the movable elements include a member selected from the group consisting of a tile element, a magnetic element, a mechanical element, and combinations thereof.

5. The perpetual calendar device of claim 1, further comprising:
a slider that is slidably attached to the calendar body, the first month element and the second month element attached to the slider so that they are movable together with the slider, and
the at least one surface of the calendar body including at least one of a rail and a channel that slidably receives the movable elements.

6. The perpetual calendar device of claim 1, wherein the at least one surface of the calendar body is one of substantially planar and three dimensional and the at least one surface is substantially non-planar.

7. The perpetual calendar device of claim 1, wherein the at least one surface of the calendar body is substantially continuous and each of the top side, the bottom side, the left side, and the right side are not terminal.

8. The perpetual calendar device of claim 1, wherein the calendar body is generated as a graphical user interface of a computerized display.

9. A perpetual calendar device operable under a Ruderman method of making a weekday determination and also permitting for an annual update between a former calendar year and a new calendar year, the perpetual calendar device comprising:
a calendar body permitting a user to make the weekday determination by selecting a day number and a month name, the calendar body permitting for the annual update by the user performing a reconfiguration of the calendar body, and the calendar body also having a common year mode rendering the calendar body usable for the weekday determination during a common year, and a leap year mode rendering the calendar body usable for the weekday determination during a leap year,
the calendar body having at least one surface with a top side, a bottom side, a left side, and a right side, the at least one surface further having a base calendar layout with immovable elements and movable elements,
the immovable elements including a second row of month name elements, a third row of month name elements, a fourth row of weekday name elements, a series of spaced apart day markers, and a series of spaced apart month markers,
the second row of month name elements disposed on the at least one surface between the array and the top side of the at least one surface, and the series of spaced apart month markers disposed adjacent the first row of month name elements and each month marker of the series of spaced apart month markers aligned with one of the month name elements,
the third row of month name elements disposed on the at least one surface between the array and the top side of the at least one surface, third row of month name elements including a first month element, a second month element, and a third month element, and
the fourth row of weekday name elements disposed on the at least one surface between the array and the top side of the at least one surface, and the series of spaced apart month markers disposed adjacent the first row of month name elements and each month marker of the series of spaced apart month markers aligned with one of the month name elements,
the movable elements including an array of day number elements and a first row of month name element, and a leap year element,
the array having day number element columns and day number element rows, the day number element columns spaced apart evenly along a length of the calendar body between the left side and the right side of the at least one surface and adjacent a bottom side of the at least one surface, the day number element rows disposed evenly along a height of the calendar body between the bottom side and the right side of the at least one surface, the series of spaced apart day markers disposed adjacent the array and each day marker of the series of spaced apart day markers aligned with one of the day number element columns, the day number element columns configured to:
individually move toward the right side of the at least one surface by one position when the calendar body is reconfigured from the common year mode to the common year mode, and reconfigured from the leap year mode to the common year mode, and
to individually move toward the right side of the at least one surface by two positions when the calendar body is reconfigured from the common year mode to the leap year mode,
the first row of month name elements disposed on the at least one surface between the array and the top side of the at least one surface, the first row of month name elements including a first month element and a second month element, the first month element and second month element of the first row of month name elements configured to:
individually move toward the left side of the at least one surface to a first month by one position when the calendar body is reconfigured from the common year mode to the leap year mode, and
to individually move toward the right side of the at least one surface by one position when the calendar body is reconfigured from the leap year mode to the common year mode.
the leap year element disposed on the at least one surface between the third row of month name elements and the top side of the at least one surface, the leap year element exposed during the leap year to signify to the user that the calendar body is in the leap year mode, the leap year element configured to display, optionally, on the right side of the second month element of the first row,
whereby the calendar body is operable by the user under the Ruderman method to make the month determination by selecting the day number, selecting the month name, and visualizing or actually effecting a line extending from one of the series of spaced apart month markers aligned with the one of the month name elements associated with the month name that is selected to one of the series of spaced apart day markers aligned with one of the day number element columns associated with the day number that is selected, with the line intersecting one of the weekday name elements in the fourth row to thereby reveal a weekday associated with the day number and the month name selected by the user.

10. The perpetual calendar device of claim 9, wherein the first month element of the first row of month name elements is a January month element, the second month element of the first row of month name elements is a February month element, the array includes seven of the day number element columns and five of the day number element rows, and the calendar body is configured for a calendar year, the calendar year including a member selected from the group consisting of a full calendar year, an academic year, and a fiscal year with an arbitrary start date and end date 365 days later.

11. The perpetual calendar device of claim 9, wherein each of the immovable elements are printed to the at least one surface of the calendar body.

12. The perpetual calendar device of claim 9, wherein the movable elements are movably secured to the at least one surface of the calendar body, and the movable elements include a member selected from the group consisting of a tile element, a magnetic element, a mechanical element, and combinations thereof.

13. The perpetual calendar device of claim 9, further comprising:
a slider that is slidably attached to the calendar body, the first month element and the second month element attached to the slider so that they are movable together with the slider, and
the at least one surface of the calendar body including at least one of a rail and a channel that slidably receives the movable elements.

14. The perpetual calendar device of claim 9, wherein the at least one surface of the calendar body is one of a substantially planar surface and a substantially non-planar three dimensional surface.

15. The perpetual calendar device of claim 9, wherein the at least one surface of the calendar body is substantially continuous and each of the top side, the bottom side, the left side, and the right side are not terminal.

16. The perpetual calendar device of claim 9, wherein the calendar body is generated as a graphical user interface of a computerized display.

17. A method of updating the perpetual calendar device of claim 1 from the former calendar year to the new calendar year, the method comprising steps of:
providing the perpetual calendar device; and
reconfiguring the calendar body to provide the annual update to the perpetual calendar device by one of
where the former calendar year is the common year and the new calendar year is the common year, moving the first row of month name elements, the second row of month name elements, and the third row of month name elements one position to a right toward the right side of the at least one surface at an end of the former calendar year so that the perpetual calendar device remains in the common year mode,
where the former calendar year is the common year and the new calendar year is the leap year, moving the second row of month name elements and the third row of month name elements two positions to the right toward the right side of the at least one surface at the end of the former calendar year, and moving each of the first month element of the first row of month name elements and the second month element of the first row of month name elements one position to the right toward the right side of the at least one surface at the end of the former calendar year, so that the perpetual calendar device is placed in the leap year mode, and the leap year element is exposed to signify to the user that the calendar body is in the leap year mode,
where the former calendar year is the leap year and the new calendar year is the common year, moving the second row of month name elements and the third row of month name elements one position to the right toward the right side of the at least one surface at the end of the former calendar year, and moving each of the first month element of the first row of month name elements and the second month element of the first row of month name elements two positions to the right toward the right side of the at least one surface at the end of the former calendar year, so that the perpetual calendar device is placed in the common year mode, and the leap year element is covered to signify to the user that the calendar body is in the common year mode,
thereby rendering the perpetual calendar device operable for the new calendar year.

18. The method of claim 17, wherein the steps of method are performed in reverse in order to generate a past calendar operable under the Ruderman method of making the weekday determination.

19. A method of updating the perpetual calendar device of claim 16 from the former calendar year to the new calendar year, the method comprising steps of:
providing the perpetual calendar device; and
reconfiguring the calendar body to provide the annual update to the perpetual calendar device by one of
where the former calendar year is the common year and the new calendar year is the common year, moving the day number element columns one position to a right toward the right side of the at least one surface at an end of the former calendar year so that the perpetual calendar device remains in the common year mode,
where the former calendar year is the common year and the new calendar year is the leap year, moving the day number element columns two positions to the right toward the right side of the at least one surface at the end of the former calendar year, and moving each of the first month element of the first row of month name elements and the second month element of the first row of month name elements one position to a left toward the left side of the at least one surface at the end of the former calendar year, so that the perpetual calendar device is placed in the leap year mode, and the leap year element is exposed to signify to the user that the calendar body is in the leap year mode,
where the former calendar year is the leap year and the new calendar year is the common year, moving the day number element columns one position to the right toward the right side of the at least one surface at the end of the former calendar year, and moving each of the first month element of the first row of month name elements and the second month element of the first row of month name elements one position to the right toward the right side of the at least one surface at the end of the former calendar year, so that the perpetual calendar device is placed in the common year mode, and the leap year element is covered to signify to the user that the calendar body is in the common year mode,
thereby rendering the perpetual calendar device operable for the new calendar year.

20. The method of claim 19, wherein the steps of method are performed in reverse in order to generate a past calendar operable under the Ruderman method of making the weekday determination.
